(19) United States
(12) Patent Application Publication
(10) Pub. No.: US 2008/0284686 A1
(43) Pub. Date: Nov. 20, 2008

(54) METHOD OF DRIVING PLASMA DISPLAY PANEL

(75) Inventors: Takashi Mashita, Chuo-shi (JP); Hajime Homma, Chuo-shi (JP); Koji Hashimoto, Chuo-shi (JP); Yuichi Sakai, Chuo-shi (JP); Ayuhiko Saito, Chuo-shi (JP); Mitsuhiro Ishizuka, Chuo-shi (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku (JP)

(21) Appl. No.: 12/119,162

(22) Filed: May 12, 2008

(30) Foreign Application Priority Data
May 16, 2007 (JP) 2007-130611
May 17, 2007 (JP) 2007-131951
May 18, 2007 (JP) 2007-133209

(51) Int. Cl. G09G 3/28

(52) U.S. Cl. 345/63

(57) ABSTRACT

When a sustain discharge corresponding to the display light is repeatedly produced by applying a drive pulse to a PDP which includes a fluorescent layer in the discharge cells, the drive pulse waveform is adjusted in accordance with the total number of sustain discharges. Furthermore, an auxiliary pulse of the same polarity as that of the sustain pulse is applied to the column electrodes in a period from after the application of a final scan pulse in the address process until the application of a leading sustain pulse. A period from the final sustain pulse until the time of the application of the leading pixel data pulse which is applied first in the write address process of the one subfield of the subsequent frame is made 1 millisecond (msec) or more.

### BACKGROUND OF THE INVENTION

1. Field of the Invention

The present invention relates to a method of driving a plasma display panel.

2. Description of the Related Art

In recent years, plasma display panels (referred to as ‘PDP’ hereinbelow) have attracted a great deal of attention as self-emitting display devices with a high emission intensity. PDP has a structure in which discharge cells which correspond to pixels are formed at the respective points of intersection between a plurality of column electrodes constituting address electrodes and a plurality of row electrodes which are arranged so as to intersect each of the column electrodes.

Furthermore, the subfield method is known as one method of driving a PDP. In driving that is based on the subfield method, an address process which sets the respective discharge cells of the PDP to one state of a lighting-on mode and a lighting-off mode in accordance with image data for each of the pixels on the basis of an video input signal, and a sustain process in which only the discharge cells in a lighting-on mode state are repeatedly made to perform a sustain discharge, in each of a plurality of subfields for each single field display period.

A driving method in which the discharge cells belonging to the respective row electrodes are selectively made to produce an address discharge for the address process by applying a pixel data pulse with a positive polarity which corresponds to image data to the column electrodes while alternatively and sequentially applying a scan pulse of a negative polarity to each of the row electrodes, whereby the discharge cells are made to make the transition from a lighting-on mode state to a lighting-off mode state is known. See FIG. 7 of Japanese Patent Application Laid Open Kokai No. 2005-043413, for example. Here, in this driving, an erroneous discharge between the row electrodes Y and column electrodes D to which a scan pulse SP has not been applied is prevented by applying a base pulse BP of the same polarity as the pixel data pulse DP to the row electrodes Y during the period of execution of the address process.

Furthermore, in cases where a display panel with a high discharge probability or capability is adopted as the PDP, an erroneous discharge takes place across the row electrodes Y and column electrodes D simply as a result of the start of the application of the base pulse BP even when a scan pulse SP is not being applied, and, as a result this erroneous discharge, there has been the risk that a portion of the wall charge which should essentially remain in the discharge cell will be erased. Accordingly, it is not possible to reliably produce an address discharge directly thereafter even when the scan pulse SP and pixel data pulse DP are applied, for example. Consequently, there has been the problem that the image which is represented by the video input signal can no longer be accurately displayed.

In gray level or gradation driving that is based on the subfield method, the driving of one field's worth of the video signal is implemented so as to be split between a plurality of subfields. A number of times the light emission should be implemented (or a period for the light emission) is assigned to each subfield and an address process and sustain (maintained light emission) process are sequentially executed. In addition, a reset process is executed prior to the address process in at least the leading subfield.

The selective write address method and selective erase address method are generally known as gray level driving methods which are based on the subfield method. See Japanese Patent Application Laid Open Kokai No. 2001-312244, for example.

According to the selective write address method, a wall charge state is initialized in all the discharge cells in the reset process and the cells which are to be placed in a light emission state by forming a wall charge of a predetermined amount within the respective discharge cells are determined selectively on the basis of the video input signal in the address process. That is, the cells which should be placed in a light emission state by performing an address discharge (write discharge) across the column electrode and one of the row electrodes forming a pair are set to the lighting-on mode in which a wall charge of a predetermined amount is formed and the cells which are to be placed in a non-light emission state are set to a lighting-off mode in which a wall charge of a predetermined amount is not formed.

With the selective erase address method, a wall charge of a predetermined amount is formed in all of the discharge cells in the reset process and the cells in lighting-on mode which are to be placed in a light emission state by erasing the wall charge formed within the respective discharge cells selectively in accordance with a video input signal are determined in the address process. That is, although all of the discharge cells are set to a lighting-off mode in the reset process, the cells which are to be placed in the light emission state in the address process maintain a wall charge of a predetermined amount and remain in the lighting-on mode, whereas the cells which should be placed in the non-light emission state have their wall charge erased and are thus placed in the lighting-off mode.

The selective write address method and selective erase address method both repeatedly apply a sustain pulse (maintenance pulse) between the row electrodes of only the discharge cells in which a wall charge of a predetermined amount is formed in the sustain process so that a sustain discharge is produced and the light emission state caused by this discharge is maintained. Normally, only the discharge cells in the light emission state are made to emit light a number of times equal to the light emission count assigned in correspondence with the weighting of the subfields.

As mentioned earlier, in gray level driving that is based on the conventional subfield method, in the sustain process of each subfield, a leading sustain pulse for causing the cells placed in the wall charge state of the lighting-on mode to emit light is applied to either one of the row electrodes in the address discharge of the preceding address process. However, there are cases, depending on the cell, where the wall charge state is not stable immediately following the address discharge and, in comparison with the sustain pulse which follows the leading sustain pulse, there has been the problem that, even in cases where the mode is set to lighting-on mode when there is inconsistency in the wall charge state in the discharge cells due to the address discharge, the light emission state is unstable and inconsistencies occur with the light emission luminance.

Furthermore, in the gray level driving that is based on the subfield method, display driving with respect to one field's worth of video signal is carried out in each of the plurality of subfields to each of which a number of times (or period) the light emission should be implemented is assigned. In each subfield, an address process and sustain process are sequentially executed. In the address process, a wall charge of a predetermined amount is formed (or erased) by selectively producing a selective discharge between the row electrodes and column electrodes within the respective pixel cells or discharge cells in accordance with a video input signal. In the sustain process, only the pixel cells in which a wall charge of a predetermined amount is formed are repeatedly discharged, thereby maintaining the light emission state caused by the discharge. In addition, a reset process is executed prior to the address process in at least the leading subfield. In this reset process, the amount of wall charge remaining in all of the discharge cells is initialized by producing a reset discharge between the row electrodes forming a pair, within all of the discharge cells.

Here, the reset discharge is a comparatively strong discharge and does not contribute toward the content of the image which is to be displayed. Hence, there has been the problem that the light emission which is caused by the discharge lowers the contrast of the image.

Therefore, a PDP and method of driving the same, with which the discharge delay time is shortened by allowing magnesium oxide crystals which perform cathode luminescence light emission with a peak wavelength between 200 and 300 nm (nanometers) which is produced by electron beam irradiation to be adhered to the surface of a dielectric layer which covers the row electrode pair have been proposed (See Japanese Patent Application Laid Open Kokai No. 2006-54160, for example). With this PDP, because the post-discharge priming effect continues for a relatively long time, a weak discharge can be stably produced. Therefore, by applying a reset pulse with a pulse waveform in which the voltage value gradually reaches a peak voltage value as time elapses to the row electrodes of the PDP in this manner, a weak reset discharge is produced across mutually adjacent row electrodes. Thereupon, because the light emission brightness which is caused by the discharge drops as a result of the weakening of the reset discharge, the contrast of the image can be raised.

However, with the conventional so-called selective erase address method in particular (See Japanese Patent Application Laid Open Nos. 2006-54160 and 2001-312244, for example), that is, in cases where writing is executed in any one write address subfield within one frame and a writing defect (write failure) arises in the write address process in the gray level driving which performs selective erase addressing in the subsequent subfield, because a write process does not exist in the subsequent subfield in the frame, there has been the problem that the pixels become dark points and the image quality deteriorates. In the case of a PDP in which MgO crystals including CL light-emitting MgO crystals are provided in a fluorescent layer, the discharge characteristic is favorable. The weak discharge is therefore produced all the more readily and this problem easily arises.

### SUMMARY OF THE INVENTION

The present invention was conceived in view of the problem described above and an object of the present invention is to provide a method of driving a plasma display panel which is capable of providing an accurate display image even where erroneous discharge occurs.

Furthermore, the above drawbacks are cited as examples of the problems which the present invention is intended to solve and an object of the present invention is to provide a method of driving a plasma display panel which is capable of generating a favorable image display by suppressing inconsistencies in the light emission accuracy of the sustain discharge of the sustain process directly after the address process.

A further object of the present invention is to provide a method of driving a plasma display panel with a high-performance gray level representation capability (the so-called ‘darkness contrast’) for displaying dark images and which is capable of preventing the degradation of the image quality without the production of dark points (black display) due to the failure of writing in the write address process.

The method of driving a plasma display panel according to the present invention is a method of driving a plasma display panel which drives a plasma display panel in which a first substrate and a second substrate are disposed opposite one another, with a discharge space that is filled with discharge gas being interposed therebetween, and discharge cells are formed at the respective intersections between a plurality of row electrode pairs formed on the first substrate and a plurality of column electrode formed on the second substrate, the plasma display panel having a fluorescent layer including a fluorescent material and a secondary electron emission material formed on the surface of the respective discharge cells which is in contact with the discharge space and the plasma display panel being driven in accordance with pixel data for each of the pixels based on a video signal, the method comprising: a drive control process which executes each of address processing, in which the discharge cells are each subjected to an address discharge selectively in accordance with the pixel data in the respective subfields to set the discharge cells to either a lighting-on mode or a lighting-off mode by applying, in each of a plurality of subfields in each unit display period of the video signal, a drive pulse to the row electrode pairs and the column electrode pairs, and sustain processing, in which only the discharge cells in the lighting-on mode state are subjected to a sustain discharge repeatedly a number of times which corresponds to a brightness weighting of the subfield; and a lighting sustain total calculation process that finds the total of the sustain discharges produced in each of the discharge cells within a predetermined period as a lighting sustain total, wherein the drive control process further executes pulse waveform adjustment processing in order to adjust the pulse waveform of the drive pulse in accordance with the lighting sustain total.

The method of driving a plasma display panel according to the present invention is a method of driving a plasma display panel in which a front substrate and a rear substrate are disposed opposite one another via a discharge space, a plurality of row electrode pairs and a plurality of column electrode pairs which extend in a direction of intersection with the plurality of row electrode pairs and form discharge cells in the discharge space at each of the intersections with the row electrode pairs are provided between the front substrate and the rear substrate, and a fluorescent layer is provided in the discharge cells on the rear substrate opposite the column electrodes, the plasma display panel being gray-level driven in accordance with a video signal, the method comprising the steps of executing, in each of the subfields when the display period of one field of the video signal is divided into a plurality of subfields which correspond to respective weightings, an address process which selectively subjects the discharge cells to an address discharge to set the discharge cells to a lighting-on mode or lighting-off mode in accordance with pixel data which correspond to the video signal, and a maintained light emission process which produces discharges in a number which corresponds to the weightings only for discharge cells in the light emission state by applying a sustain pulse to the row electrodes which constitute the row electrode pairs; and applying an auxiliary pulse of the same polarity as that of the sustain pulse to the column electrodes in a first period which extends from after the application of a final scan pulse which is applied to one of each of the row electrodes of the row electrode pairs in the address process until the application of a leading sustain pulse, which is applied in the maintained light emission process, starts.

The method of driving a plasma display panel according to the present invention is a method of driving a plasma display panel in which a first substrate and a second substrate are disposed opposite one another with a discharge space filled with discharge gas interposed therebetween and discharge cells on which a fluorescent layer having a fluorescent material is provided are formed at the respective intersections between a plurality of row electrode pairs formed on the first substrate and a plurality of column electrode pairs formed on the second substrate, the plasma display panel being driven in accordance with pixel data for each of the pixels based on a video signal, comprising the steps of executing a write address process that subjects the discharge cells to an address discharge to set the discharge cells to lighting-on mode by applying a pixel data pulse to the column electrodes selectively in accordance with the pixel data in one subfield when one frame display period of the video signal is divided into a plurality of subfields and a sustain process which subjects the discharge cells which have been set to the lighting-on mode to a sustain discharge by applying a sustain pulse to the row electrode pairs; executing an erase address process which sets the discharge cells to lighting-off mode by subjecting the discharge cells to an address discharge selectively in accordance with the pixel data and the sustain process in the subfield which follows the one subfield. Here, a period extending from the time of the application of the final sustain pulse which is the sustain pulse that is applied last in the immediately preceding frame which is the one frame display period up until the time of the application of the leading pixel data pulse which is the pixel data pulse that is applied first in the write address process of the one subfield of the subsequent frame which follows the immediately preceding frame is taken as the adjustment period, and the adjustment period is made 1 msec (millisecond) or more.

Furthermore, the method of driving a plasma display panel according to the present invention is a method of driving a plasma display panel in which a first substrate and a second substrate are disposed opposite one another, with a discharge space that is filled with discharge gas being interposed therebetween, and discharge cells on which a fluorescent layer including a fluorescent material is provided are formed at the respective intersections between a plurality of row electrode pairs formed on the first substrate and a plurality of column electrode pairs formed on the second substrate, the plasma display panel being driven in accordance with pixel data for each of the pixels based on a video signal, the method comprising the steps of executing a write address process that subjects the discharge cells to an address discharge to set the discharge cells to lighting-on mode by applying a pixel data pulse to the column electrodes selectively in accordance with the pixel data in one subfield when one frame display period of the video signal is divided into a plurality of subfields and a sustain process which subjects the discharge cells which have been set to the lighting-on mode to a sustain discharge by applying a sustain pulse to the row electrode pairs; and executing an erase address process which sets the discharge cells to lighting-off mode by subjecting the discharge cells to an address discharge selectively in accordance with the pixel data and the sustain process in the subfield which follows the one subfield. Here, a period extending from the time of the application of the final light emission sustain pulse which is the sustain pulse which produces the sustain discharge last in the immediately preceding frame which is the one frame display period up until the time of the application of the leading pixel data pulse which is the pixel data pulse that is applied first in the write address process of the one subfield of the subsequent frame which follows the immediately preceding frame is taken as the adjustment period, and the adjustment period is made 1 millisecond (msec) or more.

### BRIEF DESCRIPTION OF THE DRAWINGS

FIG. 1 shows the overall configuration of the plasma display device of the present invention;

FIG. 2 is a plan view which schematically shows the internal structure of the PDP 50 as viewed from the display side;

FIG. 3 shows a cross-section along the line V-V shown in FIG. 2;

FIG. 4 shows a cross-section along the line W-W shown in FIG. 2;

FIG. 5 schematically shows an MgO crystal which is contained in a fluorescent layer 17;

FIG. 6 shows the temporal transition of the discharge intensity of the discharge that is produced by applying a predetermined voltage when the column electrodes are cathodic across the row electrodes and column electrodes of a conventional PDP which contains CL light-emitting MgO crystals only in magnesium oxide layer 13 among the magnesium oxide layer 13 and the fluorescent layer 17;

FIG. 7 shows the temporal transition of the discharge intensity of the discharge produced by applying a predetermined voltage when the column electrodes are cathodic across row electrodes and column electrodes of a PDP 50 of this embodiment which contains CL light-emitting MgO crystals in both the magnesium oxide layer 13 and fluorescent layer 17;

FIG. 8 shows an example of a light emission pattern for each gray level of the plasma display device shown in FIG. 1;

FIG. 9 shows an example of a light emission drive sequence which is adopted by the plasma display device shown in FIG. 1;

FIG. 10 shows various drive pulses which are applied to the PDP 50 in accordance with the light emission drive sequence shown in FIG. 9;

FIG. 11 shows the pulse waveform of the final sustain pulse IP_{E} and a wall charge adjustment pulse CP which is applied to the respective sustain process I;

FIG. 12 represents other drive form for subfield SF2 which is shown in FIG. 10;

FIG. 13 shows another waveform of a reset pulse RP1_{Y1} (RP1_{Y2});

FIG. 14 shows another application example of the reset pulse in a first reset process R1;

FIG. 15 schematically represents an embodiment for a case where the fluorescent layer 17 is constructed by laminating a secondary electron emission layer 18 on the surface of a fluorescent particle layer 17a;

FIG. 16 shows the overall configuration of a plasma display device to which the driving method of the present invention is applied;

FIG. 17 shows the light emission pattern for each gray level;

FIG. 18 shows an example of a light emission drive sequence in a case where the selective erase address method is adopted as the light emission drive system for the device in FIG. 16;

FIG. 19 shows various drive pulses which are applied to the PDP in accordance with the light emission drive sequence in FIG. 18;

FIG. 20 is a circuit diagram which shows the configuration of the sustain pulse generation circuit of each of the X electrode driver and Y electrode driver in the device in FIG. 16;

FIG. 21 shows the operation when generating the sustain pulse that is applied to the row electrode Yj of the circuit in FIG. 20;

FIG. 22 shows another example of a light emission drive sequence in a case where the selective write address method is adopted as the light emission drive system for the device in FIG. 16;

FIG. 23 shows the light emission pattern for each gray level of the light emission drive sequence of FIG. 22;

FIG. 24 shows various drive pulses which are applied to the PDP in accordance with the light emission drive sequence of FIG. 22;

FIG. 25 shows another example of various drive pulses which are applied to the PDP in accordance with the light emission drive sequence of FIG. 22;

FIG. 26 is a waveform diagram that shows a pulse IP′ which is generated by using an exclusive power source;

FIG. 27 is a waveform that shows the pulse IP′ which is generated by utilizing the sustain pulse;

FIG. 28 is a waveform that shows the pulse IP′ which is generated by utilizing the sustain pulse;

FIG. 29 shows the overall configuration of the plasma display device of the present invention;

FIG. 30 shows a light emission pattern for each gray level;

FIG. 31 is a flowchart that shows the procedure for a case where either drive mode A or drive mode B is selectively executed;

FIG. 32 shows an example of a light emission drive sequence that is adopted by the plasma display device shown in FIG. 29;

FIG. 33 shows various drive pulses which are applied to the PDP 50 in accordance with the light emission drive sequence shown in FIG. 31;

FIG. 34 shows another waveform for the reset pulse RP_{Y1} (RP_{Y2});

FIG. 35 shows the fact that the period P_{W} which extends from the application end time T_{E} of the various drive pulses applied in drive control which is based on drive mode B and of the final light emission sustain pulse of the preceding frame until the application start time T_{S} of the data pulse DP which is first applied in the selective write subfield of the subsequent frame is equal to or more than a predetermined period P₀ (P_{W}=P₀);

FIG. 36 shows the relationship between the selective driving of drive mode A or drive mode B and the PDP cumulative usage time;

FIG. 37 shows the relationship between the selective driving of drive mode A or drive mode B and the temperature of the PDP;

FIG. 38 shows a case where period P (W1_{W}) of the first selective write address process W1_{W} of Embodiment 3.1 is extended so that period P_{W} is set to be equal to or more than the predetermined period P₀;

FIG. 39 shows a case where the period P(E) of the erase process E of Embodiment 3.2 is extended so that period P_{W} is set to be equal to or more than the predetermined period P₀ (P_{W}=P₀);

FIG. 40 shows a case where the remaining time obtained by subtracting the total time of all the subfields from one frame period according to an Embodiment 3.3 is assigned as rest periods A, B, C, and D and the period P_{W} is set to be equal to or more than a predetermined period P₀ (P_{W}=P₀);

FIG. 41 shows a case where subfields from the final subfield to a predetermined subfield are forcibly set to lighting-off mode and the period P_{W} is set to be equal to or more than predetermined period P₀ according to Embodiment 3.4;

FIG. 42 shows a case where a write period P (W2_{W}) of the selective write address process is set to be short as a modified example of the respective embodiments 3.1 to 3.4;

FIG. 43 shows a case where the present invention is applied to the drive control of one reset sequence as a modified example of the respective embodiments 3.1 to 3.4; and

FIG. 44 shows a case where the reset pulse of the pre-judgment section of the reset process is omitted as another revised embodiment 3.7.

### DETAILED DESCRIPTION OF THE INVENTION

When a sustain discharge which corresponds to the display light is repeatedly produced by applying a drive pulse to a PDP which comprises a fluorescent layer comprising a secondary electron emission material in the discharge cells, the pulse waveform of the drive pulse is adjusted in accordance with the total number of sustain discharges produced in the respective discharge cells. Here, by adjusting the peak potential and/or pulse width of the various drive pulses in accordance with the total number of the sustain discharges, the wall electrical charge amount formed by the various discharges is increased or the amount of wall charge erased by the various discharges is reduced. Accordingly, even when an erroneous discharge is generated, for example, and a portion of the wall charge is erased as a result, because it is possible to reliably generate an address discharge which corresponds to the video input signal, an accurate display image is then provided.

### Embodiment 1

An embodiment of the present invention will be described in detail hereinbelow with reference to the drawings.

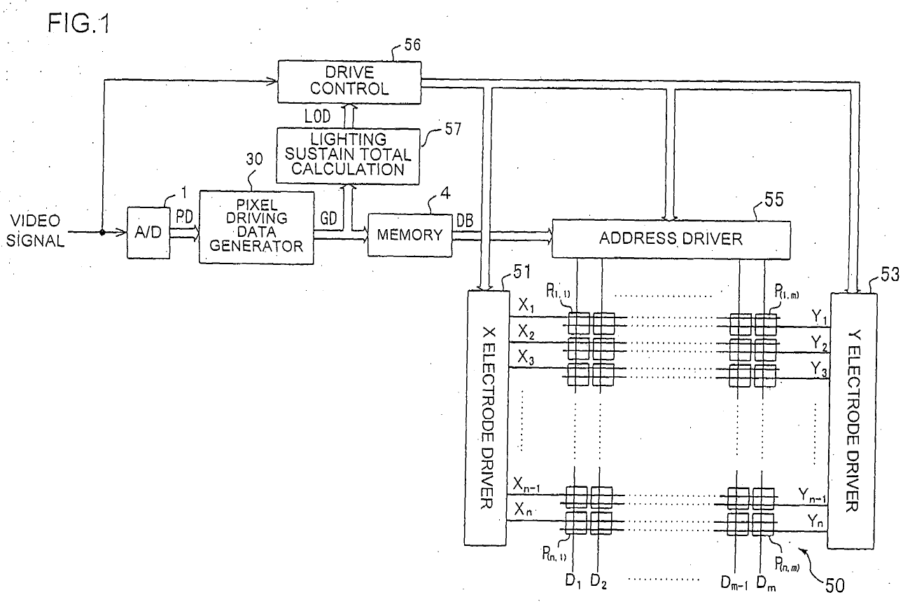

FIG. 1 shows the overall configuration of the plasma display device which performs driving of the plasma display panel in accordance with the driving method of the present invention.

As shown in FIG. 1, the plasma display device is constituted by an A/D converter 1, a memory 4, a pixel driving data generation circuit 30, a PDP 50 which constitutes a plasma display panel, an X electrode driver 51, a Y electrode driver 53, an address driver 55, a drive control circuit 56, and a lighting sustain total calculation circuit 57.

In the PDP 50, column electrodes D₁ to Dₘ which are arranged in an extended fashion in the vertical direction (perpendicular direction) of the two-dimensional display screen and row electrodes X₁ to Xₙ and row electrodes Y₁ to Yₙ which are arranged in extended fashion in a lateral direction (horizontal direction) are formed. Here, the row electrode pairs (Y₁, X₁), (Y₂, X₂), (Y₃, X₃), . . . , (Yₙ, Xₙ) which are mutually adjacent to one another and together form pairs each carry the first to nth display lines of the PDP 50. The discharge cells (display cells) PC which carry the pixels are formed at the intersections between the respective display lines and column electrodes D₁ to Dₘ (the area surrounded by the dot-chain line in FIG. 1). That is, the PDP 50 has discharge cells PC_{1,1} to PC_{1,m} which belong to the first display line, discharge cells PC_{2,1} to PC_{2,m} which belong to the second display line, . . . , and discharge cells PC_{1,1} to PC_{n,m} which belong to the nth display line arranged in the form of a matrix.

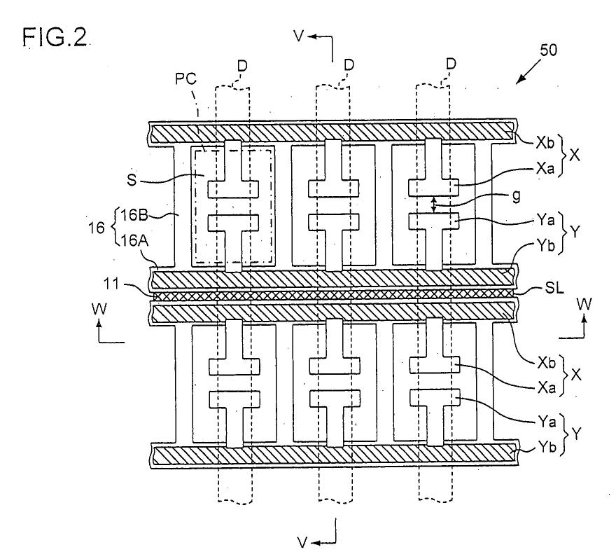

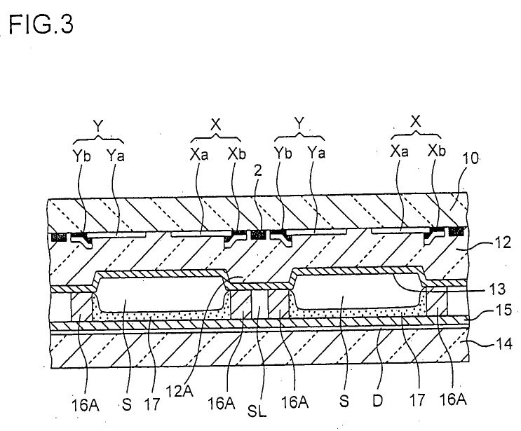

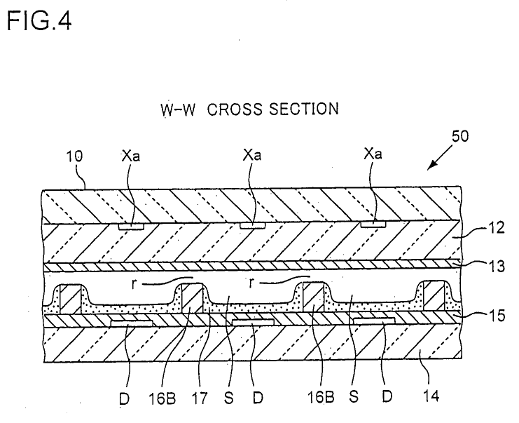

FIG. 2 is a plan view which schematically shows an internal structure of the PDP 50 which is view from the display side. In FIG. 2, the intersections between three column electrodes D which are adjacent to one another and two mutually adjacent display lines are selectively shown. Further, FIG. 3 shows a cross-section of the PDP 50 along line V-V in FIG. 2 and FIG. 4 shows a cross-section of the PDP 50 along line W-W of FIG. 2.

As shown in FIG. 2, the respective row electrodes X are constituted by a bus electrode Xb which extends in the horizontal direction of the two-dimensional display screen and T-shaped transparent electrodes Xa which are provided in contact with a position which corresponds to the respective discharge cells PC on the bus electrode Xb. The respective row electrodes Y are constituted by a bus electrode Yb which extends in the horizontal direction of the two-dimensional display screen and a T-shaped transparent electrode Ya which is provided in contact in a position which corresponds to each discharge cell PC on the bus electrode Yb. Transparent electrodes Xa and Ya comprise ITO or another transparent conductive film, for example, and bus electrodes Xb and Yb comprise a metal film, for example. Row electrodes X, which comprise the transparent electrode Xa and bus electrode Xb, and row electrodes Y, which comprise the transparent electrode Ya and bus electrode Yb, are, as shown in FIG. 3, formed on the rear side of the front transparent substrate 10 the front surface of which is the display surface of the PDP 50. Thereupon, the transparent electrodes Xa and Ya of the respective row electrode pairs (X, Y) extend toward the row electrode side of their partner with which same form a pair and the sides of the wide portion face one another via a discharge gap g1 of a predetermined width. Furthermore, a black or dark light absorption layer (light-blocking layer) 11 which extends in the horizontal direction of the two-dimensional display screen is formed on the rear side of the front transparent substrate 10 between a row electrode pair (X, Y) and the row electrode pair (X, Y) which is adjacent to the row electrode pair. In addition, a dielectric layer 12 is formed on the rear surface of the transparent substrate 10 so as to cover the row electrode pairs (X, Y). A raised dielectric layer 12A is formed on the rear side of the dielectric layer 12 (the surface on the opposite side from the surface where the row electrode pairs make contact) as shown in FIG. 3 in the part corresponding with the area in which the light absorption layer 11 and the bus electrodes Xb and Yb adjacent to the light absorption layer 11 are formed.

A magnesium oxide layer 13 is formed on the surface of the dielectric layer 12 and the raised dielectric layer 12A. The magnesium oxide layer 13 comprises magnesium oxide crystals (referred to as CL light-emitting MgO crystals hereinbelow) which constitute a secondary electron emission material which performs CL (cathode luminescence) light emission with a wavelength between 200 and 300 nm which is produced by electron beam irradiation and in a particular with a peak between 230 and 250 nm. The CL light-emitting MgO crystals are obtained by subjecting the magnesium vapor which is produced by heating magnesium to gas phase oxidation and have a poly-crystal structure in which cubic crystals are interfitted or has a cubic single crystal structure, for example. The average particle diameter of the CL light-emitting MgO crystals is equal to or more than 2000 Angstroms (measurement result using BET).

In cases where large-particle gas phase oxidation magnesium oxide single crystals with an average particle diameter of 2000 Angstrom or more are to be formed, it is necessary to raise the heating temperature when generating the magnesium vapor. Hence, the length of the flame of the reaction between the magnesium and oxygen is then long and there is a large temperature difference between the flame and the surroundings. As a result, the greater the number of gas phase oxidation magnesium oxide single crystals with a large average particle diameter, the larger the number of crystals with an energy level which corresponds to the peak wavelength of the CL light-emission (close to 235 nm and between 230 and 250 nm, for example) are formed.

In addition, in comparison with general gas phase oxidation, the area of the reaction between the magnesium and oxygen is further increased by increasing the amount of magnesium that causes evaporation per unit of time and the gas phase oxidation magnesium oxide single crystals generated as a result of a reaction with a large quantity of oxygen have an energy level which corresponds to the peak wavelength of the abovementioned CL light-emission.

The magnesium oxide layer 13 is formed as a result of causing CL light-emitting MgO crystals of this kind to adhere to the surface of the dielectric layer 12 by means of the spray method or static application method or the like. A thin-film magnesium oxide layer may be formed through evaporation or sputtering on the surface of the dielectric layer 12 and the magnesium oxide layer 13 may be formed by causing CL light-emitting MgO crystals to adhere to the thin-film magnesium oxide layer.

Meanwhile, each of the column electrodes D are formed extending in a direction orthogonal to the row electrode pairs (X, Y) in positions opposite the transparent electrodes Xa and Ya of the respective row electrode pairs (X, Y) on a rear substrate 14 that is disposed parallel to the front transparent substrate 10. A white column electrode protection layer 15 which covers the column electrodes D is also formed on the rear substrate 14. A barrier wall 16 is formed on the column electrode protection layer 15. The barrier wall 16 is formed with a ladder shape by horizontal walls 16A which extend in the lateral direction of the two-dimensional display screen in positions which correspond to the bus electrodes Xb and Yb of the respective row electrode pairs (X, Y) and vertical walls 16B which extend in the vertical direction of the two-dimensional display screen in respective center positions between mutually adjacent column electrodes D. In addition, a ladder-shaped barrier wall 16 is formed for each display line of the PDP 50 as shown in FIG. 2. A gap SL exists as shown in FIG. 2 between mutually adjacent barrier walls 16. Further, discharge cells PC which each comprise an independent discharge space S and transparent electrodes Xa and Ya are partitioned by the ladder-shaped barrier walls 16. The discharge space S is filled with a discharge gas containing xenon gas. The spaces between the respective discharge spaces S of the respective discharge cells PC and gap SL are mutually closed as a result of the magnesium oxide layer 13 butting against the horizontal walls 16A as shown in FIG. 3. Further, as shown in FIG. 4, because the vertical walls 16B do not butt against the magnesium oxide layer 13, gaps r exists therebetween. In other words, the discharge spaces S of the discharge cells PC, which are mutually adjacent in the horizontal direction of the two-dimensional display screen, communicate with one another via the gaps r.

The fluorescent layer 17 is formed on the sides of the horizontal walls 16A, the sides of the vertical walls 16B, and the surface of the column electrode protection layer 15 in the respective discharge cells PC so as to completely cover these surfaces. The fluorescent layer 17 actually comprises three types of fluorescent material, namely a fluorescent material which carries out red light emission, a fluorescent material which carries out green light emission, and a fluorescent material which carries out blue light emission.

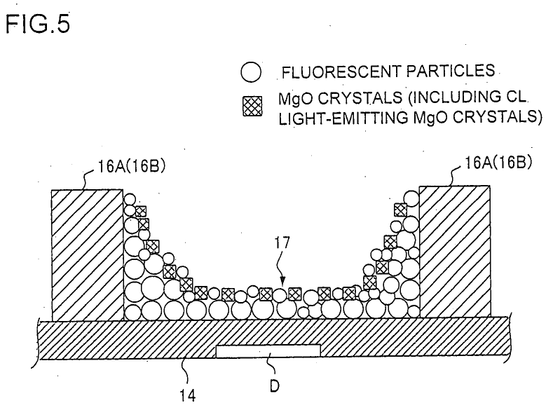

MgO crystals constituting secondary electron emission material (including CL light-emitting MgO crystals) are contained in the state shown in FIG. 5, for example, within the fluorescent layer 17. Here, MgO crystals are exposed via the fluorescent layer 17 so as to make contact with the discharge gas on the surface which covers the discharge space S on the surface of the fluorescent layer 17, that is, on the surface which contacts the discharge space S.

That is, the PDP 50 contains CL light-emitting MgO crystals which constitute the secondary electron emission material not only within the magnesium oxide layer 13 formed on the side of the front transparent substrate 10 in the respective discharge cells PC, but also within the fluorescent layer 17 formed on the side of the rear substrate 14.

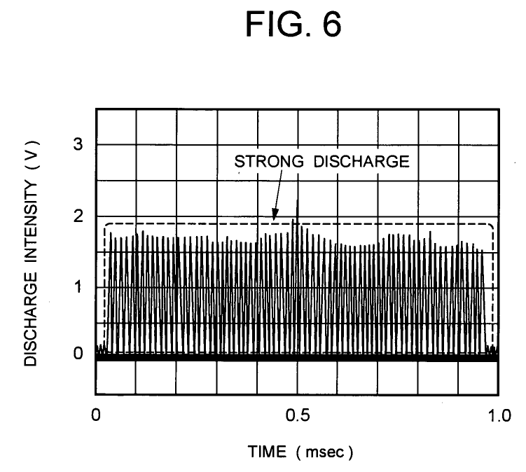

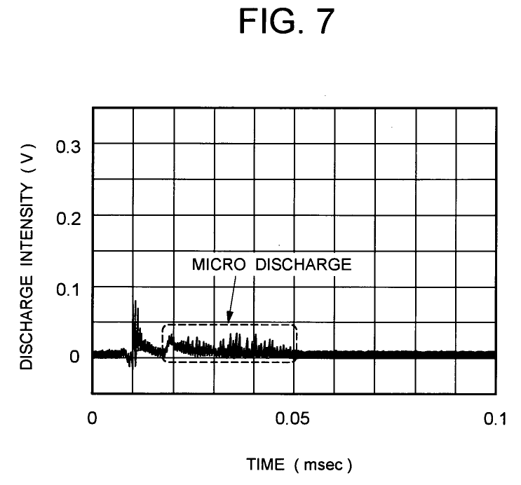

The operating effect yielded by adopting this configuration will be described hereinbelow with reference to FIGS. 6 and 7.

FIG. 6 shows the temporal transition of the discharge intensity of the discharge that is produced by applying a predetermined voltage when the column electrodes are cathodic across the row electrodes and column electrodes of a conventional PDP which contains CL light-emitting MgO crystals only in magnesium oxide layer 13 among the magnesium oxide layer 13 and fluorescent layer 17. However, FIG. 7 shows the temporal transition of the discharge intensity of the discharge produced by applying a predetermined voltage when the column electrodes are cathodic across row electrodes and column electrodes of PDP 50 of the present invention which contains CL light-emitting MgO crystals in both the magnesium oxide layer 13 and fluorescent layer 17.

In other words, although a relatively strong discharge continues for 1 [ms] or more as shown in FIG. 6 in a conventional PDP, with the PDP 50 of the present invention, a weak discharge ends within approximately 0.04 [ms] of the discharge start point as shown in FIG. 7. Accordingly, by adopting a structure that contains CL light-emitting MgO crystals in both the magnesium oxide layer 13 and the fluorescent layer 17, a marked shortening of the discharge delay time and a weakening of the discharge are achieved in comparison with a conventional PDP.

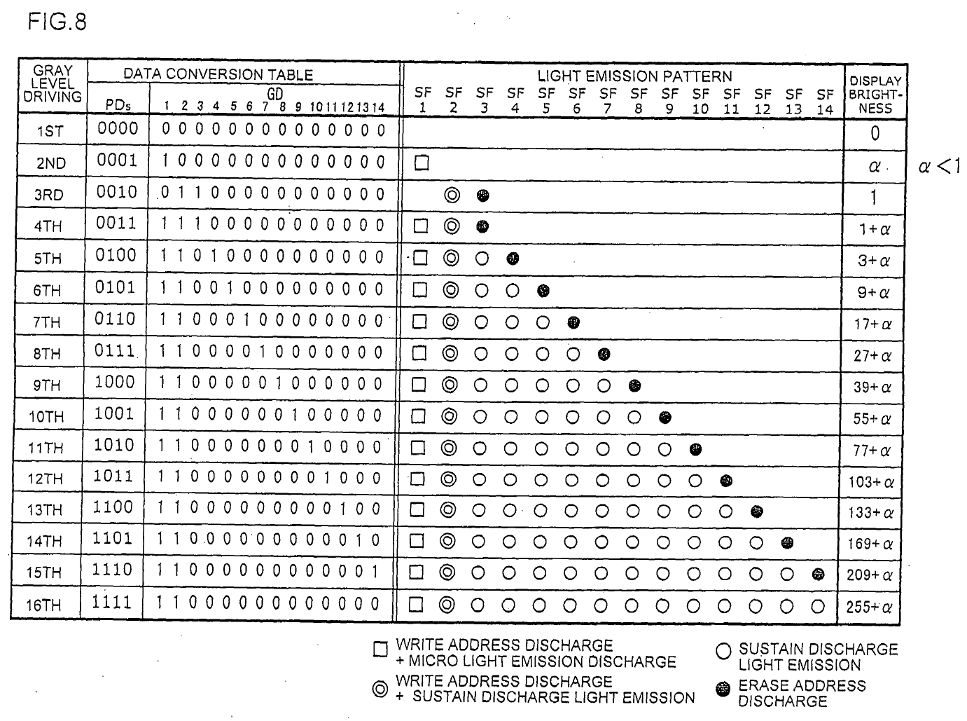

In FIG. 1, the A/D converter 1 converts the video input signal into 8-bit pixel data PD which represent the brightness levels of each of the respective pixels by means of 256 gray levels, for example. The pixel driving data generation circuit 30 performs multiple gray level processing which comprises random dither processing and dither processing on the pixel data PD. That is, first, in the random dither processing, the upper six bits' worth of the pixel data are taken as the display data and the remaining lower two bits' worth of the pixel data are taken as the error data and data obtained by adding a weighting to the error data of the pixel data which correspond to each of the peripheral pixels are mirrored in the display data in order to obtain the six bits' worth of random dither processing pixel data. With this random dither processing, the lower two bits' worth of brightness of the source pixels are represented in pseudo fashion by the peripheral pixels and, as a result, a brightness gray level representation which is the same as that of the eight bits' worth of pixel data is possible by means of six bits' worth of display data which is a smaller number than the eight bits' worth of display data. Thereafter, the pixel driving data generation circuit 30 performs dither processing on the 6-bit random dither processing pixel data obtained by means of the random dither processing. In the dither processing, a plurality of pixels which are in mutual contact with one another are taken as a single pixel unit and dither-added pixel data are obtained by assigning and adding dither coefficients consisting of mutually different coefficient values to each of the random dither processing pixel data which correspond to the respective pixels in the single pixel unit. As a result of the addition of the dither coefficients, in cases where the pixels are viewed as a pixel unit as above, brightness which corresponds to that afforded by eight bits can be rendered by means of only the upper four bits' worth of the dither-added pixel data. The pixel driving data generation circuit 30 renders the upper four bits' worth of the dither-added pixel data 4-bit multiple gray level pixel data PD_{S} which represent the entire brightness range (brightness 0 to 255) as shown in FIG. 8 by means of 15 levels. Further, the pixel driving data generation circuit 30 converts the multiple gray level pixel data PD_{S} into 14-bit pixel driving data GD in accordance with the data conversion table as shown in FIG. 8 and supplies these 14-bit pixel driving data GD to the memory 4 and lighting sustain total calculation circuit 57. The first to fourteenth bits of the pixel driving data GD correspond to subfields SF1 to SF14 respectively (described subsequently) and the logic levels of the respective bits determine whether an address discharge (described subsequently) which establishes the states of the respective discharge cells (lighting-on mode and lighting-off mode) in the subfields SF corresponding with the bits is produced.

The lighting sustain total calculation circuit 57 first determines, for each unit display period, the number of sustain pulses which are to be applied to the discharge cells PC in lighting-on mode (described subsequently) among the sustain pulses (described subsequently) which are repeatedly applied to the respective discharge cells PC within the unit display period, on the basis of the pixel driving data GD, for each of the one screen's worth of discharge cells PC_{1,1} to PC_{n,m}. The number of sustain pulses to be applied to each of the discharge cells PC is preset on the basis of the brightness weighting of each subfield for each of the subfields SF1 to SF14 within the unit display period. Therefore, the lighting sustain total calculation circuit 57 calculates, for each of the discharge cells, the number of sustain pulses which to be applied to the discharge cells PC in the lighting-on mode state on the basis of information indicating the number of sustain pulses for each subfield that has been preset and on the basis of the pixel driving data GD. That is, the lighting sustain total calculation circuit 57 determines the total number of sustain discharges (described subsequently) which is to be repeatedly produced in the respective discharge cells PC within a unit display period on the basis of information indicating the number of sustain pulses for each subfield that has been preset and on the basis of the pixel driving data GD. Further, the lighting sustain total calculation circuit 57 calculates the sum total of the total numbers of sustain discharges determined for each of the one screen's worth of discharge cells PC_{n,1} to PC_{n,m} and supplies a lighting SUS total signal LOD which represents the sum total as the lighting sustain total to the drive control circuit 56. When the lighting sustain total is determined by the lighting sustain total calculation circuit 57, not all of the discharge cells PC_{n,1} to PC_{n,m} need necessarily be targets. For example, one representative discharge cell may be selected from each discharge cell block which comprises a plurality of adjacent discharge cells PC or the lighting sustain total may be determined with all of the representative discharge cells in one screen taken as targets. Further, the lighting sustain total calculation circuit 57 may also determine the lighting sustain total on the basis of the average brightness level of the image represented by the video input signal or the total number of discharge cells in the lighting-on mode state (light emission load amount). For example, for various average brightness levels (or light emission load amounts), data which represent the lighting sustain totals which correspond to these values are pre-stored in a lookup table memory (not shown). Further, data which represent the lighting sustain total corresponding with the average brightness level (or light emission load amount) at the current point in time are read from the lookup table memory and supplied to the drive control circuit 56 as the lighting SUS total signal LOD.

The memory 4 sequentially writes the pixel drive data GD. Here, upon completion of the writing of one screen's worth of pixel drive data GD_{(1,1)} to GD_{(n,m)}, that is, (n×m) pixel drive data GD_{(1,1)} to GD_{(n,m)} which correspond to the respective pixels of the first row and first column to the nth row and mth column, the memory 4 performs a read operation as detailed hereinbelow.

First, the memory 4 perceives the respective first bits of the pixel drive data GD_{(1,1)} to GD_{(n,m)} as the pixel drive data bits DB1_{(1,1)} to DB1_{(n,m)} and supplies same to the address driver 55 by reading one display line's worth of the pixel drive data bits in subfield SF1 (described subsequently). Thereafter, the memory 4 perceives the respective second bits of the pixel drive data GD_{(1,1)} to GD_{(n,m)} as the pixel drive data bits DB2_{(1,1)} to DB2_{(n,m)} and supplies same to the address driver 55 by reading one display line's worth of the pixel drive data bits in subfield SF2 (described subsequently). Subsequently, the memory 4 perceives the respective third bits of the pixel drive data GD_{(1,1)} to GD_{(n,m)} as the pixel drive data bits DB3_{(1,1)} to DB3_{(n,m)} and supplies same to the address driver 55 by reading one display line's worth of the pixel drive data bits in subfield SF3 (described subsequently). Similarly thereafter, the memory 4 perceives the respective fourth to fourteenth bits of the pixel drive data GD_{(1,1)} to GD_{(n,m)} as the pixel drive data bits DB4 to DB14 and supplies same to the address driver 55 by reading one display line's worth of the pixel drive data bits in the subfield SF (described subsequently) which corresponds to the respective pixel drive data bits DB.

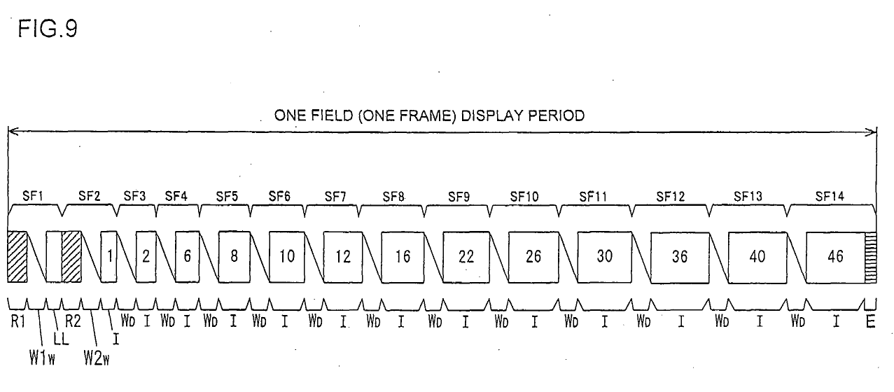

The drive control circuit 56 supplies the various control signals which are to drive the PDP 50 in accordance with a light emission drive sequence as shown in FIG. 9 to each of the X electrode driver 51, Y electrode driver 53, and address driver 55. That is, the drive control circuit 56 supplies various control signals for sequentially implementing driving which corresponds to each of the first reset process R1, the first selective write address process W1_{W} and a micro light emission process LL in the leading subfield SF1 for each single field or single frame display period (called the ‘single display period’ hereinbelow) to the panel driver. In SF2, which follows subfield SF1, the drive control circuit 56 supplies various control signals for sequentially implementing driving which corresponds to a second reset process R2, a second selective write address process W2_{W} and sustain process I respectively to the panel driver. Further, various control signals for sequentially implementing driving which corresponds to a selective erase address process W_{D} and sustain process I in the subfields SF3 to SF14 respectively are supplied to the panel driver. Only in the final subfield SF14 within the unit display period, following the execution of the sustain process I, the drive control circuit 56 supplies various control signals for sequentially implementing driving which corresponds to an erase process E to the panel driver.

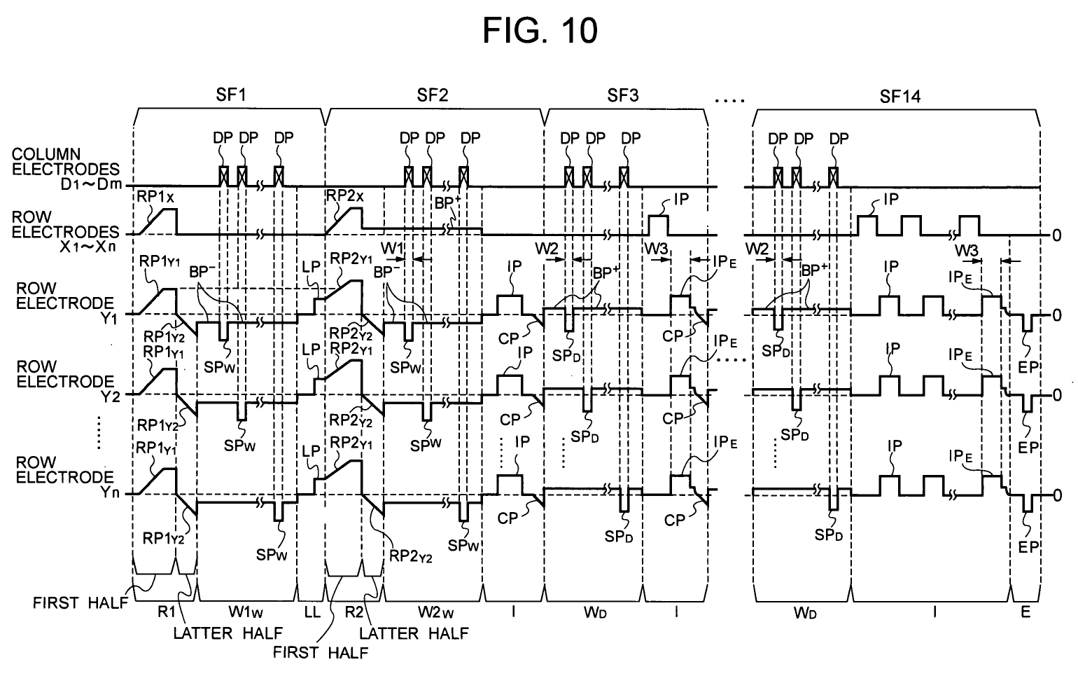

The panel driver (X electrode driver 51, Y electrode driver 53, and address driver 55) supplies various drive pulses as shown in FIG. 10 to the column electrode D and row electrodes X and Y of the PDP 50 in accordance with various control signal which are supplied by the drive control circuit 56. FIG. 10 selectively shows only the operation in the leading subfield SF1, the subsequent subfield SF2, and the final subfield SF14 from among the subfields SF1 to SF14 shown in FIG. 9.

In FIG. 10, in the first half of the first reset process R1 of subfield SF1, the Y electrode driver 53 applies a reset pulse RP1_{Y1} which has a waveform in which the potential transition at the leading edge as time elapses is gradual in comparison with the subsequent sustain pulse and which has a positive polarity peak potential to all of the row electrodes Y₁ to Yₙ. As shown in FIG. 10, the positive polarity peak potential of the reset pulse RP1_{Y1} is a potential equal to or less than the positive-polarity peak potential of the sustain pulse IP (described subsequently). Meanwhile, the address driver 55 sets the column electrodes D₁ to Dₘ to a ground potential (0 volt) state. The first reset discharge is produced across the row electrodes Y and column electrodes D in all of the discharge cells PC in accordance with the application of the reset pulse RP1_{Y1}. That is, by applying a voltage across the row electrodes Y and column electrodes D in the first half of the first reset process R1 so that the row electrodes Y are anodic and the column electrodes D are cathodic, a discharge in which the current flows from the row electrodes Y to the column electrodes D (referred to as the ‘column cathode discharge’ hereinbelow) is produced as the first reset discharge. A wall charge of a negative polarity is formed close to the row electrodes Y in all of the discharge cells PC and a wall charge of a positive polarity is formed close to the column electrodes D in accordance with the first reset discharge.

Further, in the first half of the first reset process R1, the X electrode driver 51 applies a reset pulse RP1_{X} with the same polarity as that of the reset pulse RP1_{Y1} and which has a positive polarity peak potential which makes it possible to prevent a surface discharge across the row electrodes X and Y caused by the application of the reset pulse RP1_{Y1} to all of the row electrodes X₁ to Xₙ respectively.

Thereafter, in the latter half of the first reset process R1, the Y electrode driver 53 generates a reset pulse RP1_{Y2} which has a pulse waveform in which the potential gradually drops as time elapses and reaches a negative polarity peak potential as shown in. FIG. 10 and applies the reset pulse RP1_{Y2} to all of the row electrodes Y₁ to Yₙ. Thereupon, a second reset discharge is produced across the row electrodes X and Y in all of the discharge cells PC in accordance with the application of the reset pulse RP1_{Y2}. The negative polarity peak potential of the reset pulse RP1_{Y2} is the lowest potential with which it is possible to produce the second reset discharge reliably across the row electrodes X and Y after considering the wall charge formed close to the row electrodes X and Y respectively in accordance with the first reset discharge. Further, the negative polarity peak potential of the reset pulse RP1_{Y2} is set at a higher potential than the negative polarity peak potential of the subsequently described write scan pulse SP_{W}, that is, at a potential which is close to 0 volt. In other words, this is because, when the negative polarity peak potential of the reset pulse RP1_{Y2} is lower than the negative polarity peak potential of the write scan pulse SP_{W}, a strong discharge is produced across the row electrodes Y and column electrodes D, the wall charge formed close to the column electrodes D is largely erased and the address discharge in the first selective write address process W1_{W} (described subsequently) becomes unstable. The wall charge formed close to the row electrodes X and Y respectively in the respective discharge cells PC is erased by the second reset discharge produced in the latter half of the first reset process R1 and all of the discharge cells PC are initialized in the lighting-off mode. In addition, a weak discharge is also produced across the row electrodes Y and column electrodes D in all of the discharge cells PC in accordance with the application of the reset pulse RP1_{Y2} and, as a result of this discharge, a portion of the wall charge of a positive polarity formed close to the column electrodes D is erased and is adjusted to the amount that makes it possible to produce a selective write address discharge accurately in the first selective write address process W1_{W}.

Thereafter, in the first selective write address process W1_{W} of the subfield SF1, the Y electrode driver 53 simultaneously applies a base pulse BP⁻ with a negative polarity peak potential to the row electrodes Y₁ to Yₙ as shown in FIG. 10 while sequentially and alternatively applying a write scan pulse SP_{W} with a negative polarity peak potential to each of the row electrodes Y₁ to Yₙ. Meanwhile, the X electrode driver 51 applies a 0-volt voltage to each of the row electrodes X₁ to Xₙ. Furthermore, in the first selective write address process W1_{W}, the address driver 55 generates a pixel data pulse DP with a pulse voltage which corresponds to the logic level of the pixel driving data bit which corresponds to subfield SF1. For example, the address driver 55 generates a pixel data pulse DP with a positive polarity peak potential in cases where the pixel driving data bit of logic level 1 for setting the discharge cells PC to lighting-on mode is supplied. However, the address driver 55 generates a pixel data pulse DP of a low voltage (0 volt) in accordance with a pixel driving data bit of logic level 0 for setting the discharge cells PC to lighting-off mode. Further, the address driver 55 applies the pixel data pulse DP one display line at a time (m) to the column electrodes D₁ to Dₘ in synchronism with the application timing of the respective write scan pulse SP_{W}. Thereupon, a selective write address discharge is produced across the column electrodes D and row electrodes Y in the discharge cells PC to which a high-voltage pixel data pulse DP for setting the discharge cells PC to lighting-on mode is applied at the same time as the write scan pulse SP_{W}. As a result of the selective write address discharge, the discharge cells PC are set to a state where a positive polarity wall charge is formed close to the row electrodes Y and a negative polarity wall charge is formed close to the column electrodes D, that is, to lighting-on mode. However, a selective write address discharge is not produced, as mentioned earlier, across the column electrodes D and row electrodes Y in the discharge cells PC to which a low voltage (0 volt) pixel data pulse DP for setting the discharge cells PC to lighting-off mode is applied at the same time as the write scan pulse SP_{W}. Accordingly, the discharge cells PC maintain the preceding state, that is, the lighting-off mode state that was initialized in the first reset process R1.

Thereafter, in the micro light emission process LL of the subfield SF1, the Y electrode driver 53 simultaneously applies a micro light emission pulse LP with a predetermined peak potential of a positive polarity as shown in FIG. 10 to the row electrodes Y₁ to Yₙ. A discharge is produced across the column electrodes D and row electrodes Y in the discharge cells PC set to lighting-on mode in accordance with the application of the micro light emission pulse LP (referred to as ‘micro light emission discharge’ hereinbelow). That is, in the micro light emission process LL, although a discharge is produced across the row electrodes Y and column electrodes D in the discharge cells PC, because a potential which does not produce a discharge across the row electrodes X and Y is applied to the row electrodes Y, a micro light emission discharge is produced only across the column electrodes D and row electrodes Y in the discharge cells PC set to lighting-on mode. Here, the positive polarity peak potential of the micro light emission pulse LP is a lower potential than the peak potential of the sustain pulses IP applied in the sustain process I following subfield SF2 (described subsequently). Further, as shown in FIG. 10, the rate of change as time elapses in the rising segment of the potential of the micro light emission pulse LP is higher than the rate of change in the rising segment of the reset pulse (RP1_{Y1}, RP1_{Y2}). That is, by making the potential transition of the leading edge of the micro light emission pulse LP steeper than the potential transition of the leading edge of the reset pulse, a discharge that is stronger than the first reset discharge produced in the first reset process R1 is produced. Here, the discharge is the earlier mentioned column side cathode discharge and is a discharge that is produced by the micro light emission pulse LP which has a lower peak potential than that of the sustain pulse IP. Hence, the light emission brightness caused by the discharge is lower than that of the sustain discharge produced across the row electrodes X and Y. That is, although the discharge is a discharge which causes light emission of a higher brightness level than that of the first reset discharge in the micro light emission process LL, a discharge for which the brightness level caused by the discharge is lower than that of the sustain discharge, that is, a discharge which causes micro light emission of a magnitude that can be utilized for the display is produced as the micro light emission discharge. Here, in the first selective write address process W1_{W} executed directly before the micro light emission process LL, a selective write address discharge is produced across the column electrodes D and row electrodes Y in the discharge cell PC. Accordingly, in subfield SF1, brightness which corresponds to a gray level whose brightness is one level higher than brightness level 0 is represented as the light emission caused by the micro light emission discharge and the light emission caused by the selective write address discharge.

Following the micro light emission discharge, a wall charge of a negative polarity is formed close to the row electrodes Y and a wall charge of a positive polarity is formed close to the column electrodes D, respectively.

Thereafter, in the first half of the second reset process R2 of subfield SF2, the Y electrode driver 53 applies a reset pulse RP2_{Y1} in which the potential transition at the leading edge as time elapses is gradual in comparison with the subsequent sustain pulse IP and which has a positive polarity peak potential to all of the row electrodes Y₁ to Yₙ. Further, meanwhile, the address driver 55 sets the column electrodes D₁ to Dₘ to a ground potential (0 volt) state. The X electrode driver 51 applies a reset pulse RP2_{X} with a positive polarity peak potential which makes it possible to prevent a surface discharge across the row electrodes X and Y caused by the application of the reset pulse RP2_{Y1} to all of the row electrodes X₁ to Xₙ respectively. Here, if a surface discharge is not produced across the row electrodes X and Y, instead of applying the reset pulse RP2_{X}, the X electrode driver 51 may set all of the row electrodes X₁ to Xₙ at ground potential (0 volt). The first reset discharge is produced across the row electrodes Y and column electrodes D in the discharge cells PC for which a column side cathode discharge has not been produced in the micro light emission process LL in each of the discharge cells PC in accordance with the application of the reset pulse RP2_{Y1}. That is, by applying a voltage across the row electrodes Y and column electrodes D in the first half of the second reset process R2 so that the row electrodes Y are anodic and the column electrodes D are cathodic, the column cathode discharge in which the current flows from the row electrodes Y to the column electrodes D is produced as the first reset discharge. However, a discharge is not produced even when the application of the reset pulse RP2_{Y1} is performed within the discharge cells PC in which a micro light emission discharge has already been produced in the micro light emission process LL. Therefore, directly after the end of the first half of the second reset process R2, a wall charge of a negative polarity is formed close to the row electrodes Y in all of the discharge cells PC and a wall charge of a positive polarity is formed close to the column electrodes D. Further, in the latter half of the second reset process R2 of subfield SF2, the Y electrode driver 53 applies a reset pulse RP2_{Y2} which has a pulse waveform in which the potential gradually drops as time elapses and reaches a negative polarity peak potential as shown in FIG. 10 to all of the row electrodes Y₁ to Yₙ. Furthermore, in the latter half of the second reset process R2, the X electrode driver 51 applies a base pulse BP⁺ which has a positive polarity peak potential to the row electrodes X₁ to Xₙ. Thereupon, the second reset discharge is produced across the row electrodes X and Y in all of the discharge cells PC in accordance with the application of the negative polarity reset pulse RP2_{Y2} and the positive polarity base pulse BP⁺. The negative polarity peak potential of the reset pulse RP2_{Y2} and the positive polarity peak potential of the base pulse BP⁺ are the lowest potentials with which it is possible to produce the second reset discharge reliably across the row electrodes X and Y in accordance with the first reset discharge after considering the wall charge formed close to the row electrodes X and Y respectively. Further, the negative polarity peak potential of the reset pulse RP2_{Y2} is set at a higher potential than the negative polarity peak potential of the write scan pulse SP_{W}, that is, at a potential which is close to 0 volt. In other words, this is because, when the peak potential of the reset pulse RP2_{Y2} is lower than the negative polarity peak potential of the write scan pulse SP_{W}, a strong discharge is produced across the row electrodes Y and column electrodes D, the wall charge formed close to the column electrodes D is largely erased and the address discharge in the second selective write address process W2_{W} hereinbelow becomes unstable.

In the second selective write address process W2_{W}, the Y electrode driver 53 simultaneously applies a base pulse BP⁻ with a negative polarity peak potential to the row electrodes Y₁ to Yₙ as shown in FIG. 10 while alternatively and sequentially applying a write scan pulse SP_{W} with a negative polarity peak potential to each of the row electrodes Y₁ to Yₙ. Meanwhile, the X electrode driver 51 applies a O-volt voltage to each of the row electrodes X₁ to Xₙ. Furthermore, in the second selective write address process W2_{W}, the address driver 55 generates a pixel data pulse DP with a peak potential which corresponds to the logic level of the pixel driving data bit which corresponds to subfield SF2. For example, the address driver 55 generates a pixel data pulse DP with a positive polarity peak potential in cases where the pixel driving data bit of logic level 1 for setting the discharge cells PC to lighting-on mode is supplied. However, the address driver 55 generates a pixel data pulse DP of a low voltage (0 volt) in accordance with a pixel driving data bit of logic level 0 for setting the discharge cells PC to lighting-off mode. Further, the address driver 55 applies the pixel data pulse DP one display line at a time (m) to the column electrodes D₁ to Dₘ in synchronism with the application timing of the respective write scan pulse SP_{W}. Thereupon, a selective write address discharge is produced across the column electrodes D and row electrodes Y in the discharge cells PC to which a high-voltage pixel data pulse DP for setting the discharge cells PC to lighting-on mode is applied at the same time as the write scan pulse SP_{W}. Furthermore, directly after the selective write address discharge, a weak discharge is also produced across the row electrodes X and Y in the discharge cells PC. That is, a voltage which corresponds to the base pulses BP⁻ and BP⁺ is applied across the row electrodes X and Y after the write scan pulse SP_{W} has been applied. However, the voltage is set at a voltage which is lower than the discharge start voltage of the respective discharge cells PC. Accordingly, a discharge cannot be produced within the discharge cells PC merely through the application of the voltage. However, when the selective write address discharge is produced, a discharge is produced across the row electrodes X and Y merely by applying the voltage of the base pulses BP⁻ and BP⁺ through induction by the selective write address discharge. As a result of this discharge and the selective write address discharge, the discharge cells PC are set to a state where a positive polarity wall charge is formed close to the row electrodes Y, a negative polarity wall charge is formed close to the row electrodes X, and a negative polarity wall charge is formed close to the column electrodes D, that is, to lighting-on mode. However, a selective write address discharge is not produced, as mentioned earlier, across the column electrodes D and row electrodes Y in the discharge cells PC to which a low voltage (0 volt) pixel data pulse DP for setting the discharge cells PC to lighting-off mode is applied at the same time as the write scan pulse SP_{W}. Accordingly, the discharge cells PC maintain the preceding state, that is, the lighting-off mode state that was initialized in the second reset process R2.

As shown in FIG. 10, the pulse widths of the respective write scan pulse SP_{W} and pixel data pulse DP are the same as one another and are set to the pulse width W1 which is designated by the drive control circuit 56 (described subsequently).

Thereafter, in the sustain process I of subfield SF2, the Y electrode driver 53 generates one pulse's worth of sustain pulse IP with a positive polarity peak potential and simultaneously applies the sustain pulse IP to the row electrodes Y₁ to Yₙ. Meanwhile, the X electrode driver 51 sets the row electrodes X₁ to Xₙ to a ground potential (0 volt) state and the address driver 55 sets the column electrodes D₁ to Dₘ to a ground potential (0 volt) state. A sustain discharge is produced across the row electrodes X and Y in the discharge cells PC set to lighting-on mode in response to the application of the sustain pulse IP. As a result of the light which is irradiated by the fluorescent layer 17 being irradiated to the outside via the front transparent substrate 10 in accordance with the sustain discharge, one display's worth of light emission which corresponds to the brightness weighting of subfield SF2 is performed. Further, a discharge is also produced across the row electrodes Y and column electrodes D in the discharge cells PC that have been set to lighting-on mode in response to the application of the sustain pulse IP. As a result of the discharge and the sustain discharge, a negative polarity wall charge is formed close to the row electrodes Y in the discharge cells PC and a positive polarity wall charge is formed close to each of the row electrodes X and column electrodes D. Further, following the application of the sustain pulse IP, the Y electrode driver 53 applies a wall charge adjustment pulse CP in which the potential transition at the leading edge as time elapses is gradual and which has a negative polarity peak potential as shown in FIG. 10 to the row electrodes Y₁ to Yₙ. A weak erase discharge is produced in the discharge cells PC in which a sustain discharge is produced as mentioned earlier in response to the application of the wall charge adjustment pulse CP and a portion of the wall charge formed in the discharge cells PC is erased. As a result, the amount of wall charge in the discharge cells PC is adjusted to an amount that makes it possible to produce a selective erase address discharge correctly in the next selective erase address process W_{D}.

Thereafter, in the selective erase address process W_{D} of each of the subfields SF3 to SF14, the Y electrode driver 53 applies a base pulse BP⁺ which has a positive polarity peak potential to each of the row electrodes Y₁ to Yₙ while alternatively and sequentially applying an erase scan pulse SP_{D} which has a negative polarity peak potential to each of the row electrodes Y₁ to Yₙ as shown in FIG. 10. The positive polarity peak potential of the base pulse BP⁺ is fixed at a potential which makes it possible to prevent erroneous discharge across the row electrodes X and Y during the period of execution of the selective erase address process W_{D}. Further, during the period of execution of the selective erase address process W_{D}, the X electrode driver 51 sets each of the row electrodes X₁ to Xₙ at ground potential (0 volt). Further, in the selective erase address process W_{D}, the address driver 55 first converts the pixel driving data bit which corresponds to the subfield SF into a pixel data pulse DP which has a peak potential that corresponds to the logic level of the pixel driving data bit. For example, in cases where a pixel driving data bit of logic level 1 which serves to shift the discharge cells PC from the lighting-on mode to the lighting-off mode is supplied, the address driver 55 converts the logic level-1 pixel driving data bit into a pixel data pulse DP which has a positive polarity peak potential. However, in cases where a pixel driving data bit of logic level 0 which is for maintaining the current state of the discharge cells PC is supplied, the address driver 55 converts the logic level-0 pixel driving data bit into a low voltage (0 volt) pixel data pulse DP. Further, the address driver 55 applies the pixel data pulse DP to the column electrodes D₁ to Dₘ in synchronism with the application timing of the respective erase scan pulses SP_{D} one display line at a time (an “m” number of pulses). Thereupon, a selective erase address discharge is produced across the column electrodes D and row electrodes Y in the discharge cells PC to which a high voltage pixel data pulse DP is applied at the same time as the erase scan pulse SP_{D}. As a result of the selective erase address discharge, the discharge cells PC are set to a state where a positive polarity wall charge is formed close to the row electrodes X and Y and a negative polarity wall charge is formed close to the column electrodes D, that is, to lighting-off mode. However, a selective erase address discharge is not produced, as mentioned earlier, across the column electrodes D and row electrodes Y in the discharge cells PC to which a low voltage (0 volt) pixel data pulse DP is applied at the same time as the erase scan pulse SP_{D}. Accordingly, the discharge cells PC maintain the preceding state (the lighting-on mode, lighting-off mode).

As shown in FIG. 10, the pulse widths of each of the erase scan pulse SP_{D} and pixel data pulse DP are the same as one another and are set at a pulse width W2 which is designated (described subsequently) by the drive control circuit 56.

In the sustain process I of each of the subfields SF3 to SF14, the X electrode driver 51 and Y electrode driver 53 apply a sustain pulse IP which has a positive polarity peak potential to the row electrodes Y₁ to Yₙ and X₁ to Xₙ alternately to the row electrodes X and Y and repeatedly by a number of times corresponding to the subfield brightness weighting as shown in FIG. 10. Whenever the sustain pulse IP is applied, the sustain discharge is produced across the row electrodes X and Y in the discharge cells PC which have been set to lighting-on mode. As a result of the light irradiated by the fluorescent layer 17 being irradiated to the outside via the front transparent substrate 10 in accordance with the sustain discharge, light emission a number of times which corresponds to the brightness weighting of subfield SF is performed. The total number of sustain pulses IP applied within each sustain process I is an even number. That is, the leading sustain pulse IP is applied to the row electrodes X within each sustain process I and the final sustain pulse IP is applied to the row electrodes Y. Accordingly, directly after the end of the respective sustain process I, a negative polarity wall charge is formed close to the row electrodes Y in the discharge cells PC in which the sustain discharge is produced and a positive polarity wall charge is formed close to the row electrodes X and column electrodes D. As a result, the wall charge formation states within the respective discharge cells PC are the same directly after the end of the first reset discharge.

Further, directly after the end of the sustain process I of the final subfield SF14, the Y electrode driver 53 applies an erase pulse EP which has a negative polarity peak potential to all of the row electrodes Y₁ to Yₙ. An erase discharge is produced in only those discharge cells PC which are in a lighting-on mode state in accordance with the application of the erase pulse EP. The discharge cells PC in a lighting-on mode state make the transition to a lighting-off mode state as a result of the erase discharge.

As mentioned earlier, the driving is executed on the basis of sixteen different pixel driving data GD as shown in FIG. 8.

First, at the second gray level which represents brightness which is one level higher than the first gray level which represents the black display (brightness level 0), a selective write address discharge for setting the discharge cells PC to lighting-on mode is produced only in SF1 among the subfields SF1 to SF14 as shown in FIG. 8 and the discharge cells PC set to the lighting-on mode are made to produce a micro light emission discharge (indicated by an empty square). Thereupon, the brightness level during the light emission caused by the selective write address discharge and the micro light emission discharge is lower than the brightness level during the light emission caused by one sustain discharge. Accordingly, in cases where the brightness level visualized as a result of the sustain discharge is ‘1’, at the second gray level, brightness which corresponds to a brightness level ‘α’ which is lower than brightness level ‘1’ is rendered.

Thereafter, at the third gray level which represents brightness that is one level higher than that of the second gray level, a selective write address discharge (indicated by two overlapping circles) for setting the discharge cells PC to lighting-on mode is produced only in SF2 among the subfields SF1 to SF14 and a selective erase address discharge which allows the discharge cells PC to make the transition to lighting-off mode is produced in the next subfield SF3 (indicated by a black circle). Accordingly, at the third gray level, light emission which is caused by a single sustain discharge is performed only in the sustain process I of the SF2 among the subfields SF1 to SF14 and brightness which corresponds to brightness level ‘1’ is rendered.

Thereafter, at the fourth gray level which represents brightness that is one level higher than that of the third gray level, a selective write address discharge for setting the discharge cells PC to lighting-on mode is first produced in subfield SF1 and the discharge cells PC set to the lighting-on mode are made to produce a micro light emission discharge (indicated by an empty square shape). Furthermore, at the fourth gray level, a selective write address discharge for setting the discharge cells PC to lighting-on mode is produced only in SF2 among the subfields SF1 to SF14 (indicated by two overlapping circles) and a selective erase address discharge which allows the discharge cells PC to make the transition to lighting-off mode is produced in the next subfield SF3 (indicated by a black circle). Accordingly, at the fourth gray level, light emission with a brightness level ‘α’ is executed in subfield SF1 and a sustain discharge which causes light emission of brightness level ‘1’ is implemented once in SF2. Hence, brightness which corresponds to the brightness level ‘α’+‘1’ is rendered.

Further, at each of the fifth to sixteenth gray levels, a selective write address discharge for setting the discharge cells PC to lighting-on mode is produced in subfield SF1 and the discharge cells PC which have been set to lighting-on mode are made to produce a micro light emission discharge (indicated by an empty square shape). Further, a selective erase address discharge which allows the discharge cells PC to make the transition to lighting-off mode is produced only in the one subfield which corresponds to the gray level (indicated by a black circle). Accordingly, at the fifth to sixteenth gray levels, the micro light emission discharge is produced in subfield SF1 and a single sustain discharge is produced in SF2, whereupon a sustain discharge is produced a number of times which corresponds to the number of times assigned to the subfield in each of the consecutive subfields in a number which corresponds to the gray levels (indicated by a white circle). As a result, at each of the fifth to sixteenth gray levels, brightness which corresponds to the brightness level ‘α’+‘one field (or one frame) the total number of sustain discharges produced in the display period’ is visualized.

Therefore, according to the driving shown in FIGS. 8 to 10, it is possible to render the brightness range of brightness levels ‘0’ to ‘255+α’ by means of sixteen levels as shown in FIG. 8.

Thereupon, in this driving, in subfield SF1 which has the smallest brightness weighting, a micro light emission discharge is produced rather than a sustain discharge as the discharge which contributes to the display image. The micro light emission discharge is a discharge which is produced across the column electrodes D and row electrodes Y. Hence, the brightness level during the light emission caused by the discharge is low in comparison with that caused by the sustain discharge produced across the row electrodes X and Y. Accordingly, in cases where brightness which is one level higher than a black display (brightness level 0) is rendered by the micro light emission discharge (second gray level), the brightness difference from brightness level 0 is small in comparison with a case where the brightness is rendered by a sustain discharge. Therefore, the gray level rendering performance when rendering an image of low brightness increases. Further, at the second gray level, because a reset discharge is not produced in the second reset process R2 of SF2 which succeeds subfield SF1, the reduction in the darkness contrast caused by the reset discharge is suppressed. In the driving shown in FIG. 8, although a micro light emission discharge which causes light emission with a brightness level α is produced in subfield SF1 in the case of each of the gray levels of the fourth and subsequent gray levels, the micro light emission discharge need not be produced at the third and subsequent gray levels. In short, because the light emission caused by the micro light emission discharge has a very low brightness (brightness level α), at each of the fourth and subsequent gray levels in which the micro light emission discharge is used together with the sustain discharge which causes light emission of a higher brightness, there are cases where it is no longer possible to visualize the corresponding brightness increase of brightness level α and there is no sense in producing a micro light emission discharge at this time.

Here, in the case of the plasma display device shown in FIG. 1, by adopting a structure that contains CL light-emitting MgO crystals in both the magnesium oxide layer 13 and the fluorescent layer 17 as shown in FIGS. 2 to 5 as the PDP 50, the discharge probability or capability is markedly increased in comparison with a conventional PDP and a shortening of the discharge delay time and a weakening of the discharge are achieved. Accordingly, because a weakened reset discharge can be reliably produced, the image contrast and the darkness contrast when displaying a dark image in particular can be increased by suppressing the light emission caused by the reset discharge which is not involved in the display image.

However, because the PDP 50 with a high discharge probability readily produces a discharge, in cases where driving is carried out as shown in FIG. 10, the probability of an erroneous discharge being produced across the column electrodes D and row electrodes Y directly after the reset pulse RP2_{Y1} which is applied in order to produce a weak discharge for the purpose of adjusting the wall charge amount within the discharge cells rises. In particular, the amount of charged particles remaining in the discharge space increases the greater the number of times the sustain discharge is produced in the preceding field (frame) display period and an erroneous discharge is readily produced. When the erroneous discharge is produced, because a portion of the negative polarity wall charge that remains close to the row electrodes Y in the discharge cells and the positive polarity wall charge remaining close to the column electrodes D is erased, it is no longer possible to produce an address discharge reliably in the subsequent second selective write address process W2_{W}.

Therefore, in order to produce an address discharge reliably in the second selective write address process W2_{W} even when the erroneous discharge is produced, the drive control circuit 56 adjusts the pulse width W1 of the pixel data pulse DP and the write scan pulse SP_{W} as detailed hereinbelow.

First, the drive control circuit 56 captures a lighting SUS total signal LOD which is supplied by the lighting sustain total calculation circuit 57 for each unit display period. That is, the drive control circuit 56 acquires information indicating the lighting sustain total indicated by the lighting SUS total signal LOD, that is, the total number of sustain pulses IP which actually contribute to the sustain discharge within the sustain pulse IP which is repeatedly applied to all of the discharge cells in the unit display period. Further, the drive control circuit 56 adjusts the pulse width W1 of each of the pixel data pulse DP and write scan pulse SP_{W} in accordance with the lighting sustain total. That is, the drive control circuit 56 supplies a control signal for generating a pixel data pulse DP and write scan pulse SP_{W} which have a pulse width W1 whose pulse width increases as the lighting sustain total indicated by the lighting SUS total signal LOD increases to the Y electrode driver 53 and address driver 55. For example, in cases where the pulse widths W1 of the pixel data pulse DP and the write scan pulse SP_{W} are adjusted using three levels (pulse widths a to c: a<b<c), the drive control circuit 56 first compares the lighting sustain total indicated by the lighting SUS total signal LOD with each of a predetermined first threshold value SR1 and a second threshold value SR2 which is larger than SR1. Thereupon, in cases where the lighting sustain total is less than the first threshold value SR1, the drive control circuit 56 supplies a control signal for generating the pixel data pulse DP and the write scan pulse SP_{W} for which the minimum pulse width a is the pulse width W1 to the Y electrode driver 53 and the address driver 55. Further, in cases where the lighting sustain total is equal to or more than the second threshold value SR2, the drive control circuit 56 supplies a control signal for generating the pixel data pulse DP and the write scan pulse SP_{W} for which the maximum pulse width c is the pulse width W1 to the Y electrode driver 53 and the address driver 55. Furthermore, in cases where the lighting sustain total is greater than the first threshold value SR1 and less than the second threshold value SR2, the drive control circuit 56 supplies a control signal for generating the pixel data pulse DP and the write scan pulse SP_{W} for which the intermediate pulse width b is the pulse width W1 to the Y electrode driver 53 and the address driver 55.

Thus, the greater the lighting sustain total, that is, the greater the number of sustain discharges produced in the preceding field (or frame), the greater the amount of charged particles that remain in the discharge cells. Hence, the possibility of an erroneous discharge being produced across the column electrodes D and row electrodes Y directly after the application of the reset pulse RP2_{Y1} rises. Thus, as a result of the erroneous discharge, a portion of the wall charge formed in the discharge cells is erased at the start of the second selective write address process W2_{W} of the subfield SF2 and a selective write address discharge is not readily produced. Therefore, in order to generate a selective write address discharge reliably in the second selective write address process W2_{W} of the subfield SF2 even when a portion of the wall charge is erased by the erroneous discharge, for example, adjustments in order to increase the respective pulse widths W1 of the pixel data pulse DP and write scan pulse SP_{W} are made.

Accordingly, as a result of the pulse width adjustment, an address discharge can be reliably generated even when driving a PDP 50 with a high discharge probability and an accurate image which corresponds to the video input signal can be displayed.

Furthermore, in cases where driving is carried out as shown in FIG. 10 with respect to a PDP 50 with a high discharge probability, the probability of an erroneous discharge being produced across the column electrodes D and row electrodes Y directly after the wall charge adjustment pulse CP which is applied in order to produce a weak discharge for the purpose of adjusting the wall charge amount at the end of the sustain process I of each of the subfields SF2 to SF13. In particular, the amount of charged particles remaining in the discharge space increases the greater the number of times the sustain discharge is produced in the sustain process I of the subfield and an erroneous discharge is readily produced. When the erroneous discharge is produced, because a portion of the wall charge that is formed in the discharge cells is erased, it is no longer possible to produce an erase address discharge reliably in the subsequent selective erase address process W_{D}.

Therefore, in order to produce an erase address discharge reliably in the selective erase address process W_{D} even when the erroneous discharge is produced, the abovementioned pulse width adjustment may be carried out in the same way with respect to the pixel data pulse DP and erase scan pulse SP_{D} in the selective erase address process W_{D} of each of the subfields SF3 to SF14.

Thereupon, the lighting sustain total calculation circuit 57 calculates the total number of sustain pulses IP which actually contribute to the sustain discharge within the sustain pulse IP applied to the subfields SF (from SF2) for each of the subfields SF3 to SF14 and supplies the lighting SUS total signal LOD which represents the total number of sustain pulses IP to the drive control circuit 56. In cases where pulse width adjustment is carried out in the selective erase address process W_{D} of the subfield SF5, for example, the drive control circuit 56 adjusts the pulse widths W2 of each of the pixel data pulse DP and the erase scan pulse SP_{D} which are to be applied in SF5 in accordance with the lighting sustain total calculated in the preceding subfields, that is, SF2 to SF4. In other words, similarly to the case of the second selective write address process W2_{W} as mentioned earlier, the drive control circuit 56 supplies a control signal in order to generate the pixel data pulse DP and erase scan pulse SP_{D} which have a large pulse width W2 increases as the lighting sustain total increases to the Y electrode driver 53 and address driver 55.

Although an example in which all of the scan pulses (SP_{W}, SP_{D}) which are applied to the row electrodes Y₁ to Yₙ are uniformly adjusted to the same width was illustrated in the above embodiment, adjustment of the pulse width may also be performed by means of the following method.

For example, the row electrodes Y₁ to Yₙ are divided into three row electrode groups A to C and the scan pulses (SP_{W}, SP_{D}) which take the pulse width a as the pulse widths (W1, W2) are applied to each of the row electrodes Y belonging to row electrode group A. Further, scan pulses (SP_{W}, SP_{D}) which take pulse width b which is greater than pulse width a as the pulse widths (W1, W2) are applied to each of the row electrodes Y which belong to the row electrode group B. In addition, scan pulses (SP_{W}, SP_{D}) which take pulse width c which is greater than pulse width b as the pulse widths (W1, W2) are applied to each of the row electrodes Y which belong to the row electrode group C. Thereupon, the drive control circuit 56 exercises control to reduce the number of row electrodes Y which belong to the row electrode group A as the lighting sustain total increases and to increase the number of row electrodes Y which belong to the row electrode group B or C by a quantity that corresponds to the number by which the row electrodes Y belonging to the row electrode group A were reduced.

Furthermore, although the total number of one screen's worth of lighting sustain pulses over a predetermined period is calculated by the lighting sustain total calculation circuit 57, the total number of lighting sustain pulses may also be individually calculated for each display line. Here, the drive control circuit 56 individually executes, for each display line, a pulse width adjustment with respect to the pixel data pulse DP and the scan pulses (SP_{W}, SP_{D}) in accordance with the lighting sustain total calculated for each display line.

Furthermore, although the pulse widths (W1, W2) of the pixel data pulse DP and scan pulses (SP_{W}, SP_{D}) are adjusted in accordance with the lighting sustain total in the above embodiment, the peak potential of each of the pixel data pulse DP and scan pulses (SP_{W}, SP_{D}) may instead be adjusted. In other words, the drive control circuit 56 performs an adjustment on the Y electrode driver 53 and address driver 55 to raise the positive polarity peak potential of the pixel data pulse DP (or to lower the negative polarity peak potential of the write scan pulse SP_{W}) so that the voltage across the row electrodes Y and column electrodes D increases as the lighting sustain total indicated by the lighting SUS total signal LOD increases. Accordingly, the voltage that is applied across the column electrodes D and row electrodes Y rises as a result of the simultaneous application of the pixel data pulse DP and scan pulses (SP_{W}, SP_{D}) as the lighting sustain total increases, whereby an address discharge is readily produced. Accordingly, even when erasure of the wall charge caused by an erroneous discharge occurs at the start of the address process (W2_{W}, W_{D}), an address discharge can be reliably produced. The adjustment of the peak potential with respect to the pixel data pulse DP and scan pulses (SP_{W}, SP_{D}) and the adjustment of the pulse widths (W1, W2) as mentioned earlier may also be executed in combined fashion.

Further, although the pulse widths W2 of the pixel data pulse DP and erase scan pulse SP_{D} were adjusted in order to reliably generate an address discharge in the selective erase address process W_{D} in each of the subfields SF3 to SF14 in the above embodiment, adjustment (1) to (3) as detailed hereinbelow may also be performed on the other drive pulses.

(1) The pulse width, that is, the period for maintaining the positive polarity peak potential only of the sustain pulse IP_{E} that is applied last among the sustain pulses IP which are applied repeatedly in the respective sustain process I is adjusted in accordance with the lighting sustain total.

Thereupon, the lighting sustain total calculation circuit 57 determines, as the lighting sustain total, the total for each of the discharge cells of the sustain pulses IP which contribute to the sustain discharge among the sustain pulses IP which are repeatedly applied to the respective discharge cells in the subfield (or the subfield and preceding subfield) for each of the subfields SF3 to SF14 on the basis of the pixel drive data GD. The lighting sustain total calculation circuit 57 then supplies the lighting SUS total signal LOD which represents the lighting sustain total determined for each of the subfields SF3 to SF14 to the drive control circuit 56. The drive control circuit 56 adjusts the pulse width W3 only for the sustain pulse IP_{E} which is applied at the end of the sustain process I in each subfield (SF3 to SF14) on the basis of the lighting sustain total of each subfield (SF3 to SF14) indicated by the lighting SUS total signal LOD. That is, a control signal for generating sustain pulse IP_{E} for which the period of maintaining the positive polarity peak potential is extended as the lighting sustain total increases is supplied to the Y electrode driver 53. For example, in cases where the pulse width W3 of the sustain pulse IP_{E} of the subfield SF4 is adjusted, the drive control circuit 56 first acquires information indicating the lighting sustain total of the subfield SF4 and the preceding subfield SF3 from within the lighting SUS total signal LOD. The drive control circuit 56 then supplies a control signal for generating the sustain pulse with a pulse width W3 that increases as the lighting sustain total increases as the final sustain pulse IP_{E} in the sustain process I of the subfield SF4 to the Y electrode driver 53. Further, in cases where the pulse width W3 of the sustain pulse IP_{E} of the subfield SF5 is adjusted, the drive control circuit 56 first captures information indicating the lighting sustain total in subfield SF5 and the preceding subfield SF4 from within the lighting SUS total signal LOD. The drive control circuit 56 then supplies a control signal for generating a sustain pulse with a pulse width W3 that increases as the lighting sustain total increases as the final sustain pulse IP_{E} in the sustain process I of subfield SF5 to the Y electrode driver 53. In short, in cases where the probability that an erroneous discharge will be produced directly after the wall charge adjustment pulse CP is high owing to a large number of sustain discharges produced in the subfield (or also including the preceding subfield), adjustment to extend the period for maintaining the positive polarity peak potential is performed only for the final sustain pulse IP_{E} of the sustain process I of the subfield, for each subfield. As a result of the discharge, a relatively large sustain discharge is produced in accordance with the application of the final sustain pulse IP_{E}. Accordingly, because a relatively large amount of wall charge is formed in the discharge cells in accordance with the discharge, wall charge which is adequate in order to produce an erase address discharge reliably in the selective erase address process W_{D} even when a portion of the wall charge is erased when an erroneous discharge is produced, for example, can then (at a stage which precedes the selective erase address process W_{D}) be made to remain.

(2) The waveform of the trailing edge of the final sustain pulse IP_{E} is adjusted in accordance with the lighting sustain total.

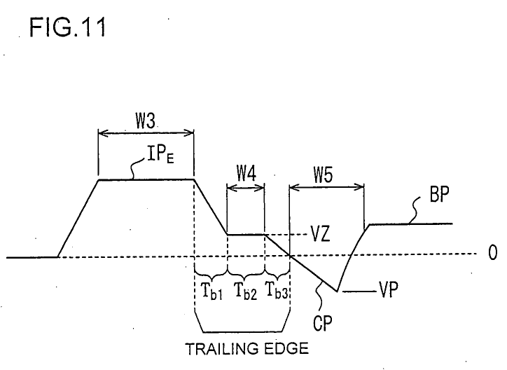

Thereupon, the lighting sustain total calculation circuit 57 determines, as the lighting sustain total, the sum total for each discharge cell of the sustain pulses IP which contribute to the sustain discharge among the sustain pulses IP which are repeatedly applied to the respective discharge cells in the subfield (or the subfield and preceding subfield) for each of the subfields SF3 to SF14 on the basis of the pixel drive data GD. The lighting sustain total calculation circuit 57 then supplies the lighting SUS total signal LOD which represents the lighting sustain total determined for each of the subfields SF3 to SF14 to the drive control circuit 56. The drive control circuit 56 adjusts the waveform of the trailing edge as detailed below only for the final sustain pulse IP_{E} of the sustain process I in each subfield (SF3 to SF14) on the basis of the lighting sustain total of each subfield (SF3 to SF14) indicated by the lighting SUS total signal LOD. That is, the final sustain pulse IP_{E} has a pulse waveform as shown in FIG. 11. As shown in FIG. 11, the trailing edge (latter edge) of the final sustain pulse IP_{E} consists of a first potential drop segment T_{b1} in which the potential gradually drops as time elapses from the positive polarity peak potential state, a fixed potential segment T_{b2} in which the state of the potential VZ at the point where the potential drop stops is maintained for a time interval W4, and a second potential drop segment T_{b3} in which the potential gradually drops as time elapses from the state of potential VZ and reaches 0 volt. That is, the drive control circuit 56 supplies a control signal, which is for generating a sustain pulse IP_{E} that has a pulse waveform which is such that the positive polarity potential VZ in fixed potential segment T_{b2} of the final sustain pulse IP_{E} rises as shown in FIG. 11 as the lighting sustain total increases, to the Y electrode driver 53. FIG. 11 selectively shows the waveforms of the final sustain pulse IP_{E} and the wall charge adjustment pulse CP which are applied to each of the row electrodes Y₁ to Yₙ in the sustain process I of each of the subfields SF3 to SF14 as shown in FIG. 10. Here, in cases where the adjustment is performed on the sustain pulse IP_{E} of subfield SF4, for example, the drive control circuit 56 first captures information which indicates the lighting sustain total in subfield SF4 and the preceding subfield SF3 from within the lighting SUS total signal LOD. Further, the drive control circuit 56 supplies a control signal for generating a sustain pulse which has a trailing edge in which the potential VZ in the fixed potential segment T_{b2} rises as the lighting sustain total increases as the final sustain pulse IP_{E} in the sustain process I of subfield SF4 to the Y electrode driver 53. Further, in cases where the adjustment is carried out for the sustain pulse IP_{E} of subfield SF5, the drive control circuit 56 first captures information which indicates the lighting sustain total of the subfield SF5 and the preceding subfield SF4 from within the lighting SUS total signal LOD. Further, the drive control circuit 56 supplies a control signal for generating a sustain pulse which has a trailing edge waveform for which the potential VZ in the fixed segment T_{b2} rises as the lighting sustain total increases as the final sustain pulse IP_{E} in the sustain process I of subfield SF5 to the Y electrode driver 53. In short, in cases where the probability that an erroneous discharge will be produced directly after the wall charge adjustment pulse CP is high owing to a large number of sustain discharges produced in the subfield (or also including the preceding subfield), adjustment to render the potential VZ in the fixed potential segment T_{b2} of the trailing edge of the final sustain pulse IP_{E} of the subfield a high potential is carried out for each subfield. With this adjustment, the discharge which is produced at the trailing edge of the final sustain pulse IP_{E} weakens and the amount of wall charge erased by the discharge is also minimized. Accordingly, because a relatively large amount of wall charge then remains in the discharge cells, wall charge which is adequate in order to produce an erase address discharge reliably in the selective erase address process W_{D} even when a portion of the wall charge is erased when an erroneous discharge is produced as mentioned earlier can then be made to remain.

When the waveform of the trailing edge of the final sustain pulse IP_{E} is adjusted, the time interval W4 of the fixed potential segment T_{b2} may also be adjusted instead of the positive polarity potential VZ in the fixed potential segment T_{b2} as shown in FIG. 11. That is, the drive control circuit 56 performs adjustment to shorten the time interval W4 of the fixed potential segment T_{b2} of the trailing edge of the final sustain pulse IP_{E} of the subfield as the number of sustain discharges which are produced in the subfield (or also including the preceding subfield), that is, the lighting sustain total, increases, for each subfield. As a result of this adjustment, the discharge produced at the trailing edge of the final sustain pulse IP_{E} weakens as the number of lighting sustain total increases and the amount of wall charge erased by the discharge decreases. Accordingly, because a relatively large amount of wall charge then remains in the discharge cells, wall charge which is adequate in order to produce an erase address discharge reliably in the selective erase address process W_{D} even when a portion of the wall charge is erased when an erroneous discharge is produced as mentioned earlier can then be made to remain.

Furthermore, when the waveform of the trailing edge of the final sustain pulse IP_{E} is adjusted, the time interval W4 of the fixed potential segment T_{b2} may also be adjusted in accordance with the lighting sustain total as mentioned earlier in addition to the positive polarity potential VZ in the fixed potential segment T_{b2} as shown in FIG. 11.

(3) The pulse waveform of the wall charge adjustment pulse CP is adjusted in accordance with the lighting sustain total.

Thereupon, the lighting sustain total calculation circuit 57 determines, as the lighting sustain total, the sum total for each discharge cell of the sustain pulses IP which contribute to the sustain discharge among the sustain pulses IP which are repeatedly applied to the respective discharge cells in the subfield (or the subfield and preceding subfield) for each of the subfields SF3 to SF14 on the basis of the pixel drive data GD. The lighting sustain total calculation circuit 57 then supplies the lighting SUS total signal LOD which represents the lighting sustain total determined for each of the subfields SF3 to SF14 to the drive control circuit 56. The drive control circuit 56 adjusts, in the manner described hereinbelow, the negative polarity peak potential of the wall charge adjustment pulse CP which is applied to the end of the sustain process I for each subfield (SF3 to SF14) on the basis of the lighting sustain total of each subfield (SF3 to SF14) indicated by the lighting SUS total signal LOD. That is, the drive control circuit 56 supplies a control signal for generating a wall charge adjustment pulse CP which has a pulse waveform for which the negative polarity peak potential VP of the wall charge adjustment pulse CP rises, that is, to a potential which is close to 0 volt as shown in FIG. 11 as the lighting sustain total increases to the Y electrode driver 53. For example, in cases where the adjustment is performed on the wall charge adjustment pulse CP which is to be applied at the end of the sustain process I of subfield SF4, the drive control circuit 56 first captures information which indicates the lighting sustain total in subfield SF4 and the preceding subfield SF3 from within the lighting SUS total signal LOD. Further, the drive control circuit 56 supplies a control signal for generating a wall charge adjustment pulse which has a pulse waveform for which the negative polarity peak potential VP rises as the lighting sustain total increases as the wall charge adjustment pulse CP in subfield SF4 to the Y electrode driver 53. Furthermore, in cases where the adjustment is carried out for the wall charge adjustment pulse CP which is to be applied at the end of the sustain process I of subfield SF5, the drive control circuit 56 first captures information which indicates the lighting sustain total of the subfield SF5 and the preceding subfield SF4 from within the lighting SUS total signal LOD. Further, the drive control circuit 56 supplies, as the wall charge adjustment pulse CP in subfield SF5, a control signal for generating a wall charge adjustment pulse which has a pulse waveform which is such that the negative polarity peak potential VP rises, that is, the peak potential VP is a potential close to 0 volt, as the lighting sustain total increases to the Y electrode driver 53. In short, in cases where the probability that an erroneous discharge will be produced directly after the wall charge adjustment pulse CP is high owing to a large number of sustain discharges produced in the subfield (or also including the preceding subfield), adjustment to render the negative polarity peak potential of the wall charge adjustment pulse CP a high potential is carried out for each subfield. With the adjustment, the discharge which is produced in response to the application of the wall charge adjustment pulse CP weakens and the amount of wall charge erased by the discharge is also minimized. Accordingly, because a relatively large amount of wall charge then remains in the discharge cells, wall charge which is adequate in order to produce an erase address discharge reliably in the selective erase address process W_{D} even when a portion of the wall charge is erased when an erroneous discharge is produced, for example, can then be made to remain.

When the pulse waveform of the wall charge adjustment pulse CP is adjusted, the pulse width W5 may also be adjusted instead of the negative polarity peak potential VP of the wall charge adjustment pulse CP as shown in FIG. 11. That is, the drive control circuit 56 performs adjustment to shorten the pulse width W5 of the wall charge adjustment pulse CP of the subfield as the number of sustain discharges which are produced in the subfield (or also including the preceding subfield), that is, the lighting sustain total, increases, for each subfield. As a result of the adjustment, the discharge produced in response to the wall charge adjustment pulse CP weakens and the amount of wall charge erased by the discharge decreases. Accordingly, because a relatively large amount of wall charge then remains in the discharge cells, wall charge which is adequate in order to produce an erase address discharge reliably in the selective erase address process W_{D} even when a portion of the wall charge is erased when an erroneous discharge is produced as mentioned earlier can then be made to remain.

Furthermore, when the pulse waveform of the wall charge adjustment pulse CP is adjusted, the pulse width W5 may also be adjusted in accordance with the lighting sustain total as mentioned earlier in addition to the negative polarity peak potential VP as shown in FIG. 11.

Here, when adjustments (1) to (3) are executed as mentioned earlier, although the total number of one screen's worth of lighting sustain pulses over a predetermined period (a period of at least one subfield) is calculated by the lighting sustain total calculation circuit 57, the total number of lighting sustain pulses may also be individually calculated for each display line. Here, the drive control circuit 56 individually executes, for each display line, adjustments (1) to (3) as mentioned earlier in accordance with the lighting sustain total calculated for each display line.

As mentioned earlier, by independently executing one of the adjustments (1) to (3) and the aforementioned pulse width adjustment to the scan pulses (SP_{W}, SP_{D}) or executing a combination of at least two thereof, an address discharge can be produced reliably in the address process (W2_{W}, W_{D}) even when a portion of the wall charge is erased when an erroneous discharge is produced, for example. An accurate image which corresponds to the video input signal can accordingly be displayed.

Further, the erroneous discharge is produced continuously during the period of execution of the address process (W2_{W}, W_{D}) following the application of the wall charge adjustment pulse CP or reset pulse RP2_{Y2}. Accordingly, as the period from the application of the wall charge adjustment pulse CP or reset pulse RP2_{Y2} until the application of the scan pulses (SP_{W}, SP_{D}) grows longer, the amount of wall charge erased increases and an address discharge becomes hard to produce. That is, following the start value of the address process (W2_{W}, W_{D}), the period from the application of the wall charge adjustment pulse CP or reset pulse RP2_{Y2} to the discharge cells which belong to the row electrode Y₁ until the application of the scan pulses (SP_{W}, SP_{D}), for example, is short. Hence, an address discharge can be reliably produced. However, the period from the application of the wall charge adjustment pulse CP or reset pulse RP2_{Y2} to the discharge cells which belong to the row electrodes Yₙ until the application of the scan pulses (SP_{W}, SP_{D}) is maximum and the wall charge amount is reduced by an amount which corresponds to the interval. It is therefore difficult to produce an address discharge. In particular, in the second selective write address process W2_{W} in which a write address discharge for forming the wall charge is produced, because a negative polarity base pulse BP⁻ is always applied to the row electrodes Y as shown in FIG. 10, an erroneous discharge is easily produced across the row electrodes Y and column electrodes D.

Therefore, in the second selective write address process W2_{W}, a series of operations for the second reset process R2 and second selective write address process W2_{W} in which the row electrodes Y₁ to Yₙ are divided into at least two row electrode groups in order to shorten the maximum period from the application of the reset pulse RP2_{Y2} until the application of the write scan pulse SP_{W} may be temporally distributed between the respective row electrode groups and executed.

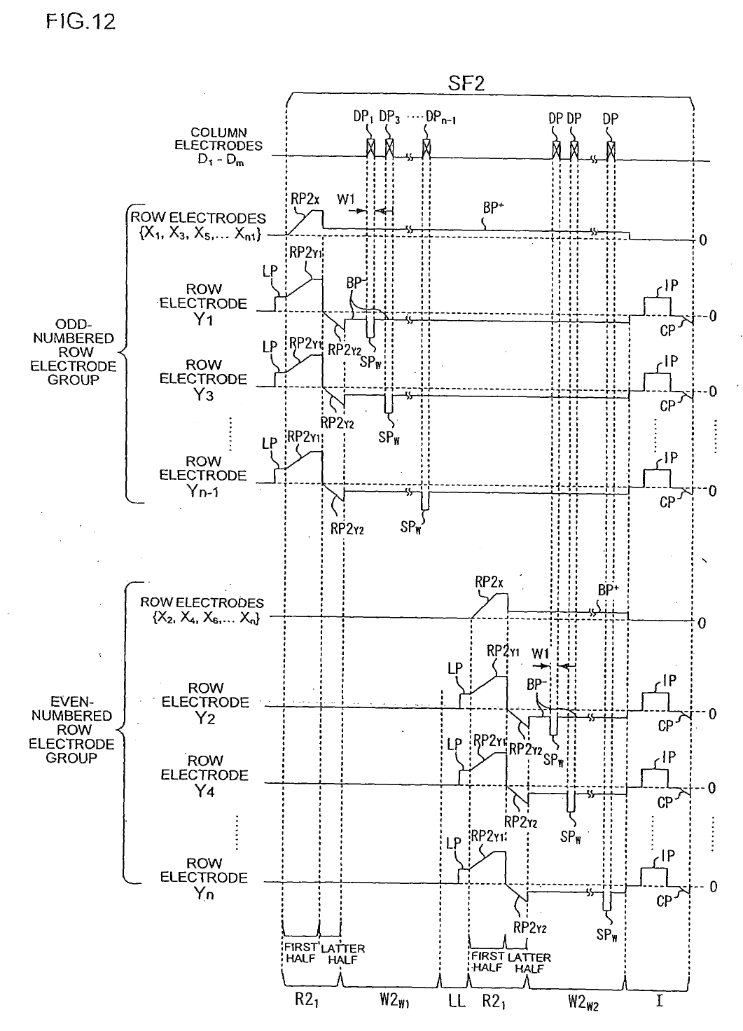

For example, the row electrodes Y₁ to Yₙ are divided into an odd-numbered row electrode group which consists of the row electrodes Y₁, Y₃, Y₅ . . . Yₙ and an even-numbered row electrode group which consists of the row electrodes Y₂, Y₄, Y₆ . . . , Yₙ and the driving indicated by subfield SF2 of FIG. 12 is executed instead of that of subfield SF2 in FIG. 10.

That is, first, the second reset process R2 is executed as mentioned earlier with only the odd-numbered row electrode group as the target (R2₁) and then the second selective write address process W2_{W} is executed with only the odd-numbered row electrode group as the target (W2_{W1}). Subsequently, directly after executing the micro light emission process LL as mentioned earlier with the even-numbered row electrode group as the target, the second reset process R2 is executed with only the even-numbered row electrode group as the target (R2₂) and then the second selective write address process W2_{W} is executed with only the even-numbered row electrode group as the target (W2_{W2}). Thereafter, the sustain process I is executed with all of the row electrodes Y₁ to Yₙ as the target.

According to the driving shown in FIG. 12, in subfield SF2, the maximum period from the application of the reset pulse RP2_{Y2} until the application of the write scan pulse SP_{W} is approximately ½ of that of the case where the driving shown in FIG. 10 is implemented. As a result, even when the amount of wall charge that remains in the discharge cells gradually decreases as a result of the erroneous discharge that is continuously produced, for example, the selective write address discharge with respect to all of the discharge cells can be completed before reducing the amount of wall charge required in order to reliably produce an address discharge.

Although the row electrodes Y₁ to Yₙ are divided into an odd-numbered row electrode group (Y₁, Y₃, Y₅, . . . Yₙ₋₁) and an even-numbered row electrode group (Y₂, Y₄, Y₆, . . . Yₙ) in the embodiment shown in FIG. 12, the division is not limited to such division. For example, the electrodes Y₁ to Yₙ may also be divided into an on-screen row electrode group (Y₁ to Y_{n/2}) which belongs to the upper half of the screen and a below-screen row electrode group (row electrodes Y_{(1+n/2)} to Yₙ) which belongs to the lower half of the screen. Further, the number of groups the row electrodes Y₁ to Yₙ are divided into is not limited to two and may be two or more.

Furthermore, for the driving in subfield SF2, the driving need not be carried out for each field (or frame) as shown in FIG. 12; this driving may be implemented only in cases where the lighting sustain total indicated by the lighting SUS total signal LOD is equal to or more than a predetermined number, that is, where there is a high probability of an erroneous discharge occurring as mentioned earlier.

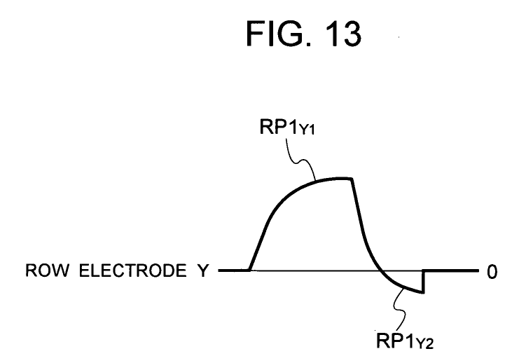

Further, the waveforms for the reset pulses RP1_{Y1} and RP1_{Y2} illustrated in the above embodiment are not limited to waveforms such as those shown in FIG. 10. For example, as shown in FIG. 13, the waveforms may have a gradient that gradually changes during voltage transition as time elapses. In addition, although reset discharges are produced all together for all the discharge cells in the reset process (R1, R2) shown in FIG. 10, reset discharges may also be temporally distributed and executed in discharge cell blocks each comprising a plurality of discharge cells.

Furthermore, although a first reset discharge of a column cathode discharge may be produced by applying the reset pulse RP1_{Y1} to the row electrodes Y₁ to Yₙ in the first half of the first reset process R1 shown in FIG. 10, this step may also be omitted.

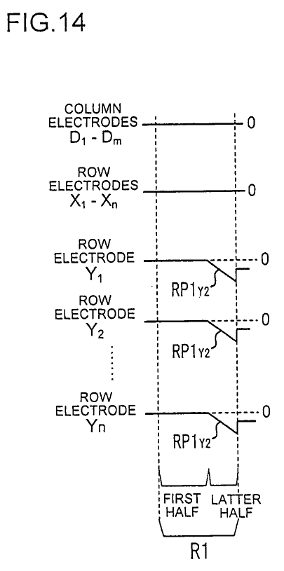

For example, a first reset process R1 is adopted as shown in FIG. 14 instead of the first reset process R1 shown in FIG. 10. In other words, as shown in FIG. 14, the row electrodes Y₁ to Yₙ are fixed at ground potential in the first half of the first reset process R1. That is, the objective of the column cathode discharge from the row electrodes Y to the column electrodes D in the first half of the first reset process R1 is to emit the charged particles in order to stabilize the write discharge in the first selective write address process W1_{W}. However, in cases where a PDP which adopts a structure that contains MgO crystals which include CL light-emitting MgO crystals in the fluorescent layer as shown in FIG. 5, for example, is driven, the write address discharge stabilizes in comparison with a case where a conventional PDP which does not have such a structure is driven. Hence, a configuration which does not produce a column cathode discharge with both the row electrodes Y and column electrodes D at ground potential in the first half of the first reset process R1 can be adopted. In this case, the row electrodes X are also at ground potential level as shown in FIG. 14.

Furthermore, in the driving shown in FIGS. 8 to 10, at the second gray level which represents brightness which is one level higher than the first gray level which represents a black display (brightness level 0), by producing a micro light emission discharge whose discharge intensity is weaker than a single sustain discharge, a brightness level α which is lower than the light emission brightness level caused by the sustain discharge is implemented. Thereupon, at the second gray level, if a light emission brightness level which is caused by a single sustain discharge is rendered instead of the brightness level α, the PDP 50 may also be driven in accordance with a light emission drive sequence excluding the leading SF1 itself among the subfields SF1 to SF14 shown in FIGS. 8 to 10.

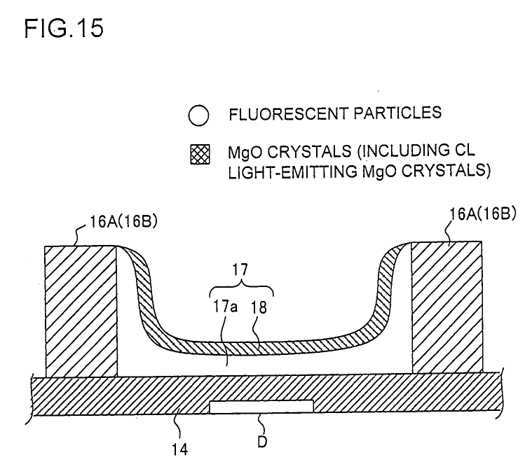

Furthermore, although, in the structure for the PDP 50 shown in FIG. 5, MgO crystals are contained in the fluorescent layer 17 provided on the side of the rear substrate 14, the fluorescent layer 17 may be formed, as shown in FIG. 15, by stacking a fluorescent particle layer 17a consisting of fluorescent particles and a secondary electron emission layer 18 consisting of a secondary electron emission material. Thereupon, crystals consisting of a secondary electron emission material (MgO crystals including CL light-emitting MgO crystals, for example) may be formed by being laid on the surface of the fluorescent particle layer 17a as the secondary electron emission layer 18 or a secondary electron emission material may be formed as a thin-film deposition film.

### Embodiment 2

With the method of driving a plasma display panel of the present invention, an auxiliary pulse of the same polarity as that of the sustain pulse is applied to the column electrodes in a first period which extends from after the application of a final scan pulse which is applied to the first row electrodes in the address process until the application of a leading sustain pulse which is applied in the maintained light emission process starts and, therefore, a reduction in the wall charge of the cells which have been set to lighting-on mode is prevented and a sustain discharge which is stabilized by the leading sustain pulse following the address process can be produced. Inconsistencies in the light emission brightness of the sustain discharge can accordingly be suppressed to permit a favorable image display.

With the method of driving a plasma display panel of the present invention, wherein the leading sustain pulse has a leading edge in which the potential rises during the period from the time the application of the leading sustain pulse starts until the clamping of the sustain pulse at a rated potential and an auxiliary potential of the same polarity as that of the leading sustain pulse is applied to the other row electrodes in a second period which corresponds to the leading edge of the leading sustain pulse for the first row electrodes. Accordingly, a sustain discharge in the second period is prevented because the potential difference across the row electrodes in the second period decreases, and a sustain discharge is produced after the leading sustain pulse is clamped. As a result, the light emission brightness of the sustain discharge is stable and a favorable image display is possible.

An embodiment of the present invention will be described hereinbelow with reference to the drawings.

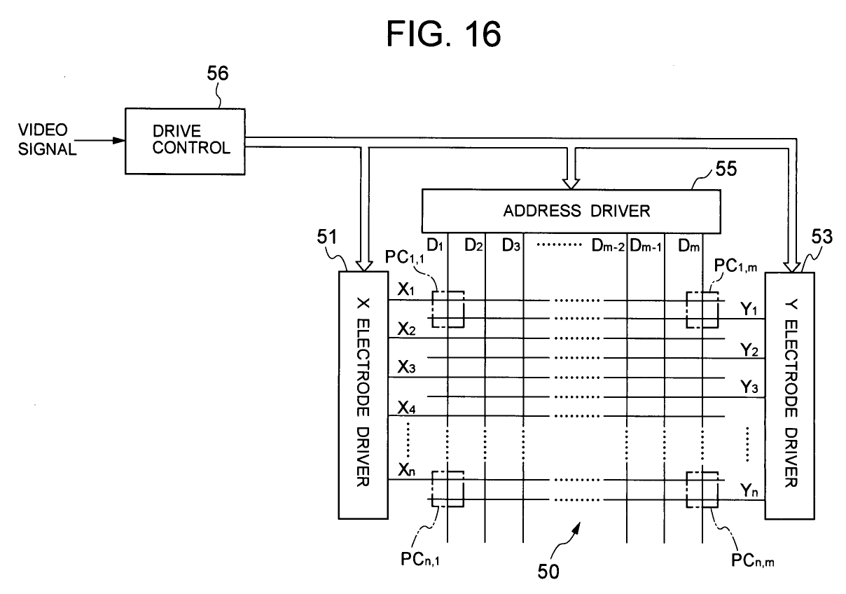

FIG. 16 shows the overall configuration of a plasma display device which drives a plasma display panel in accordance with the driving method of the present invention.

As shown in FIG. 16, the plasma display device is constituted by a plasma display panel (PDP) 50, an X electrode driver 51, a Y electrode driver 53, an address driver 55, and a drive control circuit 56.

In the PDP 50, column electrodes D₁ to Dₘ which are arranged in an extended fashion in the vertical direction (perpendicular direction) of the two-dimensional display screen and row electrodes X₁ to Xₙ and row electrodes Y₁ to Yₙ which are arranged in extended fashion in a lateral direction (horizontal direction) are formed. Here, the row electrode pairs (Y₁, X₁), (Y₂, X₂), (Y₃, X₃), . . . , (Yₙ, Xₙ) which are mutually adjacent to one another and together form pairs each carry the first to nth display lines of the PDP 50. The discharge cells PC_{1,1} to PC_{n,m} which carry the pixels are formed at the intersections between the respective display lines and column electrodes D₁ to Dₘ (the area surrounded by the dot-chain line in FIG. 16). That is, the PDP 50 has discharge cells PC_{1,1} to PC_{n,m} which belong to the first display line, discharge cells PC_{2,1} to PC_{1,m} which belong to the second display line, . . . , and discharge cells PC_{n,1} to PC_{n,m} which belong to the nth display line arranged in the form of a matrix.

As mentioned earlier, the internal structure of the PDP 50 is illustrated in FIG. 2 and is the same as the cross-section described. Further, a cross-section of the PDP 50 along the lone V-V in FIG. 2 and a cross-section of the PDP 50 along the lone W-W in FIG. 2 are shown in FIGS. 3 and 4 respectively and are the same as the cross-sections described. In addition, the cross-sectional view of FIG. 5 is provided for the MgO crystals contained in the fluorescent layer 17 and is the same as the cross-section described.

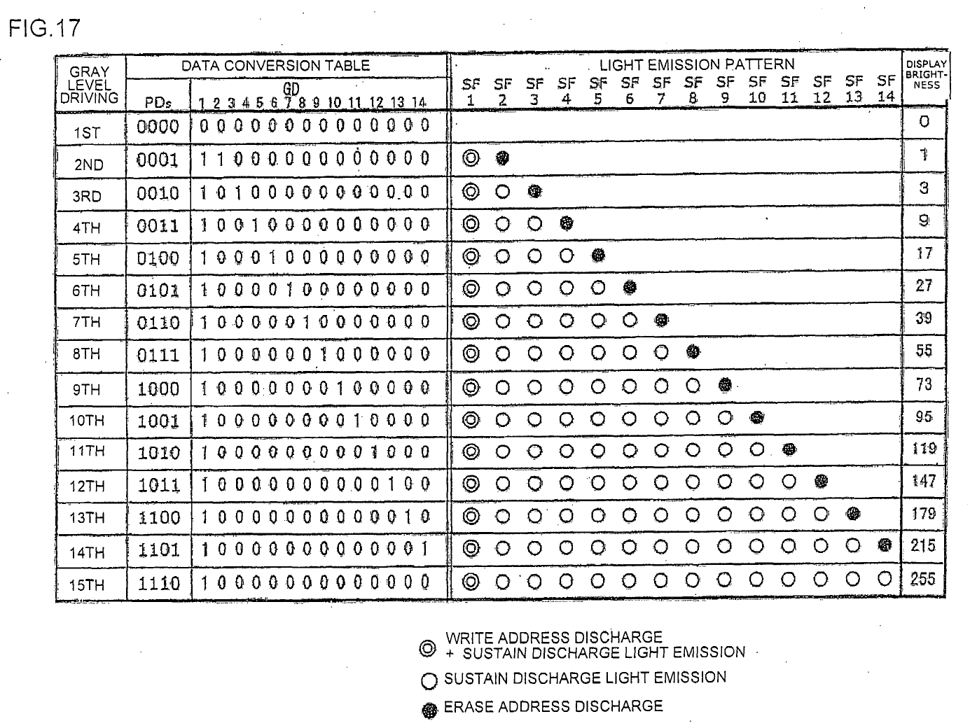

The drive control circuit 56 first converts the video input signal into 8-bit pixel data which represent all of the brightness levels of each of the respective pixels by means of 256 gray levels and performs multiple gray level processing which comprises random dither processing and dither processing on the pixel data. That is, first, in the random dither processing, the upper six bits' worth of the pixel data are taken as the display data and the remaining lower two bits' worth of the pixel data are taken as the error data and data obtained by adding a weighting to the error data of the pixel data which correspond to each of the peripheral pixels are mirrored in the display data in order to obtain the six bits' worth of random dither processing pixel data. With this random dither processing, the lower two bits' worth of brightness of the source pixels are represented in pseudo fashion by the peripheral pixels and, as a result, a brightness gray level representation which is the same as that of the eight bits' worth of pixel data is possible by means of six bits' worth of display data which is a smaller number than the eight bits' worth of display data. Thereafter, the drive control circuit 56 performs dither processing on the 6-bit random dither processing pixel data obtained by means of the random dither processing. In the dither processing, a plurality of pixels which are adjacent to one another are taken as a single pixel unit and dither-added pixel data are obtained by assigning and adding dither coefficients consisting of mutually different coefficient values to each of the random dither processing pixel data which correspond to the respective pixels in the single pixel unit. As a result of the addition of the dither coefficients, in cases where the pixels are viewed as a pixel unit as above, brightness which corresponds to that afforded by eight bits can be rendered by means of only the upper four bits' worth of the dither-added pixel data. Therefore, the drive control circuit 56 converts the upper four bits' worth of dither-added pixel data into four-bit multiple gray level pixel data PD_{S} which represent all of the brightness levels by means of fifteen gray levels as shown in FIG. 17. The drive control circuit 56 then converts the multiple gray level pixel data PD_{S} into 14-bit pixel driving data GD in accordance with a data conversion table as shown in FIG. 17. The drive control circuit 56 matches the first to fourteenth bits of the pixel driving data GD with each of the subfields SF1 to SF14 (described subsequently) and supplies the bits which correspond to the subfields SF to the address driver 55 one display line at a time (m) as pixel driving data bits.

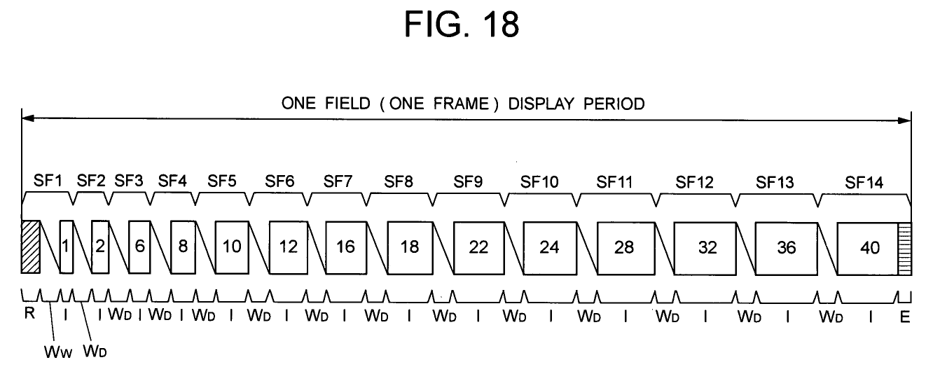

In addition, the drive control circuit 56 supplies various control signals for driving the PDP 50 with the above structure in accordance with a light emission drive sequence as shown in FIG. 18 to a panel driver which comprises the X electrode driver 51, Y electrode driver 53, and address driver 55. That is, the drive control circuit 56 supplies various control signals for sequentially implementing driving which corresponds to each of the reset process (first reset process) R, the selective write address process W_{W} and the sustain (maintained discharge) process I in the leading subfield SF1 within a single field (single frame) display period as shown in FIG. 18 to the panel driver. In each of the subfields SF2 to SF14, the drive control circuit 56 supplies various control signals for sequentially implementing driving which corresponds to each of the selective erase address process W_{D} and the sustain process (maintained light emission process) I to the panel driver. Only in the last subfield SF14 in one field display period and following the execution of the sustain process I, the drive control circuit 56 supplies various control signals for sequentially implementing driving in accordance with the erase process E to the panel driver.

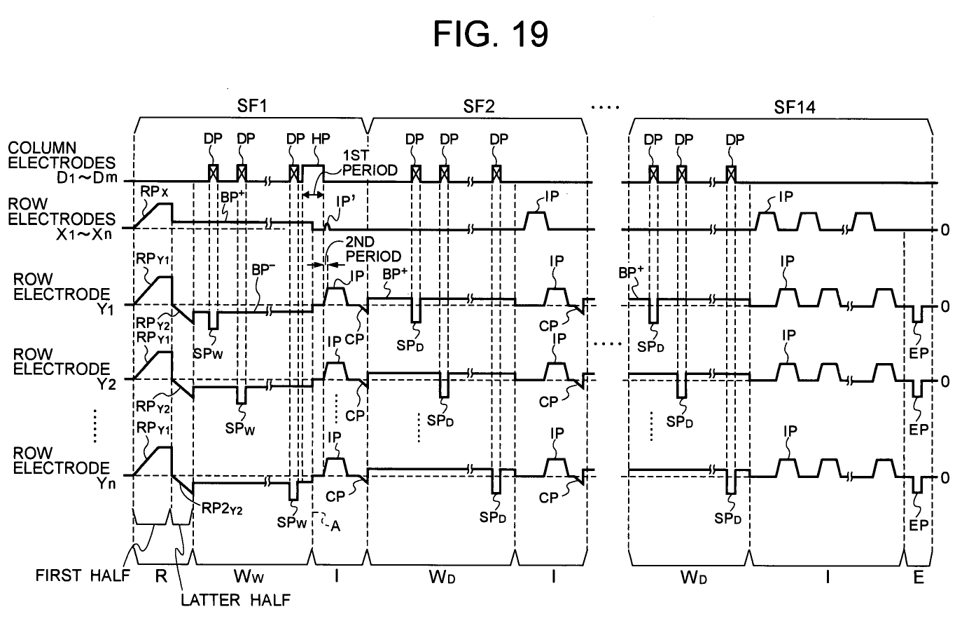

The panel drivers, that is, the X electrode driver 51, Y electrode driver 53, and address driver 55 generate various drive pulses as shown in FIG. 19 in accordance with the various control signals supplied by the drive control circuit 56 and supplies the various drive pulses to the column electrodes D and row electrodes X and Y of the PDP 50.

In FIG. 19, the operation of only the leading subfield SF1, the next subfield SF2, and the last subfield SF14 are selectively shown among the subfields SF1 to SF14 shown in FIG. 18.

First, in the first half of the reset process R of the subfield SF1, the Y electrode driver 53 applies a positive polarity reset pulse RP_{Y1} which has a waveform in which the potential transition at the leading edge as time elapses is gradual in comparison with the subsequent sustain pulse (maintenance pulse) to all of the row electrodes Y₁ to Yₙ. The peak potential of the reset pulse RP_{Y1} is a potential which is higher than the peak potential of the sustain pulse. Meanwhile, the address driver 55 sets the column electrodes D₁ to Dₘ to a ground potential (0 volt) state. The first reset discharge is produced across the row electrodes Y and column electrodes D in all of the discharge cells PC in accordance with the application of the reset pulse RP_{Y1}. That is, by applying a voltage across the row electrodes Y and column electrodes D in the first half of the reset process R so that the row electrodes Y are anodic and the column electrodes D are cathodic, a discharge in which the current flows from the row electrodes Y to the column electrodes D (referred to as the ‘column cathode discharge’ hereinbelow) is produced as the first reset discharge. A wall charge of a negative polarity is formed close to the row electrodes Y in all of the discharge cells PC and a wall charge of a positive polarity is formed close to the column electrodes D in accordance with the first reset discharge.

In addition, in the first half of the reset process R, the X electrode driver 51 applies the reset pulse RP_{X} which has the same polarity as that of the reset pulse RP_{Y1} and has a peak potential that makes it possible to prevent surface discharge across the row electrodes X and Y which is caused by the application of the reset pulse RP_{Y1} to all of the row electrodes X₁ to Xₙ.

Further, in the latter half of the reset process R of subfield SF1, the Y electrode driver 53 generates a negative polarity reset pulse RP_{Y2} in which the potential transition at the leading edge as time elapses is gradual and applies the negative polarity reset pulse RP_{Y2} to all of the row electrodes Y₁ to Yₙ. Further, in the latter half of the reset process R, the X electrode driver 51 applies a base pulse BP⁺ which has a positive polarity peak potential as shown in FIG. 19 to each of the row electrodes X₁ to Xₙ. A second reset discharge is produced across the row electrodes X and Y in all of the discharge cells PC in accordance with the application of the negative polarity reset pulse RP_{Y2} and the positive polarity base pulse BP⁺. As a result of the second reset discharge, the majority of the wall charge formed close to each of the row electrodes X and Y in all of the discharge cells PC is erased. As a result, all of the discharge cells PC are initialized in lighting-off mode. Further, a weak discharge is also produced across the row electrodes Y and column electrodes D within all of the discharge cells PC in response to the application of the reset pulse RP_{Y2} and a portion of the positive polarity wall charge formed close to the column electrodes D is erased. As a result, the amount of wall charge which remains close to the column electrodes D of all of the discharge cells PC is adjusted to an amount which makes it possible to produce a selective write address discharge correctly in the selective write address process W_{W} (described subsequently).

The voltage that is applied across the row electrodes X and Y by the reset pulse RP_{Y2} and base pulse BP⁺ is a voltage that makes it possible to produce the second reset discharge reliably across the row electrodes X and Y after considering the wall charge formed close to the row electrodes X and Y respectively in accordance with the first reset discharge. Further, the negative peak potential of the reset pulse RP_{Y2} is set at a higher potential than the peak potential of the subsequently described negative polarity write scan pulse SP_{W}, that is, at a potential which is close to 0 volt. In other words, this is because, when the peak potential of the reset pulse RP_{Y2} is made lower than the peak potential of the write scan pulse SP_{W}, a strong discharge is produced across the row electrodes Y and column electrodes D, the wall charge formed close to the column electrodes D is largely erased and the address discharge in the selective write address process W_{W} becomes unstable.

Thereafter, in the selective write address process W_{W} of the subfield SF1, the Y electrode driver 53 simultaneously applies a base pulse BP⁻ with a negative polarity peak potential to the row electrodes Y₁ to Yₙ as shown in FIG. 19 while alternatively and sequentially applying a write scan pulse SP_{W} with a negative polarity peak potential to each of the row electrodes Y₁ to Yₙ. The X electrode driver 51 meanwhile continuously applies a base pulse BP⁺ with a positive polarity peak potential to each of the row electrodes X₁ to Xₙ. Thereupon, the voltage which is applied across the row electrodes X and Y by the base pulse BP⁺ and base pulse BP⁻ may be lower than the discharge start voltage of the discharge cells PC.

Furthermore, in the selective write address process W_{W}, the address driver 55 first converts the pixel driving data bit which corresponds to subfield SF1 into a pixel data pulse DP which has a pulse voltage that corresponds to the logic level of the pixel driving data bit. For example, in cases where a pixel driving data bit of logic level 1 for setting the discharge cells PC to the lighting-on mode is supplied, the address driver 55 converts the logic level-1 pixel driving data bit into a pixel data pulse DP which has a positive polarity peak potential. However, the address driver 55 converts the logic level-0 pixel driving data bit for setting the discharge cells PC to a lighting-off mode into a low voltage (0 volt) pixel data pulse DP. Further, the address driver 55 applies the pixel data pulse DP to the column electrodes D₁ to Dₘ in synchronism with the application timing of the respective write scan pulses SP_{W} one display line's worth of the pixel data pulse DP at a time (m). Thereupon, a selective write address discharge is produced across the column electrodes D and row electrodes Y in the discharge cells PC to which a high voltage pixel data pulse DP for setting the discharge cells PC to lighting-on mode is applied at the same time as the write scan pulse SP_{W}. Furthermore, directly after the selective write address discharge, a weak discharge is also produced across the row electrodes X and Y in the discharge cells PC. That is, a voltage which corresponds to the base pulses BP⁻ and BP⁺ is applied across the row electrodes X and Y after the write scan pulse SP_{W} has been applied. However, since the voltage is set at a voltage which is lower than the discharge start voltage of the respective discharge cells PC, a discharge cannot be produced within the discharge cells PC merely through the application of the voltage. However, when the selective write address discharge is produced, a discharge is produced across the row electrodes X and Y merely by applying the voltage of the base pulses BP⁻ and BP⁺ through induction by the selective write address discharge. As a result of the discharge and the selective write address discharge, the discharge cells PC are set to a state where a positive polarity wall charge is formed close to the row electrodes Y, a negative polarity wall charge is formed close to the row electrodes X, and a negative polarity wall charge is formed close to the column electrodes D, that is, to lighting-on mode. However, the earlier mentioned selective write address discharge is not produced across the column electrodes D and row electrodes Y in the discharge cells PC to which a low voltage (0 volt) pixel data pulse DP for setting the discharge cells PC to lighting-off mode is applied at the same time as the write scan pulse SP_{W} and, consequently, a discharge is not produced across the row electrodes X and Y. Accordingly, the discharge cells PC maintain the preceding state, that is, the lighting-off mode state that was initialized in the reset process R.

In the selective write address process W_{W}, the final pixel data pulse DP is applied to the column electrodes D₁ to Dₘ at the same time as the write scan pulse SP_{W} which is applied to the row electrodes Yₙ and, when the application of the final pixel data pulse DP is complete, an auxiliary pulse HP is applied to the column electrodes D₁ to Dₘ directly afterwards. The auxiliary pulse HP is a pulse which has the same positive polarity potential as the pixel data pulse DP. The auxiliary pulse HP has a pulse width up until directly before the application of the initial sustain pulse IP of the next sustain process I.

Thereafter, in the sustain process I of subfield SF1, the Y electrode driver 53 generates one pulse's worth of a sustain pulse IP which has a positive polarity peak potential and simultaneously applies the sustain pulse IP to each of the row electrodes Y₁ to Yₙ. The X electrode driver 51 sets the row electrodes X₁ to Xₙ in a floating state in the leading period of the sustain pulse IP which is applied to each of the row electrodes Y₁ to Yₙ and sets the row electrodes X₁ to Xₙ to a ground potential (0 volt) state in the remaining period of application of the subsequent sustain pulses IP. As a result, a pulse IP′ is generated in the row electrodes X₁ to Xₙ.

In the sustain process I of the subfield SF1, a sustain discharge is produced across the row electrodes X and Y in the discharge cells PC in the lighting-on mode state in response to the application of the sustain pulse IP. As a result of the light which is irradiated by the fluorescent layer 17 being irradiated to the outside via the front transparent substrate 10 in accordance with the sustain discharge, display light emission which corresponds to the brightness weighting of subfield SF1 is performed. Further, a discharge is also produced across the row electrodes Y and column electrodes D in the discharge cells PC in the lighting-on mode state in response to the application of the sustain pulse IP. As a result of the discharge and the sustain discharge, a negative polarity wall charge is formed close to the row electrodes Y in the discharge cells PC and a positive polarity wall charge is formed close to each of the row electrodes X and column electrodes D.

Further, following the application of the sustain pulse IP, the Y electrode driver 53 applies a wall charge adjustment pulse CP in which the potential transition at the leading edge as time elapses is gradual and which has a negative polarity peak potential as shown in FIG. 19 to the row electrodes Y₁ to Yₙ. A weak erase discharge is produced in the discharge cells PC in which a sustain discharge is produced as mentioned earlier in response to the application of the wall charge adjustment pulse CP and a portion of the wall charge formed in the discharge cells PC is erased. As a result, the amount of wall charge in the discharge cells PC is adjusted to an amount that makes it possible to produce a selective erase address discharge correctly in the next selective erase address process W_{D}.

Thereafter, in the selective erase address process W_{D} of each of the subfields SF2 to SF14, the Y electrode driver 53 applies a base pulse BP⁺ which has a predetermined peak potential of a positive polarity to each of the row electrodes Y₁ to Yₙ while alternatively and sequentially applying an erase scan pulse SP_{D} which has a negative polarity peak potential to each of the row electrodes Y₁ to Yₙ as shown in FIG. 19. The potential of the base pulse BP⁺ is set at a potential which makes it possible to prevent erroneous discharge across the row electrodes X and Y during the period of execution of the selective erase address process W_{D}. Further, during the period of execution of the selective erase address process W_{D}, the X electrode driver 51 sets each of the row electrodes X₁ to Xₙ at ground potential (0 volt). Further, in the selective erase address process W_{D}, the address driver 55 first converts the pixel driving data bit which corresponds to the subfield SF into a pixel data pulse DP which has a pulse voltage which corresponds to the logic level. For example, in cases where a pixel driving data bit of logic level 1 which serves to shift the discharge cells PC from the lighting-on mode to the lighting-off mode is supplied, the address driver 55 converts the logic level-1 pixel driving data bit into a pixel data pulse DP which has a positive polarity peak potential. However, in cases where a pixel driving data bit of logic level 0 which is for maintaining the current state of the discharge cells PC is supplied, the address driver 55 converts the logic level-0 pixel driving data bit into a low voltage (0 volt) pixel data pulse DP. Further, the address driver 55 applies the pixel data pulse DP to the column electrodes D₁ to Dₘ in synchronism with the application timing of the respective erase scan pulses SP_{D} one display line's worth at a time (m). Thereupon, a selective erase address discharge is produced across the column electrodes D and row electrodes Y in the discharge cells PC to which a high-voltage, positive-polarity pixel data pulse DP is applied at the same time as the erase scan pulse SP_{D}. As a result of the selective erase address discharge, the discharge cells PC are set to a state where a positive polarity wall charge is formed close to the row electrodes X and Y and a negative polarity wall charge is formed close to the column electrodes D, that is, to lighting-off mode. However, a selective erase address discharge is not produced, as mentioned earlier, across the column electrodes D and row electrodes Y in the discharge cells PC to which a low voltage (0 volt) pixel data pulse DP is applied at the same time as the erase scan pulse SP_{D}. Accordingly, the discharge cells PC maintain the preceding state (the lighting-on mode, lighting-off mode).

Thereafter, in the sustain process I of each of the subfields SF2 to SF14, the X electrode driver 51 and Y electrode driver 53 apply a sustain pulse IP which has a positive polarity peak potential alternately to the row electrodes X and Y as shown in FIG. 19 and repeatedly by a number of times corresponding to the subfield brightness weighting (an even number of times). The X electrode driver 51 sets the row electrodes X₁ to Xₙ to a ground potential state in the period of application of the sustain pulse IP applied to each of the row electrodes Y₁ to Yₙ. The Y electrode driver 53 sets the row electrodes Y₁ to Yₙ to a ground potential state during the period of application of the sustain pulse IP which is applied to each of the row electrodes X₁ to Xₙ.

In the sustain process I of each of the subfields SF2 to SF14, a sustain discharge is produced across the row electrodes X and Y in the discharge cells PC which have been set to lighting-on mode each time a sustain pulse IP is applied as shown in FIG. 19. Thereupon, as a result of the light irradiated by the fluorescent layer 17 being irradiated to the outside via the front transparent substrate 10 in accordance with the sustain discharge, light emission a number of times which corresponds to the brightness weighting of subfield SF is performed.

Here, in the sustain process I of each of the subfields SF2 to SF14, a negative polarity wall charge is formed close to the row electrodes Y in the discharge cells PC in which a sustain discharge has been produced in response to the final sustain pulse IP and a positive polarity wall charge is formed close to each of the row electrodes X and column electrodes D. Following the application of the final sustain pulse IP, the Y electrode driver 53 applies a wall charge adjustment pulse CP in which the potential transition at the leading edge as time elapses is gradual and which has a negative polarity peak potential as shown in FIG. 19 to the row electrodes Y₁ to Yₙ. A weak erase discharge is produced in the discharge cells PC in which a sustain discharge is produced as mentioned earlier in response to the application of the wall charge adjustment pulse CP and a portion of the wall charge formed in the discharge cells PC is erased. As a result, the amount of wall charge in the discharge cells PC is adjusted to an amount that makes it possible to produce a selective erase address discharge correctly in the next selective erase address process W_{D}.

Further, at the end of the final subfield SF14, the Y electrode driver 53 applies an erase pulse EP which has a negative polarity peak potential to all of the row electrodes Y₁ to Yₙ. An erase discharge is produced only in the discharge cells PC in a lighting-on mode state in response to the application of the erase pulse EP. The discharge cells PC in the lighting-on mode state make the transition to the lighting-off mode state as a result of the erase discharge.

The driving is executed as above on the basis of fifteen different pixel driving data GD as shown in FIG. 17. With this driving, except for a case where brightness level 0 is rendered (first gray level) as shown in FIG. 17, a write address discharge is first produced in each discharge cell PC in the leading subfield SF1 (indicated by two overlapping circles) and the discharge cells PC are set to lighting-on mode. Thereafter, a selective erase address discharge is produced only in the selective erase address process W_{D} of one subfield in each of the subfields SF2 to SF14 (indicated by a black circle), whereupon the discharge cells PC are set to lighting-off mode. That is, the respective discharge cells PC are set to lighting-on mode in each of the consecutive subfields only in a quantity which corresponds to the center brightness which is to be rendered and light emission which is caused by the sustain discharge is produced repeatedly a number of times that is assigned to each of the subfields (indicated by a white circle). Thereupon, brightness which corresponds to the total number of sustain discharges produced in one field (or one frame) display period is visualized. Accordingly, with fifteen types of light emission patterns of the first to fifteenth gray level driving as shown in FIG. 17, fifteen gray levels' worth of center brightness which corresponds to the total number of sustain discharges produced in each of the subfields indicated by white circles is rendered. With this driving, because there is no mixing within one screen of areas in which the light emission patterns (lit state, unlit state) are mutually inverted within one field display period, a pseudo contour that arises in such a state is prevented.

Furthermore, in the driving shown in FIG. 19, the number of sustain pulses IP which are to be applied in the sustain process I of each of the subfields SF2 to SF14 is an even number. Accordingly, directly after the end of each sustain process I, because a state is assumed where a negative polarity wall charge is formed close to the row electrodes Y and a positive polarity wall charge is formed close to the column electrodes D, in the selective erase address process W_{D} which is successively carried out in each sustain process I, a discharge in which the column electrodes D are the cathode side (referred to as the ‘column cathode discharge’ hereinbelow) is possible across the column electrodes D and row electrodes Y. Therefore, positive polarity pulses are only applied to the column electrodes D and an increase in costs for the address driver 55 is prevented.

In the driving shown in FIGS. 18 and 19, all of the discharge cells PC are first initialized in lighting-off mode in the leading subfield SF1 by applying a reset discharge to same and, except for a cases where a black display (brightness level 0) is executed, a write address discharge is produced for each of the discharge cells PC to shift same to lighting-on mode. Thereupon, in cases where a black display is executed by this driving, the discharge that is produced via one field display period is only the reset discharge in the leading subfield SF1. Accordingly, in comparison with a case where driving to produce a selective erase address discharge in order to shift the discharge cells to lighting-off mode is adopted after all of the discharge cells have been subjected to a reset discharge and initialized in a lighting-on mode state, there is a reduction in the number of discharges produced in one field display field. Therefore, with the driving, the contrast when displaying a dark image, that is, so-called darkness contrast can be improved.

Furthermore, in the driving shown in FIGS. 18 and 19, by applying a voltage across the two electrodes in the reset process R of the leading subfield SF1 so that the column electrodes D are cathodic and the row electrodes Y are anodic, a column cathode discharge in which the current flows from the row electrodes Y to the column electrodes D is produced as the first reset discharge. Accordingly, during the first reset discharge, when anode ions in the discharge gas move toward the column electrode D, the anode ions collide with MgO crystals which are a secondary electron emission material contained in the fluorescent layer 17 as shown in FIG. 5 and secondary electrons are emitted by the MgO crystals. In a PDP 50 of the plasma display device shown in FIG. 1 in particular, by exposing the MgO crystals to a discharge space as shown in FIG. 5, the probability of the collision with the anode ions is raised so that the secondary electrons are efficiently emitted to the discharge space. Because the discharge start voltage of the discharge cells PC is low as a result of the priming action by the secondary electrons, a relatively weak reset discharge can be produced. Accordingly, because the light emission brightness caused by the discharge drops as a result of the weakened reset discharge, a display with an improved darkness contrast is possible.

Furthermore, in the driving shown in FIG. 19, the first reset discharge is produced across the row electrodes Y formed on the side of the transparent substrate 10 and the column electrodes D formed on the side of the rear substrate 14, as shown in FIG. 3. Accordingly, in comparison with a case where a reset discharge is produced across the row electrodes X and Y formed on the side of the front transparent substrate 10, the discharged light emitted by the front transparent substrate 10 to the outside is reduced and, therefore, further darkness contrast improvements are possible.

In addition, in the driving shown in FIG. 19, by applying a sustain pulse IP only once in the sustain process I of subfield SF1 which has the smallest brightness weighting, the display reproducibility with respect to a low brightness image is raised by making the number of sustain discharges only a single sustain discharge. Further, following the end of the sustain discharge which is produced in accordance with the single sustain pulse IP, a state is assumed where a negative polarity wall charge is formed close to the row electrodes Y and positive polarity wall charge is formed close to the column electrodes D. As a result, when implementing the driving shown in FIG. 19, the column anode discharge can be produced as a selective erase address discharge in the selective erase address process W_{D} of subfield SF2.

Furthermore, the PDP 50 shown in FIG. 16 contains CL light-emitting MgO crystals which constitute a secondary electron emission material not only in the magnesium oxide layer 13 formed on the side of the front transparent substrate 10 in each of the discharge cells PC but also in the fluorescent layer 17 which is formed on the side of the rear substrate 14.

The operating effects of adopting the configuration will be described hereinbelow with reference to FIGS. 6 and 7.

FIG. 6 represents the transition of the discharge intensity of the column cathode discharge that is produced when applying a reset pulse RP_{Y1} as shown in FIG. 8 to a so-called conventional PDP which contains CL light-emitting MgO crystals only in the magnesium oxide layer 13 among the magnesium oxide layer 13 and fluorescent layer 17.

However, FIG. 7 shows the transition of the discharge intensity of the column cathode discharge that is produced when applying reset pulse RP_{Y1} to a PDP 50 which contains CL light-emitting MgO crystals in both the magnesium oxide layer 13 and the fluorescent layer 17.

As shown in FIG. 6, with a conventional PDP, a relatively strong column cathode discharge continues for 1 [ms] or more in response to the application of the reset pulse RP_{Y1}. However, with the PDP 50 of the embodiment, the column cathode discharge ends within approximately 0.04 [ms] as shown in FIG. 7. That is, the discharge delay time of the column cathode discharge can be markedly shortened in comparison with a conventional PDP.

Therefore, as shown in FIG. 19, when a column cathode discharge is produced by applying a reset pulse RP_{Y1} which has a waveform in which the potential transition at the leading edge of the pulse is gradual to the row electrodes Y of the PDP 50, the discharge ends before the potential of the reset pulse RP_{Y1} arrives at the peak potential. Accordingly, because the column cathode discharge ends at the stage where the voltage which is applied across the row electrodes and column electrodes is low, the discharge intensity also drops markedly as shown in FIG. 7.

That is, by applying a reset pulse RP_{Y1} as shown in FIG. 19, for example, which has a waveform in which the potential transition at the leading edge of the pulse is gradual to the PDP 50 in which CL light-emitting MgO crystals are contained not only in the magnesium oxide layer 13 but also in the fluorescent layer 17, a column cathode discharge with a weakened discharge intensity is produced. Therefore, because it is possible to produce a column cathode discharge with an extremely weak discharge intensity as the reset discharge, the contrast of the image and, in particular, the darkness contrast when a dark image is displayed can be raised.

Furthermore, after the selective write address process W_{W} in the driving of FIG. 19, the lighting-on mode discharge cells assume a state where positive wall charge adheres to the side of the row electrodes Y and negative wall charge adheres to the side of the column electrodes D as a result of the address discharge. As a result of the effect of the wall charge, a micro column cathode discharge is produced across the row electrodes Y and column electrodes D during the period from after the selective write address process W_{W} up until before the sustain process I. As a result of the micro column cathode discharge, the wall charge on the side of the row electrodes Y and column electrodes D decreases and the sustain discharge across the row electrodes X and Y and across the row electrodes Y and column electrodes D which should arise as a result of the leading sustain pulse IP which immediately follows does not stabilize and there are cases where a lit state is not produced. In particular, in a PDP which contains CL light-emitting MgO crystals in the fluorescent layer, the column cathode discharge characteristic across the row electrodes Y and column electrodes D is favorable and a micro column cathode discharge occurs all the more readily.

Therefore, in the period from directly after the application of the final sustain pulse SP_{W} until directly before the application of the leading sustain pulse IP which is a period in which the micro column cathode discharge readily occurs, the positive polarity auxiliary pulse HP is applied to the column electrodes D₁ to Dₘ as mentioned earlier. As a result, the generation of a micro column cathode discharge can be prevented, whereby a stable sustain discharge can be produced in the leading sustain pulse IP after the selective write address process W_{W}.

The micro column cathode discharge readily occurs in the period in which the base pulse BP⁻ to the row electrodes Y is rising toward a positive polarity. This is thought to be because the rise of the potential difference across the row electrodes Y and column electrodes D is then minimal. When this point is considered, although an embodiment in which an auxiliary pulse HP is applied in a first period which extends from directly after the application of the final sustain pulse SP_{W} until directly before the application of the leading sustain pulse IP was illustrated in the embodiment shown in FIG. 19, the occurrence of a micro column cathode discharge can also be prevented by means of a configuration which applies the auxiliary pulse HP only in at least the rising period of the base pulse BP⁻ (the period which contains boundary line A between the selective write address process W_{W} and the sustain process I of subfield SF1 in FIG. 19) as the first period.

In the leading sustain pulse IP of the sustain process I of subfield SF1, a surface discharge across the row electrodes X and Y is produced and, with the object of mirroring the wall charge on the side of the column electrodes D, that is, in order to produce a selective erase address by means of a positive polarity pixel data pulse DP in the subsequent selective erase address process W_{D}, a column cathode discharge is produced across the row electrodes Y and column electrodes D. Here, during the application of the leading sustain pulse IP, when a column cathode discharge is produced across the row electrodes Y and column electrodes D in the leading edge period (rising period) prior to the surface discharge across the row electrodes X and Y, there are cases where the wall charge of the row electrodes Y decreases and the surface discharge across the row electrodes X and Y is not stable and, in the worst case, where there is no lighting.

Therefore, by setting row electrodes X to which a sustain pulse IP has not been applied in a floating state in the leading edge period, a positive polarity potential (auxiliary potential) of the same polarity as that of the sustain pulse IP is applied to the row electrodes X and a pulse IP′ is produced. Hence, the potential difference across the row electrodes X and Y decreases. The column cathode discharge across the row electrodes Y and column electrodes D is induced to the size of the potential difference across the row electrodes X and Y (field intensity) and discharge readily occurs. Therefore, by reducing the potential difference across the row electrodes X and Y, a column cathode discharge across the row electrodes Y and column electrodes D in the leading edge period can be prevented. Further, after clamping the row electrodes Y to a rated potential Vs, the column cathode discharge is produced across the row electrodes Y and column electrodes D substantially at the same time as the surface discharge across the row electrodes X and Y and the reduction in the wall charge during the surface discharge across the row electrodes X and Y is suppressed, whereby the surface discharge across the row electrodes X and Y stabilizes.

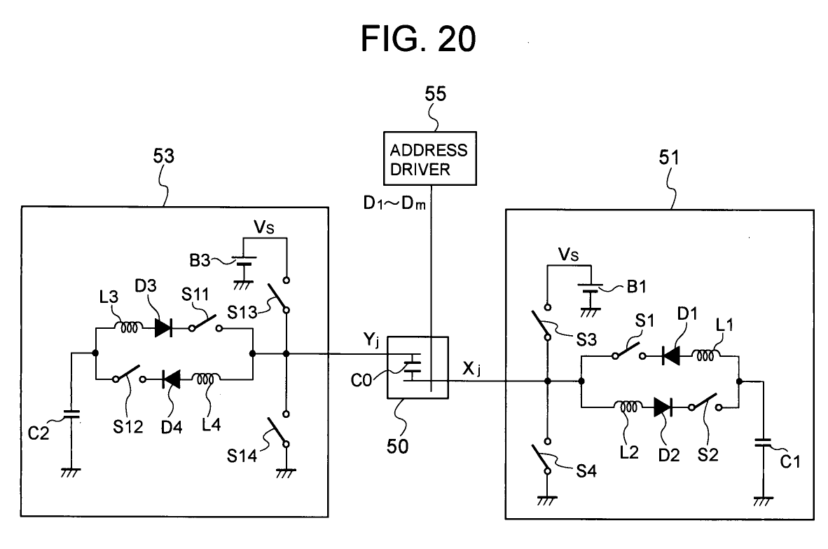

The sustain pulse IP and pulse IP′ are generated by the respective sustain pulse generation circuits of the X electrode driver 51 and Y electrode driver 53. FIG. 20 shows the configuration of the sustain pulse generation circuit which is for the row electrodes Xj, Yj of discharge cells PC_{j,1} to PC_{j,m} of the j-th display line which is one display line among the first display line to the nth display line of the PDP 50.

The circuit on the row electrode Xj side comprises switch elements S1, S2, S3, and S4, coils L1 and L2, diodes D1 and D2, a capacitor C1, and a DC power source B1. In the circuit of the row electrode Xj, a series circuit which comprises switch element S1, diode D1 and coil L1 and a series circuit which comprises coil L2, diode D2 and switch element S12 are connected in parallel. The respective first ends of these series circuits are connected to row electrode Xj while the other ends of the series circuits are commonly grounded via capacitor C1. Furthermore, the respective first ends of the series circuits are connected via the switch element S3 to a supply line for supplying voltage Vs from the power supply B1 and grounded via the switch element S4.

The circuit on the row electrode Yj side comprises switch elements S11, S12, S13, and S14, coils L3 and L4, diodes D3 and D4, a capacitor C2, and a DC power source B3. Each of these parts is connected in the same way as the parts of the circuit on the row electrode Xj side. The circuit is shown as an equivalent circuit in which capacitor C0 is connected across the row electrodes Xj and Yj. The respective capacitances of the capacitors C1 and C2 are sufficiently large in comparison with the capacity of the capacitor C0.

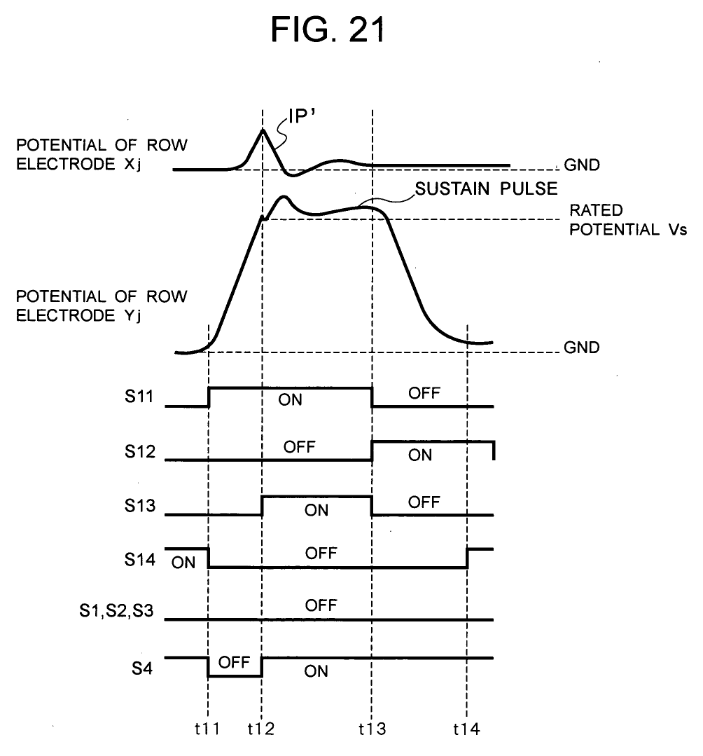

In the sustain pulse generation circuit, in cases where a sustain pulse IP is applied to the row electrode Yj in the sustain process I of the subfield SF1, the switch element S11 is turned ON at time t11 as shown in FIG. 21. Here, the other switch element is OFF. When the switch element S11 turns ON when the voltage across the terminals of the capacitor C0 is 0V, as a result of the resonance action of the coil L3 and capacitor C0, a current flows from the capacitor C2 to the capacitor C0 via the coil L3, diode D3, and then the switch element S11. Accordingly, the potential of the row electrode Yj rises as shown in FIG. 21 and the leading edge part of the sustain pulse is formed. The potential of the row electrode Xj, which is capacitance-coupled by the capacitor C0 to the row electrode Yj, rises with a slight delay with respect to the rise in the potential of the row electrode Yj. This forms the pulse IP′. During the rise in the potentials of the row electrodes Xj and Yj, that is, during the rise in the sustain pulse IP which is applied to the row electrode Yj, the row electrode Xj is in a floating state.

The switch elements S13 and S4 are turned ON at time t12 at which time the potential of the row electrode Yj substantially reaches Vs. Accordingly, the row electrode Yj enters a clamped state as a result of the direct application of the potential Vs and the row electrode Xj shifts from a floating state to a grounded state. In other words, the output voltage Vs of the power source B3 enters a state of being applied across the row electrodes Yj and Xj and the top of the sustain pulse IP is formed. The potential of the row electrode Xj gradually drops to ground potential and pulse IP′ disappears.

The application state of Vs which starts at time t12 continues as far as time t13. At time t13, the switching elements S11 and S13 are turned OFF and switch element S12 is turned ON in their place. Accordingly, through the resonance action of the coil L4 and capacitor C0, a resonance current flows via a path which extends from ground to switch S4, followed by capacitor C0, coil L4, diode D4, switch element S12, and then capacitor C2 and, as a result, the potential of the row electrode Yj drops and the falling part of the sustain pulse is formed. The switch element S14 turns ON at time t14 at which time the sustain pulse has substantially dropped and switch element S12 is turned OFF at time t15 directly afterward.

Accordingly, when the potential of the row electrode Yj is in the process of rising, the voltage across the row electrodes Xj and Yj does not reach the discharge start voltage in all of the discharge cells PC_{j,1} to PC_{j,m} of the j-th display line and a sustain discharge does not occur. Furthermore, in the period from time t12 to t13 after the row electrode Yj has reached the rated potential Vs, a sustain discharge occurs following the arrival of row electrode Yj at the rated potential Vs as a result of the grounding of the row electrode Yj and, even when the discharge characteristic differs for each discharge cell, substantially the same brightness level can be obtained.

This makes it possible to perform the same sustain pulse application operation for all of the first to nth display lines including the j-th display line and the discharge intensity of the sustain discharge can be made substantially the same for all of the discharge cells PC_{1,1} to PC_{n,m}.

As mentioned earlier, even when there are inconsistencies in the address discharge during the selective write address process W_{W} as a result of using a configuration where pulse HP is applied to the column electrodes D during the period from directly after the application of the final scan pulse SP_{W} in the selective write address process W_{W} until directly before the application of the leading sustain pulse IP and where the row electrodes X are in a floating state during the leading edge period of the leading sustain pulse IP, that is, even when there are inconsistencies from one discharge cell to the next with regard to the state of formation of the wall charge, the sustain discharge of the leading sustain pulse can be reliably produced.

The application of the auxiliary pulse HP is stopped prior to the start of the application of the leading sustain pulse. This is because, when the auxiliary pulse HP is applied during the leading edge of the leading sustain pulse, the field intensity across the row electrodes X and Y increases and the sustain discharge easily occurs in the leading edge period.

Normally, an electric field is produced during the application of the sustain pulse between the first row electrode to which the sustain pulse IP is applied and the other row electrode and between the first row electrode and the column electrode D. This is because, here, when an auxiliary pulse HP of the same polarity as the sustain pulse is applied to the column electrode D in the leading edge period, the electric field between the row electrodes Y and column electrodes D grows weak and the electric field between the row electrodes X and Y increases to the same degree, such that a sustain discharge is readily produced across the row electrodes X and Y.

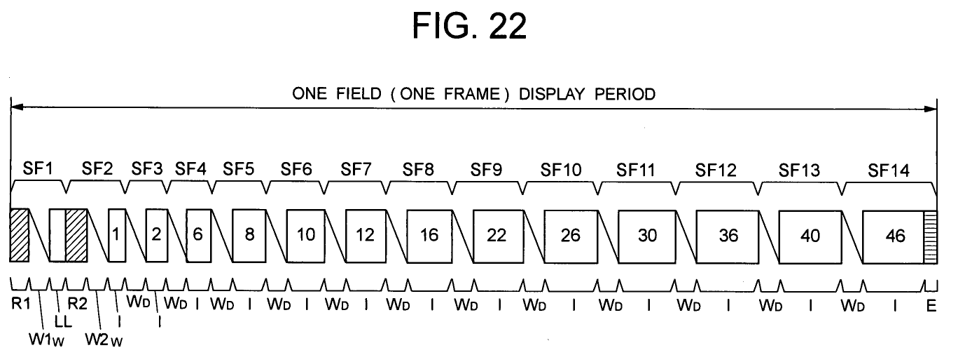

FIG. 22 shows another light emission drive sequence which adopts a selective erase address method in order to drive the PDP 50 in the plasma display device shown in FIG. 16. The drive control circuit 56 supplies various control signals for driving a PDP 50 with the configuration shown in FIG. 16 in accordance with a light emission drive sequence as shown in FIG. 22 to a panel driver which comprises the X electrode driver 51, Y electrode driver 53, and address driver 55. That is, the drive control circuit 56 supplies various control signals for sequentially implementing driving which corresponds to each of the first reset process R1, the first selective write address process W1_{W} and the micro light emission process LL in the leading subfield SF1 within one field (one frame) display period as shown in FIG. 14 to the panel driver. In subfield SF2 which follows the subfield SF1, the drive control circuit 56 supplies various control signals for sequentially implementing driving which corresponds to each of the second reset process R2, the second selective write address process W2_{W} and the sustain process I to the panel driver. In each of the subfields SF3 to SF14, the drive control circuit 56 supplies various control signals for sequentially implementing driving in accordance with the selective erase address process W_{D} and the sustain process I to the panel driver. Only in the final subfield SF14 within the single field display period, following the execution of the sustain process I, the drive control circuit 56 supplies various control signals for sequentially implementing driving which corresponds to erase process E to the panel driver.

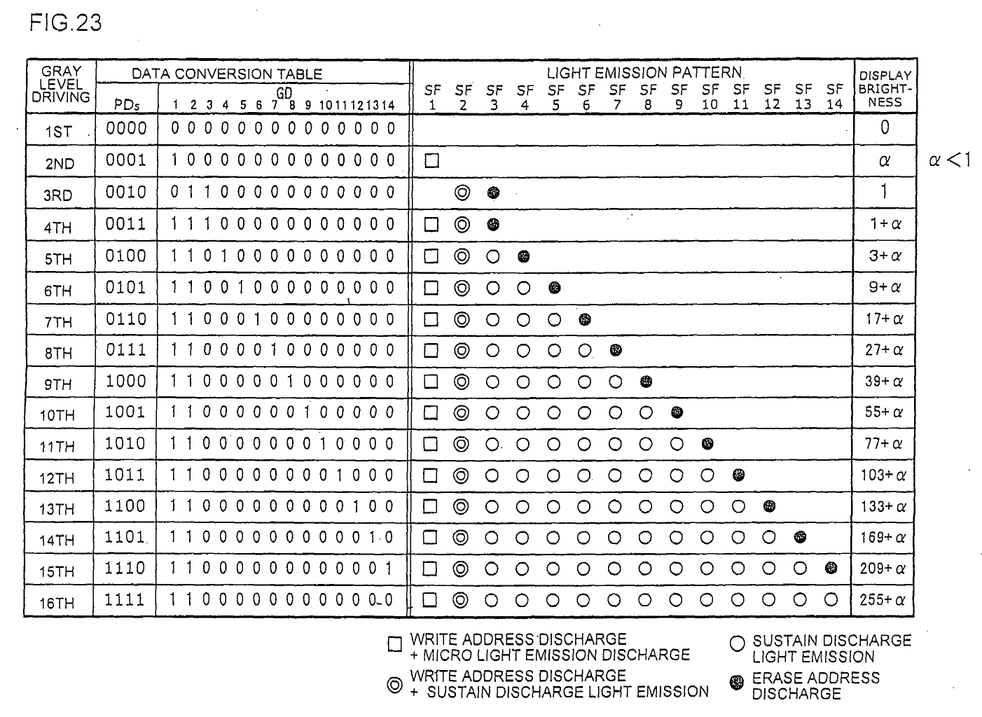

Furthermore, the drive control circuit 56 converts the upper four bits' worth of the dither-added pixel data obtained in the dither processing into 4-bit multiple gray level pixel data PD_{S} which represent all of the brightness levels as shown in FIG. 23 by means of 16 gray levels. Further, the drive control circuit 56 converts the multiple gray level pixel data PD_{S} into 14-bit pixel driving data GD in accordance with a data conversion table as shown in FIG. 23, matches the first to fourteenth bits of the pixel driving data GD with each of the subfields SF1 to SF14 and supplies the bits which correspond to the subfields SF to the address driver 55 one display line at a time (m) as pixel driving data bits.

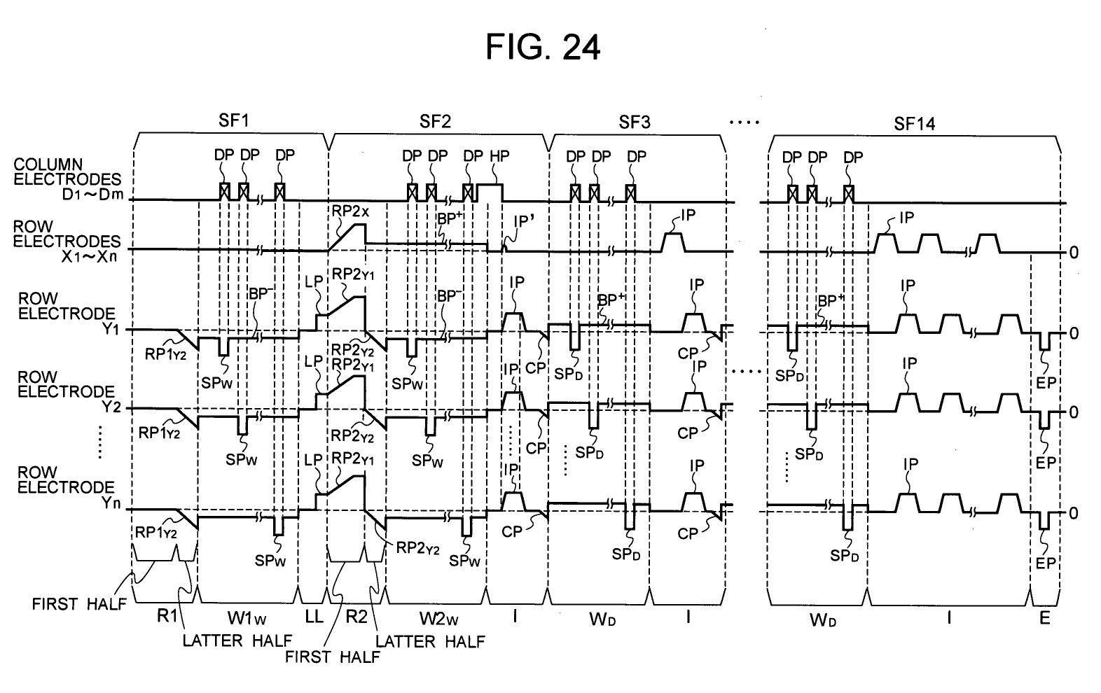

The panel drivers, that is, the X electrode driver 51, Y electrode driver 53, and address driver 55 generate various drive pulses as shown in FIG. 24 in accordance with the various control signals supplied by the drive control circuit 56 and supplies the various drive pulses to the column electrodes D and row electrodes X and Y of the PDP 50.

In FIG. 24, only the operation of SF1 to SF3 and the operation of the last subfield SF14 among the subfields SF1 to SF14 shown in FIG. 22 are selectively shown. Further, the same reference symbols are used for the same pulses as the various drive pulses generated in cases where the selective erase address method shown in FIG. 19 is adopted in FIG. 24.

First, in the first half of the first reset process R1 of subfield SF1, the Y electrode driver 53 applies a positive polarity reset pulse RP_{Y1} which has a waveform in which the potential transition at the leading edge as time elapses is gradual in comparison with the subsequent sustain pulse (maintenance pulse) to all of the row electrodes Y₁ to Yₙ. The peak potential of the reset pulse RP y1 is a potential which is higher than the peak potential of the sustain pulse as shown in FIG. 24. Meanwhile, the address driver 55 sets the column electrodes D₁ to Dₘ to a ground potential (0 volt) state. The first reset discharge is produced across the row electrodes Y and column electrodes D in all of the discharge cells PC in accordance with the application of the reset pulse RP1_{Y1}. That is, by applying a voltage across the row electrodes Y and column electrodes D in the first half of the first reset process R1 so that the row electrodes Y are anodic and the column electrodes D are cathodic, a discharge in which the current flows from the row electrodes Y to the column electrodes D (referred to as the ‘column cathode discharge’ hereinbelow) is produced as the first reset discharge. A wall charge of a negative polarity is formed close to the row electrodes Y in all of the discharge cells PC and a wall charge of a positive polarity is formed close to the column electrodes D in accordance with the first reset discharge.

In addition, in the first half of the first reset process R1, the X electrode driver 51 applies the reset pulse RP_{X} which has the same polarity as that of the reset pulse RP1_{Y1} and has a peak potential that makes it possible to prevent surface discharge across the row electrodes X and Y which is caused by the application of the reset pulse RP1_{Y1} to all of the row electrodes X₁ to Xₙ.

Further, in the latter half of the first reset process R1 of the subfield SF1, the Y electrode driver 53 generates a reset pulse RP1_{Y2} which has a pulse waveform in which the potential gradually drops as time elapses and reaches a negative polarity peak potential as shown in FIG. 24 and applies the reset pulse RP1_{Y2} to all of the row electrodes Y₁ to Yₙ. Thereupon, a second reset discharge is produced across the row electrodes X and Y in all of the discharge cells PC in accordance with the application of the reset pulse RP1_{Y2}. The peak potential of the reset pulse RP1_{Y2} is the lowest potential with which it is possible to produce the second reset discharge reliably across the row electrodes X and Y after considering the wall charge formed close to the row electrodes X and Y respectively in accordance with the first reset discharge. Further, the peak potential of the reset pulse RP1_{Y2} is set at a higher potential than the peak potential of the subsequently described negative polarity write scan pulse SP_{W}, that is, at a potential which is close to 0 volt. In other words, this is because, when the peak potential of the reset pulse RP1_{Y2} is lower than the peak potential of the write scan pulse SP_{W}, a strong discharge is produced across the row electrodes Y and column electrodes D, the wall charge formed close to the column electrodes D is largely erased and the address discharge in the first selective write address process W1_{W} (described subsequently) becomes unstable. The wall charge formed close to the row electrodes X and Y respectively in the respective discharge cells PC is erased by the second reset discharge produced in the latter half of the first reset process R1 and all of the discharge cells PC are initialized in the lighting-off mode. In addition, a weak discharge is also produced across the row electrodes Y and column electrodes D in all of the discharge cells PC in accordance with the application of the reset pulse RP1_{Y2} and, as a result of the discharge, a portion of the wall charge of a positive polarity formed close to the column electrodes D is erased and is adjusted to the amount that makes it possible to produce a selective write address discharge accurately in the first selective write address process W1_{W}.

Thereafter, in the first selective write address process W1_{W} of the subfield SF1, the Y electrode driver 53 simultaneously applies a base pulse BP⁻ with a predetermined peak potential of a negative polarity to the row electrodes Y₁ to Yₙ as shown in FIG. 24 while sequentially and alternatively applying a write scan pulse SP_{W} with a negative polarity peak potential to each of the row electrodes Y₁ to Yₙ. Meanwhile, the X electrode driver 51 applies a 0-volt voltage to each of the row electrodes X₁ to Xₙ. Furthermore, in the first selective write address process W1_{W}, the address driver 55 first generates a pixel data pulse DP with a pulse voltage which corresponds to the logic level of the pixel driving data bit which corresponds to subfield SF1. For example, the address driver 55 generates a pixel data pulse DP with a positive polarity peak potential in cases where the pixel driving data bit of logic level 1 for setting the discharge cells PC to lighting-on mode is supplied. However, the address driver 55 generates a pixel data pulse DP of a low voltage (0 volt) in accordance with a pixel driving data bit of logic level 0 for setting the discharge cells PC to lighting-off mode. Further, the address driver 55 applies the pixel data pulse DP one display line at a time (m) to the column electrodes D₁ to Dₘ in synchronism with the application timing of the respective write scan pulse SP_{W}. Thereupon, a selective write address discharge is produced across the column electrodes D and row electrodes Y in the discharge cells PC to which a high-voltage pixel data pulse DP for setting the discharge cells PC to lighting-on mode is applied at the same time as the write scan pulse SP_{W}. As a result of the selective write address discharge, the discharge cells PC are set to a state where a positive polarity wall charge is formed close to the row electrodes Y and a negative polarity wall charge is formed close to the column electrodes D, that is, to lighting-on mode. However, a selective write address discharge is not produced, as mentioned earlier, across the column electrodes D and row electrodes Y in the discharge cells PC to which a low voltage (0 volt) pixel data pulse DP for setting the discharge cells PC to lighting-off mode is applied at the same time as the write scan pulse SP_{W}, and, as a result, a discharge is not produced across the row electrodes X and Y. Accordingly, the discharge cells PC maintain the preceding state, that is, the lighting-off mode state that was initialized in the reset process R.

Thereafter, in the micro light emission process LL of the subfield SF1, the Y electrode driver 53 simultaneously applies a micro light emission pulse LP with a predetermined peak potential of a positive polarity as shown in FIG. 24 to the row electrodes Y₁ to Yₙ. A discharge is produced across the column electrodes D and row electrodes Y in the discharge cells PC set to lighting-on mode in accordance with the application of the micro light emission pulse LP (referred to as ‘micro light emission discharge’ hereinbelow). That is, in the micro light emission process LL, although a discharge is produced across the row electrodes Y and column electrodes D in the discharge cells PC, because a potential which does not produce a discharge across the row electrodes X and Y is applied to the row electrodes Y1 a micro light emission discharge is produced only across the column electrodes D and row electrodes Y in the discharge cells PC set to lighting-on mode. Here, the peak potential of the micro light emission pulse LP is a lower potential than the peak potential of the sustain pulses IP applied in the sustain process I following subfield SF2 (described subsequently) and is the same as the potential which is applied to the row electrodes Y in the selective erase address process W_{D} described subsequently. Further, as shown in FIG. 24, the rate of change as time elapses in the rising segment of the potential of the micro light emission pulse LP is higher than the rate of change in the rising segment of the reset pulse (RP1_{Y1}, RP2_{Y1}). That is, by making the potential transition of the leading edge of the micro light emission pulse LP steeper than the potential transition of the leading edge of the reset pulse, a discharge that is stronger than the first reset discharge produced in the first reset process R1 is produced. Here, the discharge is the earlier mentioned column side cathode discharge and is a discharge that is produced by the micro light emission pulse LP which has a lower peak potential than that of the sustain pulse IP. Hence, the light emission brightness caused by the discharge is lower than that of the sustain discharge (described subsequently) produced across the row electrodes X and Y. That is, although the discharge is a discharge which causes light emission of a higher brightness level than that of the first reset discharge in the micro light emission process LL, a discharge for which the brightness level caused by the discharge is lower than that of the sustain discharge, that is, a discharge which causes micro light emission of a magnitude that can be utilized for the display is produced as the micro light emission discharge. Here, in the first selective write address process W1_{W} executed directly before the micro light emission process LL, a selective write address discharge is produced across the column electrodes D and row electrodes Y in the discharge cell PC. Accordingly, in subfield SF1, brightness which corresponds to a gray level whose brightness is one level higher than brightness level 0 is represented as the light emission caused by the micro light emission discharge and the light emission caused by the selective write address discharge.

Following the micro light emission discharge, a wall charge of a negative polarity is formed close to the row electrodes Y and a wall charge of a positive polarity is formed close to the column electrodes D.

Thereafter, in the first half of the second reset process R2 of subfield SF2, the Y electrode driver 53 applies a positive polarity reset pulse RP2_{Y1} which has a waveform in which the potential transition at the leading edge as time elapses is gradual in comparison with the sustain pulse (described subsequently) to all of the row electrodes Y₁ to Yₙ. As shown in FIG. 24, the peak potential of the reset pulse RP2_{Y1} is higher than the peak potential of the reset pulse RP1_{Y1}. Further, meanwhile, the address driver 55 sets the column electrodes D₁ to Dₘ to aground potential (0 volt) state. The X electrode driver 51 applies a positive polarity reset pulse RP2_{X} which has a peak potential which makes it possible to prevent a surface discharge across the row electrodes X and Y caused by the application of the reset pulse RP2_{Y1} to all of the row electrodes X₁ to Xₙ respectively. Here, if a surface discharge is not produced across the row electrodes X and Y, instead of applying the reset pulse RP2_{X}, the X electrode driver 51 may set all of the row electrodes X₁ to Xₙ at ground potential (0 volt). A first reset discharge which is weaker than the column cathode discharge in the micro light emission process LL is produced across the row electrodes Y and column electrodes D in the discharge cells PC for which a column side cathode discharge has not been produced in the micro light emission process LL in each of the discharge cells PC in accordance with the application of the reset pulse RP2_{Y1}. That is, by applying a voltage across the row electrodes Y and column electrodes D in the first half of the second reset process R2 so that the row electrodes Y are anodic and the column electrodes D are cathodic, the column cathode discharge in which the current flows from the row electrodes Y to the column electrodes D is produced as the first reset discharge. However, a discharge is not produced even when the application of the reset pulse RP2_{Y1} is performed within the discharge cells PC in which a micro light emission discharge has already been produced in the micro light emission process LL. Therefore, directly after the end of the first half of the second reset process R2, a wall charge of a negative polarity is formed close to the row electrodes Y in all of the discharge cells PC and a wall charge of a positive polarity is formed close to the column electrodes D.

Further, in the latter half of the second reset process R2 of subfield SF2, the Y electrode driver 53 applies a reset pulse RP2_{Y2} which has a pulse waveform in which the potential gradually drops as time elapses and reaches a negative polarity peak potential as shown in FIG. 24 to all of the row electrodes Y₁ to Yₙ. Furthermore, in the latter half of the second reset process R2, the X electrode driver 51 applies a base pulse BP⁺ which has a positive polarity peak potential to the row electrodes X₁ to Xₙ while the reset pulse RP2_{Y2} is being applied to the row electrode Y. The second reset discharge is produced across the row electrodes X and Y in all of the discharge cells PC in accordance with the application of the negative polarity reset pulse RP2_{Y2} and the positive polarity base pulse BP⁺. As a result of the second reset discharge, the majority of the wall charge formed close to each of the row electrodes X and Y in all of the discharge cells PC is erased. As a result, all of the discharge cells PC are initialized in lighting-off mode. Further, a weak discharge is also produced across the row electrodes Y and column electrodes D within all of the discharge cells PC in response to the application of the reset pulse RP2_{Y2} and a portion of the positive polarity wall charge formed close to the column electrodes D is erased. As a result, the amount of wall charge which remains close to the column electrodes D of all of the discharge cells PC is adjusted to an amount which makes it possible to produce a selective write address discharge correctly in the second selective write address process W2_{W}.

The voltage that is applied across the row electrodes X and Y by the reset pulse RP2_{Y2} and base pulse BP⁺ is a voltage that makes it possible to produce the second reset discharge reliably across the row electrodes X and Y after considering the wall charge formed close to the row electrodes X and Y respectively in accordance with the first reset discharge. Further, the negative peak potential of the reset pulse RP2_{Y2} is set at a higher potential than the peak potential of the subsequently described negative polarity write scan pulse SP_{W}, that is, at a potential which is close to 0 volt. In other words, this is because, when the peak potential of the reset pulse RP2_{Y2} is made lower than the peak potential of the write scan pulse SP_{W}, a strong discharge is produced across the row electrodes Y and column electrodes D, the wall charge formed close to the column electrodes D is largely erased and the address discharge in the second selective write address process W2_{W} becomes unstable.

Thereafter, in the second selective write address process W2_{W} of the subfield SF2, the Y electrode driver 53 simultaneously applies a base pulse BP⁻ with a negative polarity peak potential to the row electrodes Y₁ to Yₙ as shown in FIG. 24 while alternatively and sequentially applying a write scan pulse SP_{W} with a negative polarity peak potential to each of the row electrodes Y₁ to Yₙ. The X electrode driver 51 meanwhile continuously applies a base pulse BP⁺ with a positive polarity peak potential to each of the row electrodes X₁ to Xₙ. The voltage which is applied across the row electrodes X and Y by the base pulse BP⁺ and base pulse BP⁻ may be lower than the discharge start voltage of the discharge cells PC. Furthermore, in the second selective write address process W2_{W}, the address driver 55 first generates a pixel data pulse DP which has a peak potential that corresponds to the logic level of the pixel driving data bit which corresponds to the subfield SF2. For example, in cases where a pixel driving data bit of logic level 1 for setting the discharge cells PC to the lighting-on mode is supplied, the address driver 55 generates a pixel data pulse DP which has a positive polarity peak potential. However, the address driver 55 generates a low voltage (0 volt) pixel data pulse DP in accordance with the pixel driving data bit of logic level 0 for setting the discharge cells PC to a lighting-off mode. Further, the address driver 55 applies the pixel data pulse DP to the column electrodes D₁ to Dₘ in synchronism with the application timing of the respective write scan pulses SP_{W} one display line's worth of the pixel data pulse DP at a time (m). Thereupon, a selective write address discharge is produced across the column electrodes D and row electrodes Y in the discharge cells PC to which a high voltage pixel data pulse DP for setting the discharge cells PC to lighting-on mode is applied at the same time as the write scan pulse SP_{W}. Furthermore, directly after the selective write address discharge, a weak discharge is also produced across the row electrodes X and Y in the discharge cells PC. That is, a voltage which corresponds to the base pulses BP⁻ and BP⁺ is applied across the row electrodes X and Y after the write scan pulse SP_{W} has been applied. However, since the voltage is set at a voltage which is lower than the discharge start voltage of the respective discharge cells PC, a discharge cannot be produced within the discharge cells PC merely through the application of the voltage. However, when the selective write address discharge is produced, a discharge is produced across the row electrodes X and Y merely by applying the voltage of the base pulses BP⁻ and BP⁺ through induction by the selective write address discharge. As a result of the discharge and the selective write address discharge, the discharge cells PC are set to a state where a positive polarity wall charge is formed close to the row electrodes Y, a negative polarity wall charge is formed close to the row electrodes X, and a negative polarity wall charge is formed close to the column electrodes D, that is, to lighting-on mode. However, the earlier mentioned selective write address discharge is not produced across the column electrodes D and row electrodes Y in the discharge cells PC to which a low voltage (0 volt) pixel data pulse DP for setting the discharge cells PC to lighting-off mode is applied at the same time as the write scan pulse SP_{W} and, consequently, a discharge is not produced across the row electrodes X and Y. Accordingly, the discharge cells PC maintain the preceding state, that is, the lighting-off mode state that was initialized in the second reset process R2.

In the second selective write address process W2_{W}, the final pixel data pulse DP is applied to the column electrodes D₁ to Dₘ at the same time as the write scan pulse SP_{W} applied to the row electrodes Yₙ and, when the application of the final pixel data pulse DP ends, an auxiliary pulse HP is applied directly thereafter to the column electrodes D₁ to Dₘ. The auxiliary pulse HP is a pulse which has the same positive polarity potential as the pixel data pulse DP. The auxiliary pulse HP has a pulse width up until directly before the application of the initial sustain pulse IP of the next sustain process I.

Thereafter, in the sustain process I of subfield SF2, the Y electrode driver 53 generates one pulse's worth of a sustain pulse IP which has a positive polarity peak potential and simultaneously applies the sustain pulse IP to each of the row electrodes Y₁ to Yₙ. As shown in FIG. 21, the X electrode driver 51 sets the row electrodes X₁ to Xₙ in a floating state in the leading period of the sustain pulse IP which is applied to each of the row electrodes Y₁ to Yₙ and sets the row electrodes X₁ to Xₙ to a ground potential (0 volt) state in the remaining period of application of the subsequent sustain pulses IP. As shown in FIG. 21, the potential of each of the row electrodes X₁ to Xₙ rises in sympathy with the rise in the potential of each of the row electrodes Y₁ to Yₙ in the floating state and the potential of each of the row electrodes Y₁ to Yₙ reaches a potential which gradually drops when clamped to the potential Vs and reaches ground potential. As a result, a pulse IP′ is generated in the row electrodes X₁ to Xₙ.

In the sustain process I of the subfield SF2, a sustain discharge is produced across the row electrodes X and Y in the discharge cells PC in the lighting-on mode state in response to the application of the sustain pulse IP. As a result of the light which is irradiated by the fluorescent layer 17 being irradiated to the outside via the front transparent substrate 10 in accordance with the sustain discharge, display light emission which corresponds to the brightness weighting of subfield SF1 is performed. Further, a discharge is also produced across the row electrodes Y and column electrodes D in the discharge cells PC in the lighting-on mode state in response to the application of the sustain pulse IP. As a result of the discharge and the sustain discharge, a negative polarity wall charge is formed close to the row electrodes Y in the discharge cells PC and a positive polarity wall charge is formed close to each of the row electrodes X and column electrodes D.

Furthermore, following the application of the sustain pulse IP, the Y electrode driver 53 applies a wall charge adjustment pulse CP in which the potential transition at the leading edge as time elapses is gradual and which has a negative polarity peak potential as shown in FIG. 24 to the row electrodes Y₁ to Yₙ. A weak erase discharge is produced in the discharge cells PC in which a sustain discharge is produced as mentioned earlier in response to the application of the wall charge adjustment pulse CP and a portion of the wall charge formed in the discharge cells PC is erased. As a result, the amount of wall charge in the discharge cells PC is adjusted to an amount that makes it possible to produce a selective erase address discharge correctly in the next selective erase address process W_{D}.

Thereafter, in the selective erase address process W_{D} of each of the subfields SF3 to SF14, the Y electrode driver 53 applies a base pulse BP⁺ which has a predetermined peak potential of a positive polarity to each of the row electrodes Y₁ to Yₙ while alternatively and sequentially applying an erase scan pulse SP_{D} which has a negative polarity peak potential to each of the row electrodes Y₁ to Yₙ as shown in FIG. 24. The peak potential of the base pulse BP⁺ is set at a potential which makes it possible to prevent erroneous discharge across the row electrodes X and Y during the period of execution of the selective erase address process W_{D}. Further, during the period of execution of the selective erase address process W_{D}, the X electrode driver 51 sets each of the row electrodes X₁ to Xₙ at ground potential (0 volt). Further, in the selective erase address process W_{D}, the address driver 55 first converts the pixel driving data bit which corresponds to the subfield SF into a pixel data pulse DP which has a pulse voltage that corresponds to the logic level of the pixel driving data bit. For example, in cases where a pixel driving data bit of logic level 1 which serves to shift the discharge cells PC from the lighting-on mode to the lighting-off mode is supplied, the address driver 55 converts the logic level-1 pixel driving data bit into a pixel data pulse DP which has a positive polarity peak potential. However, in cases where a pixel driving data bit of logic level 0 which is for maintaining the current state of the discharge cells PC is supplied, the address driver 55 converts the logic level-0 pixel driving data bit into a low voltage (0 volt) pixel data pulse DP. Further, the address driver 55 applies the pixel data pulse DP to the column electrodes D₁ to Dₘ in synchronism with the application timing of the respective erase scan pulses SP_{D}, one display line (m-th line) at a time. Thereupon, a selective erase address discharge is produced across the column electrodes D and row electrodes Y in the discharge cells PC to which a high voltage positive polarity pixel data pulse DP is applied at the same time as the erase scan pulse SP_{D}. As a result of the selective erase address discharge, the discharge cells PC are set to a state where a positive polarity wall charge is formed close to the row electrodes X and Y and a negative polarity wall charge is formed close to the column electrodes D, that is, to lighting-off mode. However, a selective erase address discharge is not produced, as mentioned earlier, across the column electrodes D and row electrodes Y in the discharge cells PC to which a low voltage (0 volt) pixel data pulse DP is applied at the same time as the erase scan pulse SP_{D}. Accordingly, the discharge cells PC maintain the preceding state (the lighting-on mode, lighting-off mode).

In the sustain process I of each of the subfields SF3 to SF14, the X electrode driver 51 and Y electrode driver 53 apply a sustain pulse IP which has a positive polarity peak potential alternately to the row electrodes X and Y as shown in FIG. 24 and repeatedly by a number of times (an even number of times) which corresponds to the subfield brightness weighting. Whenever the sustain pulse IP is applied, the sustain discharge is produced across the row electrodes X and Y in the discharge cells PC which have been set to lighting-on mode. Here, as a result of the light irradiated by the fluorescent layer 17 being irradiated to the outside via the front transparent substrate 10 in accordance with the sustain discharge, display light emission a number of times which corresponds to the brightness weighting of subfield SF is performed.

Here, in the sustain process I of each of the subfields SF3 to SF14, a negative polarity wall charge is formed close to the row electrodes Y in the discharge cells PC in which the sustain discharge is produced in accordance with the final sustain pulse IP and a positive polarity wall charge is formed close to each of the row electrodes X and column electrodes D. Following the application of the final sustain pulse IP, the Y electrode driver 53 applies a wall charge adjustment pulse CP in which the potential transition at the leading edge as time elapses is gradual and which has a negative polarity peak potential as shown in FIG. 24 to the row electrodes Y₁ to Yₙ. A weak erase discharge is produced in the discharge cells PC in which a sustain discharge is produced as mentioned earlier in response to the application of the wall charge adjustment pulse CP and a portion of the wall charge formed in the discharge cells PC is erased. As a result, the amount of wall charge in the discharge cells PC is adjusted to an amount that makes it possible to produce a selective erase address discharge correctly in the next selective erase address process W_{D}.

Further, at the end of the final subfield SF14, the Y electrode driver 53 applies an erase pulse EP which has a negative polarity peak potential to all of the row electrodes Y₁ to Yₙ. An erase discharge is produced only in the discharge cells PC in a lighting-on mode state in response to the application of the erase pulse EP. The discharge cells PC in the lighting-on mode state make the transition to the lighting-off mode state as a result of the lighting-off mode.

The driving is executed as above on the basis of sixteen different pixel driving data GD as shown in FIG. 23.

First, at the second gray level which represents brightness which is one level higher than the first gray level which represents the black display (brightness level 0), a selective write address discharge for setting the discharge cells PC to lighting-on mode is produced only in SF1 among the subfields SF1 to SF14 as shown in FIG. 23 and the discharge cells PC set to the lighting-on mode are made to produce a micro light emission discharge (indicated by an empty square shape). Thereupon, the brightness level during the light emission caused by the selective write address discharge and the micro light emission discharge is lower than the brightness level during the light emission caused by one sustain discharge. Accordingly, in cases where the brightness level visualized as a result of the sustain discharge is ‘1’, at the second gray level, brightness which corresponds to a brightness level ‘α’ which is lower than brightness level ‘1’ is rendered.

Thereafter, at the third gray level which represents brightness that is one level higher than that of the second gray level, a selective write address discharge (indicated by two overlapping circles) for setting the discharge cells PC to lighting-on mode is produced only in SF2 among the subfields SF1 to SF14 and a selective erase address discharge which allows the discharge cells PC to make the transition to lighting-off mode is produced in the next subfield SF3 (indicated by a black circle). Accordingly, at the third gray level, light emission which is caused by a single sustain discharge is performed only in the sustain process I of the SF2 among the subfields SF1 to SF14 and brightness which corresponds to brightness level ‘1’ is rendered.

Thereafter, at the fourth gray level which represents brightness that is one level higher than that of the third gray level, a selective write address discharge for setting the discharge cells PC to lighting-on mode is first produced in subfield SF1 and the discharge cells PC set to the lighting-on mode are made to produce a micro light emission discharge (indicated by an empty square shape). Furthermore, at the fourth gray level, a selective write address discharge for setting the discharge cells PC to lighting-on mode is produced only in SF2 among the subfields SF1 to SF14 (indicated by two overlapping circles) and a selective erase address discharge which allows the discharge cells PC to make the transition to lighting-off mode is produced in the next subfield SF3 (indicated by a black circle). Accordingly, at the fourth gray level, light emission with a brightness level ‘α’ is executed in subfield SF1 and a sustain discharge which causes light emission of brightness level ‘1’ is implemented only once in SF2. Hence, brightness which corresponds to the brightness level ‘α’+‘1’ is rendered.

Further, at each of the fifth to sixteenth gray levels, a selective write address discharge for setting the discharge cells PC to lighting-on mode is produced in subfield SF1 and the discharge cells PC which have been set to lighting-on mode are made to produce a micro light emission discharge (indicated by an empty square shape). Further, a selective erase address discharge which allows the discharge cells PC to make the transition to lighting-off mode is produced only in the one subfield which corresponds to the gray level (indicated by a black circle). Accordingly, at the fifth to sixteenth gray levels, the micro light emission discharge is produced in subfield SF1 and a single sustain discharge is produced in SF2, whereupon a sustain discharge is produced a number of times which corresponds to the number of times assigned to the subfield in each of the consecutive subfields in a number which corresponds to the gray levels (indicated by a white circle). As a result, at each of the fifth to sixteenth gray levels, brightness which corresponds to the brightness level ‘α’+‘one field (or one frame) the total number of sustain discharges produced in the display period’ is visualized. Therefore, according to the driving shown in FIGS. 22 to 24, it is possible to render the brightness range of brightness levels ‘0’ to ‘255+α’ by means of sixteen levels as shown in FIG. 23.

Thereupon, in the driving shown in FIGS. 22 to 24, in subfield SF1 which has the smallest brightness weighting, a micro light emission discharge is produced rather than a sustain discharge as the discharge which contributes to the display image. This micro light emission discharge is a discharge which is produced across the column electrodes D and row electrodes Y. Hence, the brightness level during the light emission caused by the discharge is low in comparison with that caused by the sustain discharge produced across the row electrodes X and Y. Accordingly, in cases where brightness which is one level higher than a black display (brightness level 0) is rendered by the micro light emission discharge (second gray level), the brightness difference from brightness level 0 is small in comparison with a case where the brightness is rendered by a sustain discharge. Therefore, the gray level rendering performance when rendering an image of low brightness increases. Further, at the second gray level, because a reset discharge is not produced in the second reset process R2 of SF2 which succeeds subfield SF1, the reduction in the darkness contrast caused by the reset discharge is suppressed. In the driving of the light emission pattern shown in FIG. 23, although a micro light emission discharge which causes light emission with a brightness level α is produced in subfield SF1 in the case of each of the gray levels of the fourth and subsequent gray levels, the micro light emission discharge need not be produced at the third and subsequent gray levels. In short, because the light emission caused by the micro light emission discharge has a very low brightness (brightness level α), at each of the fourth and subsequent gray levels in which the micro light emission discharge is used together with the sustain discharge which causes light emission of a higher brightness, there are cases where it is no longer possible to visualize the corresponding brightness increase of brightness level α and there is no sense in producing a micro light emission discharge at this time.

Here, in the driving shown in FIG. 24, by applying a voltage across the two electrodes in the first reset process R1 of the leading subfield SF1 so that the column electrodes D are cathodic and the row electrodes Y are anodic, a column cathode discharge in which the current flows from the row electrodes Y to the column electrodes D is produced as the first reset discharge. Accordingly, during the first reset discharge, when anode ions in the discharge gas move toward the column electrode D, the anode ions collide with MgO crystals which are a secondary electron emission material contained in the fluorescent layer 17 as shown in FIG. 5 and secondary electrons are emitted by the MgO crystals. In particular, in a PDP 50, by exposing the MgO crystals to a discharge space as shown in FIG. 5, the probability of the collision with the anode ions is raised so that the secondary electrons are efficiently emitted to the discharge space. Because the discharge start voltage of the discharge cells PC is low as a result of the priming action by the secondary electrons, a relatively weak reset discharge can be produced. Accordingly, because the light emission brightness caused by the discharge drops as a result of the weakened reset discharge, a display with an improved darkness contrast is possible.

Furthermore, in the driving shown in FIG. 24, the reset discharge is produced across the row electrodes Y formed on the side of the transparent substrate 10 and the column electrodes D formed on the side of the rear substrate 14, as shown in FIG. 3. Accordingly, in comparison with a case where a reset discharge is produced across the row electrodes X and Y formed on the side of the front transparent substrate 10, the discharged light emitted by the front transparent substrate 10 to the outside is reduced and, therefore, further darkness contrast improvements are possible.

Further, the PDP 50 which constitutes a plasma display panel contains CL light-emitting MgO crystals which constitute the secondary electron emission material as shown in FIG. 5 not only within the magnesium oxide layer 13 formed on the side of the front transparent substrate 10 in the respective discharge cells PC, but also within the fluorescent layer 17 formed on the side of the rear substrate 14.

Accordingly, in comparison with the column cathode discharge (shown in FIG. 6) of discharge cells which contain CL light-emitting MgO crystals only in the magnesium oxide layer 13, a weak discharge can be ended within a short period (shown in FIG. 7). Therefore, because a column cathode discharge with a very weak discharge intensity can be produced as the reset discharge, the image contrast and, in particular, the darkness contrast when a dark image is displayed can be improved.

Further, in the driving shown in FIG. 24, by applying a sustain pulse IP only once in the sustain process I of subfield SF2 which has the smallest brightness weighting, the display reproducibility with respect to a low brightness image is raised by making the number of sustain discharges only a single sustain discharge. Further, following the end of the sustain discharge which is produced in accordance with the single sustain pulse IP, a state is assumed where a negative polarity wall charge is formed close to the row electrodes Y and positive polarity wall charge is formed close to the column electrodes D. Accordingly, as shown in FIG. 24, a column cathode discharge can be produced as the selective erase address discharge in the selective erase address process W_{D} of subfield SF3. Thereupon, in the driving shown in FIG. 24, the number of sustain pulses IP which are to be applied in the sustain process I of each of the subfields SF3 to SF14 is an even number. Accordingly, directly after the end of each sustain process I, because a state is assumed where a negative polarity wall charge is formed close to the row electrodes Y and a positive polarity wall charge is formed close to the column electrodes D, in the selective erase address process W_{D} which is successively carried out in each sustain process I, a column cathode discharge is possible. Therefore, positive polarity pulses are only applied to the column electrodes D and an increase in costs for the address driver 55 is prevented.

A pulse HP is applied to the column electrodes D₁ to Dₘ in a first period which extends from directly after the application of the final sustain pulse SP_{W} of the second selective write address process W2_{W} of the subfield SF2 until directly before the application of the leading sustain pulse IP. As a result, the generation of a micro column cathode discharge can be prevented, whereby a stable sustain discharge can be produced in the leading sustain pulse IP after the selective write address process W_{W}. Furthermore, when a sustain pulse IP is applied to the row electrodes Y₁ to Yₙ in the sustain process I of the subfield SF2, while the potential of the row electrodes Y₁ to Yₙ is in the process of rising (leading edge period), the potential of the row electrodes X₁ to Xₙ follows the potential of the row electrodes Y₁ to Yₙ, thereby producing a pulse IP′. Hence, the column cathode discharge across the row electrodes Y and column electrodes D in the leading edge period can be prevented. Accordingly, even when there are inconsistencies with the address discharge during the selective write address process W2_{W}, that is, even when there are inconsistencies from one discharge cell to the next with regard to the state of formation of the wall charge, the sustain discharge of the leading sustain pulse IP can be reliably produced and substantially the same brightness level can be obtained.

The micro column cathode discharge readily occurs in the period in which the base pulse BP⁻ to the row electrodes Y is rising toward a positive polarity. This is thought to be because the rise of the potential difference across the row electrodes Y and column electrodes D is then minimal. When this point is considered, although an embodiment in which an auxiliary pulse HP is applied in a first period which extends from directly after the application of the final sustain pulse SP_{W} until directly before the application of the leading sustain pulse IP was illustrated in the embodiment shown in FIG. 24, the occurrence of a micro column cathode discharge can also be prevented instead by means of a configuration which applies the auxiliary pulse HP only in at least the rising period of the base pulse BP⁻ (the period which contains boundary line B between the selective write address process W2_{W} and the sustain process I of subfield SF2 in FIG. 24) as the first period.

In addition, although reset discharges are produced all together for all the discharge cells in the first reset process R1 and second reset process R2 shown in FIG. 24, reset discharges may also be temporally distributed and executed in discharge cell blocks each comprising a plurality of discharge cells.

Furthermore, although a first reset discharge of a column cathode discharge may be produced as the column cathode discharge by applying the reset pulse RP1_{Y1} to the row electrodes Y₁ to Yₙ in the first half of the first reset process R1 shown in FIG. 24, this step may also be omitted.

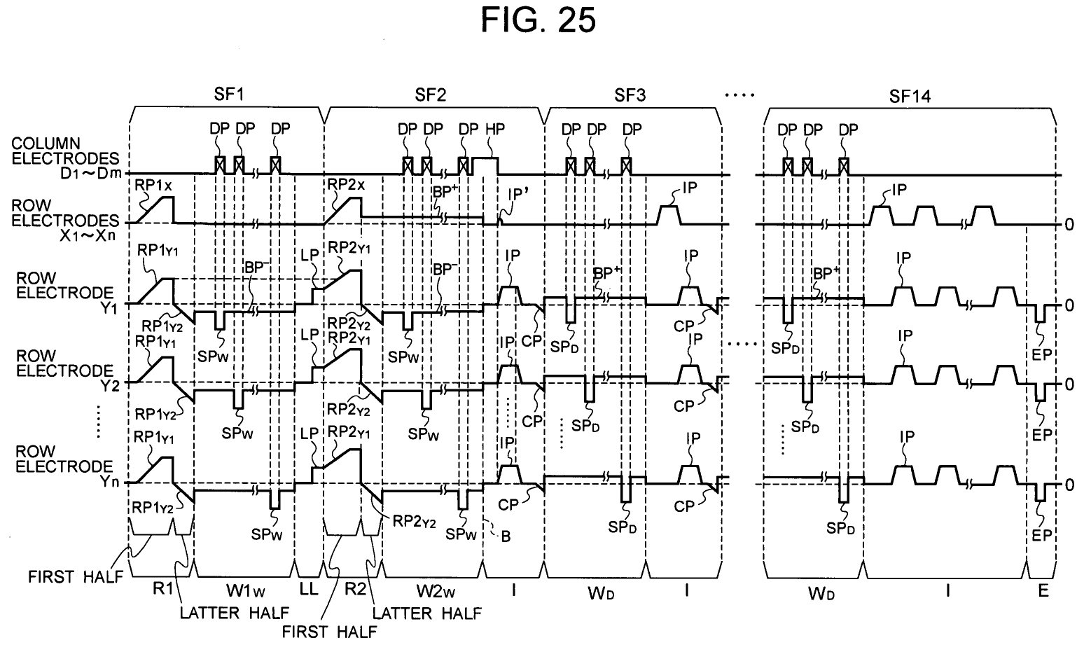

For example, as shown in FIG. 25, the row electrodes Y₁ to Yₙ are fixed at ground potential in the first half of the first reset process R1.

That is, the objective of the column cathode discharge from the row electrodes Y to the column electrodes D in the first half of the first reset process R1 is to emit the charged particles in order to stabilize the write discharge in the first selective write address process W1_{W}. However, in cases where a configuration that contains MgO crystals which include CL light-emitting MgO crystals in the fluorescent layer such as that shown in FIGS. 5 and 22 and so forth, for example, is adopted, the write discharge stabilizes in comparison with a case where such a configuration is not adopted. Hence, a configuration which does not produce a column cathode discharge with both the row electrodes Y and column electrodes D at ground potential in the first half of the first reset process R1 can be adopted. In this case, the row electrodes X are also at ground potential level as shown in FIG. 25. Further, in this case, following the end of the first reset process R1, all of the discharge cells enter the lighting-off mode state as a result of the discharge caused by the erase pulse EP in erase process E of the preceding field and the discharge caused by the application of the reset pulse RP1_{Y2}. Thereupon, with regard to the column cathode discharge caused by the application of the reset pulse RP2_{Y1} in the first half of the second reset process R2 shown in FIG. 25, the charged particles which are emitted as a result of the reset discharge mainly act to stabilize the write discharge in the second selective write address process W2_{W}. Accordingly, when the column cathode discharge resulting from the application of the reset pulse RP2_{Y1} in the first half of the second reset process R2 is omitted, in cases where a write error occurs in the second selective write address process W2_{W}, a sustain discharge can no longer be produced in all of the subfields including subfield SF2 and subsequent subfields. Therefore, in the first half of the second reset process R2, the column cathode discharge resulting from the application of the reset pulse RP2_{Y1} is preferably carried out.

Pulse HP is applied to the column electrodes D₁ to Dₘ in the first period which extends from directly after the application of the final scan pulse SP_{W} of the second selective write address process W2_{W} until directly before the application of the leading sustain pulse IP also in the embodiment of FIG. 25. The row electrodes X₁ to Xₙ are made to enter a floating state in the leading edge period of the leading sustain pulse IP. Accordingly, because the sustain discharge resulting from the leading sustain pulse IP is stable, even when there are inconsistencies in the address discharge during the selective write address process W2_{W}, that is, even when there are inconsistencies from one discharge cell to the next with respect to the state of formation of the wall charge, the sustain discharge of the leading sustain pulse can be produced.

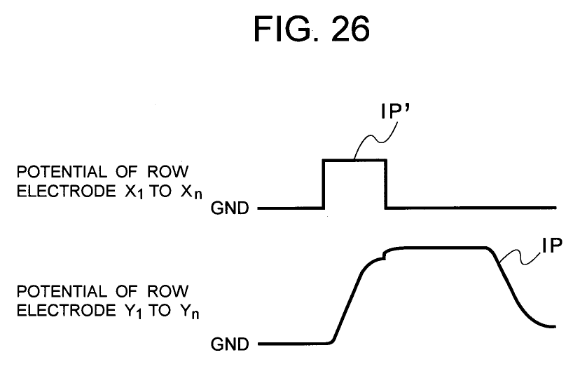

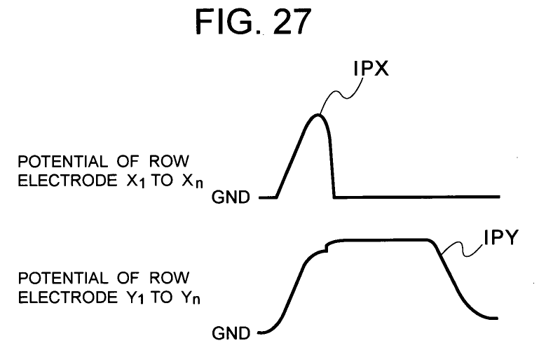

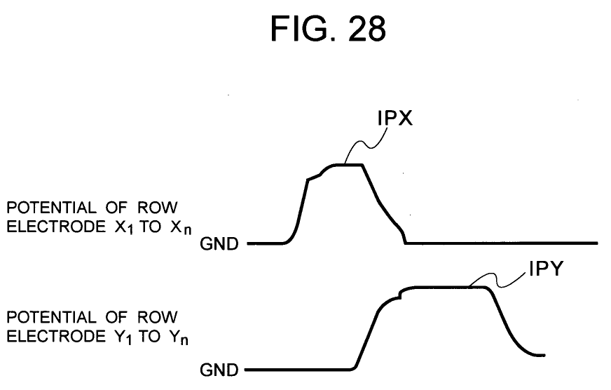

Although the row electrodes X₁ to Xₙ are made to enter a floating state in the leading edge period of the sustain pulse IP which is applied to the row electrodes Y₁ to Yₙ in order to generate pulse IP′ in each of the earlier embodiments, embodiment is not limited to such a step. For example, a square pulse IP′ may also be generated as shown in FIG. 26 by using a dedicated power source. In this case, because the potential and pulse width of the pulse IP′ can be optionally set, can be reliably controlled so that the sustain discharge is not produced in the leading edge period of the sustain pulse IP which is applied to the row electrodes Y₁ to Yₙ. Furthermore, a sustain pulse which is applied to the row electrodes X₁ to Xₙ may also be utilized. For example, as shown in FIG. 27, the sustain pulse IPX is partially applied to the row electrodes X₁ to Xₙ by the X electrode driver 51 only in the leading edge period of the sustain pulse IPY which is applied to the row electrodes Y₁ to Yₙ. As a result, only the rising part of the sustain pulse IPX formed through the resonance action is obtained as pulse IP′. Furthermore, as shown in FIG. 28, the sustain pulse IPXIPX may also be generated with timing such that the sustain pulse IPY rises when the sustain pulse IPX falls. With a method that obtains pulse IP′ by utilizing the sustain pulse which is applied to the row electrodes X₁ to Xₙ, there is the advantage that there are no particular costs incurred because the circuit of the X electrode driver 51 is used as is.

### Embodiment 3

According to the present invention, the period which extends from the time the final sustain pulse which is the sustain pulse that is applied last in the leading frame is applied until the time of application of the first pixel data pulse which is initially applied in the write address process of the subsequent frame which follows the leading frame is adjusted to be equal to or more than a predetermined period and drive control is carried out. The drive control of the adjustment of the period is always executed or executed selectively based on the cumulative usage time and temperature of the PDP, and so forth.

As a result of the configuration, the occurrence of a weak discharge is prevented by reducing the priming particles which occur in the sustain discharge and the generation of dark points due to write errors in the write address process is prevented.

An embodiment of the present invention will be described hereinbelow with reference to the drawings.

### Embodiment 3.1

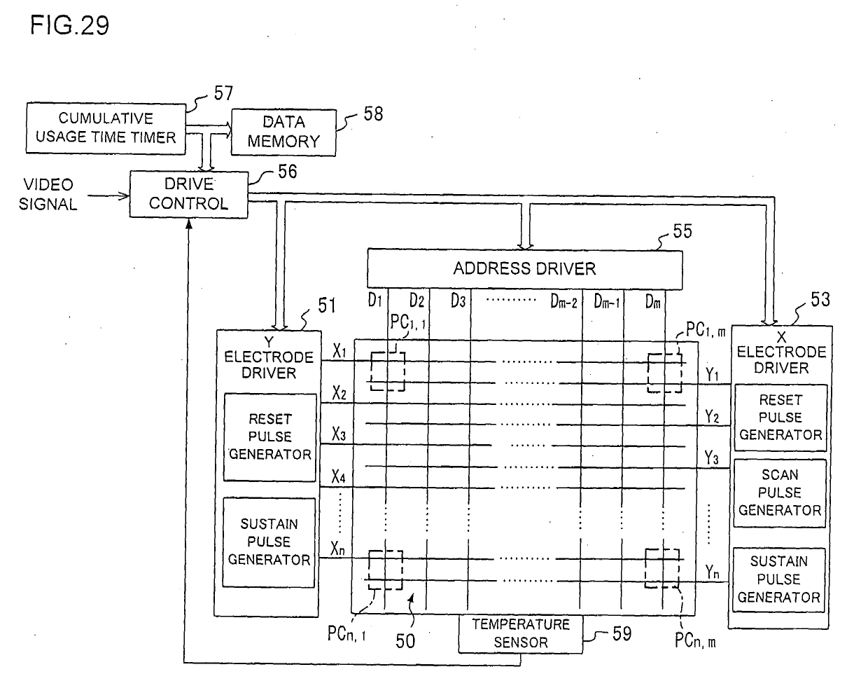

FIG. 29 shows the overall configuration of a plasma display device which drives a plasma display panel in accordance with the driving method of the present invention.

As shown in FIG. 29, the plasma display device is constituted by a PDP 50 constituting a plasma display panel, an X electrode driver 51, a Y electrode driver 53, address driver 55, drive control circuit 56, cumulative usage time timer 58, and a drive sequence data memory (also simply called a data memory) 58, and a temperature sensor 59. The X electrode driver 51 also includes a reset pulse generation circuit and a sustain generation circuit, and the Y electrode driver 53 contains a reset pulse generation circuit, a scan pulse generation circuit and a sustain generation circuit.

In the PDP 50, column electrodes D₁ to Dₘ which are arranged in an extended fashion in the vertical direction (perpendicular direction) of the two-dimensional display screen and row electrodes X₁ to Xₙ and row electrodes Y₁ to Yₙ which are arranged in extended fashion in a lateral direction (horizontal direction) are formed. Here, the row electrode pairs (Y₁, X₁), (Y₂, X₂), (Y₃, X₃), . . . , (Yₙ, Xₙ) which are mutually adjacent to one another and together form pairs each carry the first to nth display lines of the PDP 50. The discharge cells PC which carry the pixels are formed at the intersections between the respective display lines and column electrodes D₁ to Dₘ (the area surrounded by the dot-chain line in FIG. 29). That is, the PDP 50 has discharge cells PC_{1,1} to PC_{1,m} which belong to the first display line, discharge cells PC_{2,1} to PC_{2,m} which belong to the second display line, . . . , and discharge cells PC_{n,1} to PC_{n,m} which belong to the nth display line arranged in the form of a matrix.

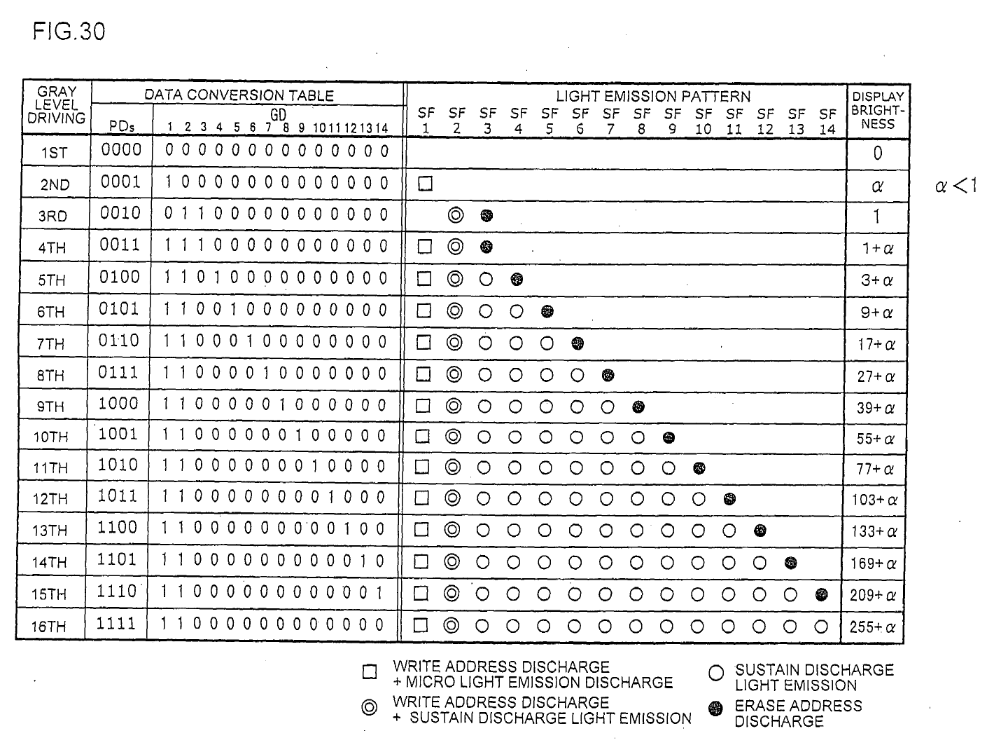

The drive control circuit 56 first converts the video input signal into 8-bit pixel data which represent the all of the brightness levels of each of the respective pixels by means of 256 gray levels, and performs multiple gray level processing which comprises random dither processing and dither processing on the pixel data. That is, first, in the random dither processing, the upper six bits' worth of the pixel data are taken as the display data and the remaining lower two bits' worth of the pixel data are taken as the error data and data obtained by adding a weighting to the error data of the pixel data which correspond to each of the peripheral pixels are mirrored in the display data in order to obtain the six bits' worth of random dither processing pixel data. With the random dither processing, the lower two bits' worth of brightness of the source pixels are represented in pseudo fashion by the peripheral pixels and, as a result, a brightness gray level representation which is the same as that of the eight bits' worth of pixel data is possible by means of six bits' worth of display data which is a smaller number than the eight bits' worth of display data. Thereafter, the drive control circuit 56 performs dither processing on the 6-bit random dither processing pixel data obtained by means of the random dither processing. In the dither processing, a plurality of pixels which are in mutual contact with one another are taken as a single pixel unit and dither-added pixel data are obtained by assigning and adding dither coefficients consisting of mutually different coefficient values to each of the random dither processing pixel data which correspond to the respective pixels in the single pixel unit. As a result of the addition of the dither coefficients, in cases where the pixels are viewed as a pixel unit as above, brightness which corresponds to that afforded by eight bits can be rendered by means of only the upper four bits' worth of the dither-added pixel data. Therefore, the drive control circuit 56 renders the upper four bits' worth of the dither-added pixel data 4-bit multiple gray level pixel data PD_{S} which all of the brightness levels as shown in FIG. 30 by means of 16 gray levels. Further, the drive control circuit 56 converts the multiple gray level pixel data PD_{S} into 14-bit pixel driving data GD in accordance with the data conversion table as shown in FIG. 30. The drive control circuit 56 matches the first to fourteenth bits of the pixel driving data GD with each of the subfields SF1 to SF14 (described subsequently) and supplies the bits which correspond to the subfields SF to the address driver 55 one display line at a time (m) as pixel driving data bits.

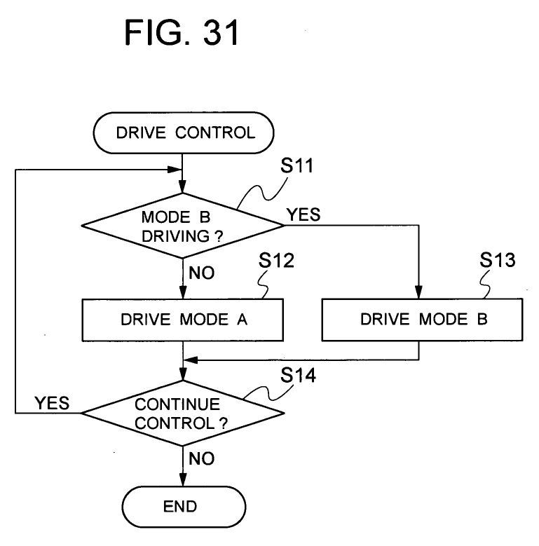

As shown in the flowchart of FIG. 31, the drive control circuit 56 selectively executes a normal drive sequence operation (called drive mode A (MODE-A) hereinbelow) and an adjustment drive sequence operation (called drive mode B (MODE-B) hereinbelow).

That is, as will be described in detail hereinbelow, in drive mode B, the period which extends from the point where the application of the final light emission sustain pulse in the frame ends until the point where the application of the data pulse DP which is first applied in the selective write subfield in the subsequent frame is started is adjusted (changed) to be longer than the normal drive sequence (drive mode A).

When the flowchart in FIG. 31 is referenced, the drive control circuit 56 first discriminates on the basis of the conditions and criteria for selecting the drive mode whether to perform driving using drive mode B (step S11). A variety of conditions exist as conditions for drive mode selection, the details of which will be described subsequently.

In step S11, in cases where it is discriminated that driving using drive mode B is not to be performed, driving using drive mode A is executed (step S12). On the other hand, in cases where it is discriminated that driving using drive mode B is to be performed, drive mode B is executed (step S13).

Thereafter, it is discriminated whether the drive control is to be continued and, in cases where the drive control is to be continued, the procedure is repeated by returning to step S11. In cases where the drive control is ended, the main control routine is ended.

[Sequence Based on Drive Mode A (Normal Drive Sequence)]

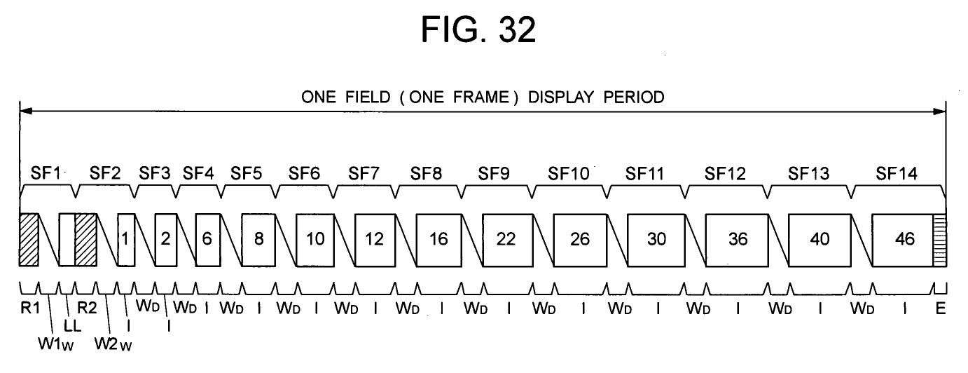

First, the drive operation will be described on the basis of drive mode A (normal drive sequence). The drive control circuit 56 supplies various control signals for driving the PDP 50 which has the above structure in accordance with the light emission drive sequence as shown in FIG. 32 to the panel driver which comprises the X electrode driver 51, Y electrode driver 53, and address driver 55. That is, the drive control circuit 56 supplies various control signals for sequentially implementing driving which corresponds to each of the first reset process R1, the first selective write address process W1_{W} and a micro light emission process LL in the leading subfield SF1 in one field (one frame) display period as shown in FIG. 32 to the panel driver. In SF2, which follows subfield SF1, the drive control circuit 56 supplies various control signals for sequentially implementing driving which corresponds to a second reset process R2, a second selective write address process W2_{W} and sustain process I respectively to the panel driver. Further, various control signals for sequentially implementing driving which corresponds to a selective erase address process W_{D} and sustain process I in the subfields SF3 to SF14 respectively are supplied to the panel driver. Only in the final subfield SF14 within the single field display period, following the execution of the sustain process I, the drive control circuit 56 supplies various control signals for sequentially implementing driving which corresponds to an erase process E to the panel driver.

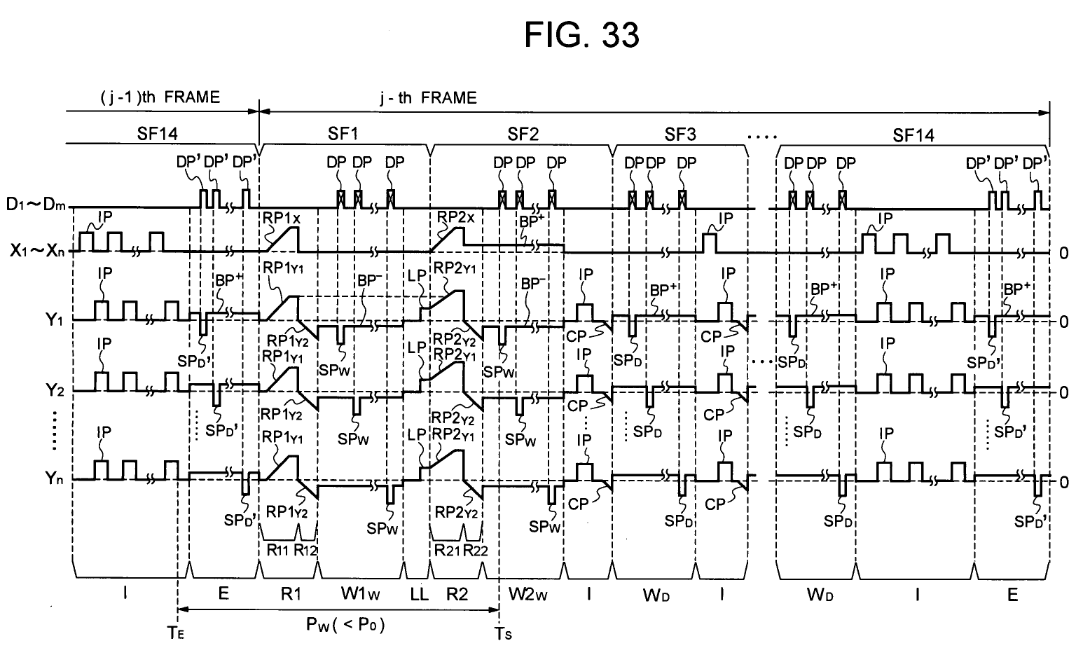

The panel drivers, that is, the X electrode driver 51, Y electrode driver 53, and address driver 55 generate various drive pulses as shown in FIG. 33 in accordance with the various control signals supplied by the drive control circuit 56 and supplies the various drive pulses to the column electrodes D and row electrodes X and Y of the PDP 50.

In FIG. 33, only the operation of SF1 to SF3 and the operation of the last subfield SF14 among the subfields SF1 to SF14 shown in FIG. 32, and only the operation of the last subfield (SF14) in the frame ((j−1)th frame) preceding the frame (j-th frame) comprising the subfields SF1 to SF14 are selectively shown.

First, in the first half (R11) of the first reset process R1 of subfield SF1, the Y electrode driver 53 applies a positive polarity reset pulse RP1_{Y1} which has a waveform in which the potential transition at the leading edge as time elapses is gradual in comparison with the subsequent sustain pulse to all of the row electrodes Y₁ to Yₙ. The peak potential of the reset pulse RP1_{Y1} is a potential which is higher than the peak potential of the sustain pulse and is a lower potential than the peak potential of the subsequent reset pulse RP2_{Y1}. Furthermore, meanwhile, the address driver 55 sets the column electrodes D₁ to Dₘ to a ground potential (0 volt) state. In addition, meanwhile, the X electrode driver 51 applies a reset pulse RP1_{X} with the same polarity as that of the reset pulse RP1_{Y1} and which has a peak potential which prevents a surface discharge across the row electrodes X and Y caused by the application of the reset pulse RP1_{Y1} to all of the row electrodes X₁ to Xₙ respectively. Meanwhile, if a surface discharge does not occur across the row electrodes X and Y, the X electrode driver 51 may also set all of the row electrodes X₁ to Xₙ at ground potential (0 volt) instead of applying the reset pulse RP1ₓ. Here, in the first half of the first reset process R1, a weak first reset discharge is produced across the row electrodes Y and column electrodes D in all of the discharge cells PC in accordance with the application of the reset pulse RP1_{Y1} as mentioned earlier. That is, by applying a voltage across the row electrodes Y and column electrodes D in the first half (R11) of the first reset process R1 so that the row electrodes Y are anodic and the column electrodes D are cathodic, a discharge in which the current flows from the row electrodes Y to the column electrodes D (referred to as the ‘column cathode discharge’ hereinbelow) is produced as the first reset discharge. A wall charge of a negative polarity is formed close to the row electrodes Y in all of the discharge cells PC and a wall charge of a positive polarity is formed close to the column electrodes D in accordance with the first reset discharge.

Thereafter, in the latter half (R12) of the first reset process R1 of the subfield SF1, the Y electrode driver 53 generates a reset pulse RP1_{Y2} for which the potential transition at the leading edge as time elapses is gradual and which has a negative polarity and applies the reset pulse RP1_{Y2} to all of the row electrodes Y₁ to Yₙ. The negative peak potential of the reset pulse RP1_{Y2} is set at a higher potential than the subsequently described negative polarity write scan pulse SP_{W}, that is, at a potential which is close to 0 volt. In other words, this is because, when the peak potential of the reset pulse RP_{Y2} is lower than the peak potential of the write scan pulse SP_{W}, a strong discharge is produced across the row electrodes Y and column electrodes D, the wall charge formed close to the column electrodes D is largely erased and the address discharge in the first selective write address process W1_{W} becomes unstable. Meanwhile, the X electrode driver 51 sets all of the row electrodes X₁ to Xₙ at ground potential (0 volt). The peak potential of the reset pulse RP1_{Y2} is the lowest potential with which it is possible to produce the second reset discharge reliably across the row electrodes X and Y after considering the wall charge formed close to the row electrodes X and Y respectively in accordance with the first reset discharge. Here, in the latter half of the first reset process R1, a second reset discharge is produced across the row electrodes X and Y in all of the discharge cells PC in accordance with the application of the reset pulse RP1_{Y2}. As a result of the second reset discharge, the wall charge formed close to the row electrodes X and Y respectively in the respective discharge cells PC is erased and all of the discharge cells PC are initialized in the lighting-off mode. In addition, a weak discharge is also produced across the row electrodes Y and column electrodes D in all of the discharge cells PC in accordance with the application of the reset pulse RP1_{Y2}. As a result of the weak discharge, a portion of the wall charge of a positive polarity formed close to the column electrodes D is erased and is adjusted to the amount that makes it possible to produce a selective write address discharge accurately in the first selective write address process W1_{W} (described subsequently).

Thereafter, in the first selective write address process W1_{W} of the subfield SF1, the Y electrode driver 53 simultaneously applies a base pulse BP⁻ with a predetermined base potential of a negative polarity to the row electrodes Y₁ to Yₙ as shown in FIG. 33 while sequentially and alternatively applying a write scan pulse SP_{W} with a negative polarity peak potential to each of the row electrodes Y₁ to Yₙ. Meanwhile, the address driver 55 first converts the pixel driving data bit which corresponds to subfield SF1 into a pixel data pulse DP which has a pulse voltage that corresponds to the logic level of the pixel driving data bit. For example, in cases where a pixel driving data bit of logic level “1” which serves to set the discharge cells PC to lighting-on mode is supplied, the address driver 55 converts the logic level-1 pixel driving data bit into a pixel data pulse DP which has a positive polarity peak potential. However, the address driver 55 converts the logic level “0” pixel driving data bit for setting the discharge cells PC to lighting-off mode into a low voltage (0 volt) pixel data pulse DP. Further, the address driver 55 applies the pixel data pulse DP to the column electrodes D₁ to Dₘ in synchronism with the application timing of the respective write scan pulses SP_{W} one display line at a time (m). Thereupon, a selective write address discharge is produced across the column electrodes D and row electrodes Y in the discharge cells PC to which a high voltage pixel data pulse DP for setting the discharge cells to lighting-on mode is applied at the same time as the write scan pulse SP_{W}. Meanwhile, although a voltage which corresponds to the write scan pulse SP_{W} is applied across the row electrodes X and Y, at this stage, all of the discharge cells PC enter lighting-off mode, that is, a state where wall charge is erased, and, therefore, discharge is not produced across the row electrodes X and Y only in the application of the write scan pulse SP_{W}. Therefore, in the first selective write address process W1_{W} of the subfield SF1, a selective write address discharge is produced only across the column electrodes D and row electrodes Y in the discharge cells PC in accordance with the application of the write scan pulse SP_{W} and high-voltage pixel data pulse DP. As a result, although wall charge does not exist close to the row electrodes X in the discharge cells PC, the discharge cells PC are set to a lighting-on mode state where wall charge of a positive polarity is formed close to the row electrodes Y and wall charge of a negative polarity is formed close to column electrodes D. However, a selective write address discharge is not produced as mentioned earlier across the column electrodes D and row electrodes Y in the discharge cells PC to which the low voltage (0 volt) pixel data pulse DP for setting the discharge cells PC to the lighting-off mode is applied at the same time as the write scan pulse SP_{W}. Accordingly, the discharge cells PC maintain a lighting-off mode state which is initialized in the first reset process R1, that is, a state where a discharge is not produced across the row electrodes Y and column electrodes D and across the row electrodes X and Y.

Thereafter, in the micro light emission process LL of the subfield SF1, the Y electrode driver 53 simultaneously applies a micro light emission pulse LP with a predetermined peak potential of a positive polarity as shown in FIG. 33 to the row electrodes Y₁ to Yₙ. A discharge is produced across the column electrodes D and row electrodes Y in the discharge cells PC set to lighting-on mode in accordance with the application of the micro light emission pulse LP (referred to as ‘micro light emission discharge’ hereinbelow). That is, in the micro light emission process LL, although a discharge is produced across the row electrodes Y and column electrodes D in the discharge cells PC, because a potential which does not produce a discharge across the row electrodes X and Y is applied to the row electrodes Y, a micro light emission discharge is produced only across the column electrodes D and row electrodes Y in the discharge cells PC set to lighting-on mode. Here, the peak potential of the micro light emission pulse LP is a lower potential than the peak potential of the sustain pulses IP applied in the sustain process I following subfield SF2 (described subsequently) and is the same as the base potential which is applied to the row electrodes Y in the selective erase address process W_{D} (described subsequently), for example. Further, as shown in FIG. 33, the rate of change as time elapses in the rising segment of the potential of the micro light emission pulse LP is higher than the rate of change in the rising segment of the reset pulse (RP1_{Y1}, RP2_{Y1}). That is, by making the potential transition of the leading edge of the micro light emission pulse LP steeper than the potential transition of the leading edge of the reset pulse, a discharge that is stronger than the first reset discharge produced in the first reset process R1 and the second reset process R2 is produced. Here, the discharge is the earlier mentioned column side cathode discharge and is a discharge that is produced by the micro light emission pulse LP which has a lower pulse voltage than that of the sustain pulse IP. Hence, the light emission brightness caused by the discharge is lower than that of the sustain discharge (described subsequently) produced across the row electrodes X and Y. That is, although the discharge is a discharge which causes light emission of a higher brightness level than that of the first reset discharge in the micro light emission process LL, a discharge for which the brightness level caused by the discharge is lower than that of the sustain discharge, that is, a discharge which causes micro light emission of a magnitude that can be utilized for the display is produced as the micro light emission discharge. Here, in the first selective write address process W1_{W} executed directly before the micro light emission process LL, a selective write address discharge is produced across the column electrodes D and row electrodes Y in the discharge cells PC. Accordingly, in subfield SF1, brightness which corresponds to a gray level whose brightness is one level higher than brightness level 0 is represented by the light emission caused by the micro light emission discharge and the light emission caused by the selective write address discharge.

Following the micro light emission discharge, wall charge of a negative polarity is formed close to the row electrodes Y and wall charge of a positive polarity is formed close to the column electrodes D.

Thereafter, in the first half (R21) of the second reset process R2 of subfield SF2, the Y electrode driver 53 applies a positive polarity reset pulse RP2_{Y1} which has a waveform in which the potential transition at the leading edge as time elapses is gradual in comparison with the subsequent sustain pulse IP to all of the row electrodes Y₁ to Yₙ. The peak potential of the reset pulse RP2_{Y1} is higher than the peak potential of the reset pulse RP1_{Y1}. Further, meanwhile, the address driver 55 sets the column electrodes D₁ to Dₘ to a ground potential (0 volt) state and the X electrode driver 51 applies a reset pulse RP2_{X} of a positive polarity which has a peak potential which makes it possible to prevent a surface discharge across the row electrodes X and Y caused by the application of the reset pulse RP2_{Y1} to all of the row electrodes X₁ to Xₙ respectively. Here, if a surface discharge is not produced across the row electrodes X and Y, instead of applying the reset pulse RP2_{X}, the X electrode driver 51 may set all of the row electrodes X₁ to Xₙ at ground potential (0 volt). A first reset discharge which is weaker than the column cathode discharge in the micro light emission process LL is produced across the row electrodes Y and column electrodes D in the discharge cells PC for which a column side cathode discharge has not been produced in the micro light emission process LL in each of the discharge cells PC in accordance with the application of the reset pulse RP2_{Y1}. That is, by applying a voltage across the row electrodes Y and column electrodes D in the first half (R21) of the second reset process R2 so that the row electrodes Y are anodic and the column electrodes D are cathodic, the column cathode discharge in which the current flows from the row electrodes Y to the column electrodes D is produced as the first reset discharge. However, a discharge is not produced even when the application of the reset pulse RP2_{Y1} is performed within the discharge cells PC in which a micro light emission discharge has already been produced in the micro light emission process LL. Therefore, directly after the end of the first half of the second reset process R2, a wall charge of a negative polarity is formed close to the row electrodes Y in all of the discharge cells PC and a wall charge of a positive polarity is formed close to the column electrodes D.

Thereafter, in the latter half (R22) of the second reset process R2 of subfield SF2, the Y electrode driver 53 applies a negative polarity reset pulse RP2_{Y2} in which the potential transition at the leading edge is gradual as time elapses to the row electrodes Y₁ to Yₙ. Furthermore, in the latter half (R22) of the second reset process R2, the X electrode driver 51 applies a base pulse BP⁺ which has a predetermined base potential of a positive polarity to each of the row electrodes X₁ to Xₙ. Here, a second reset discharge is produced across the row electrodes X and Y in all of the discharge cells PC in accordance with the application of the negative polarity reset pulse RP2_{Y2} and the positive polarity base pulse BP⁺. The peak potentials of each of the reset pulse RP2_{Y2} and the base pulse BP⁺ are the lowest potential with which it is possible to produce the second reset discharge reliably across the row electrodes X and Y after considering the wall charge formed close to the row electrodes X and Y respectively in accordance with the first reset discharge. Further, the negative peak potential of the reset pulse RP2_{Y2} is set at a higher potential than the peak potential of the negative polarity write scan pulse SP_{W}, that is, at a potential which is close to 0 volt. In other words, this is because, when the peak potential of the reset pulse RP2_{Y2} is lower than the peak potential of the write scan pulse SP_{W}, a strong discharge is produced across the row electrodes Y and column electrodes D, the wall charge formed close to the column electrodes D is largely erased and the address discharge in the second selective write address process W2_{W} becomes unstable. Here, the wall charge formed close to the row electrodes X and Y respectively in the respective discharge cells PC is erased by the second reset discharge produced in the latter half of the second reset process R2 and all of the discharge cells PC are initialized in the lighting-off mode. In addition, a weak discharge is also produced across the row electrodes Y and column electrodes D in all of the discharge cells PC in accordance with the application of the reset pulse RP2_{Y2} and, as a result of the discharge, a portion of the wall charge of a positive polarity formed close to the column electrodes D is erased and is adjusted to the amount that makes it possible to produce a selective write address discharge accurately in the second selective write address process W2_{W}.

Thereafter, in the second selective write address process W2_{W} of the subfield SF2, the Y electrode driver 53 simultaneously applies a base pulse BP⁻ with a predetermined base potential of a negative polarity to the row electrodes Y₁ to Yₙ as shown in FIG. 33 while alternatively and sequentially applying a write scan pulse SP_{W} with a negative polarity peak potential to each of the row electrodes Y₁ to Yₙ. The X electrode driver 51 applies the base pulse BP⁺ applied to each of the row electrodes X₁ to Xₙ in the latter half of the second reset process R2 to each of the row electrodes X₁ to Xₙ successively also in the second selective write address process W2_{W}. The potentials of the base pulse BP⁻ and base pulse BP⁺ respectively are set at a potential so that the voltage across the row electrodes X and Y during a non-application period of the write scan pulse SP_{W} is lower than the discharge start voltage of the discharge cell PC. Furthermore, in the second selective write address process W2_{W}, the address driver 55 first converts the pixel driving data bit which corresponds to subfield SF2 into a pixel data pulse DP which has a pulse voltage that corresponds to the logic level of the pixel driving data bit. For example, in cases where a pixel driving data bit of logic level “1” which serves to set the discharge cells PC to lighting-on mode is supplied, the address driver 55 converts the logic level-1 pixel driving data bit into a pixel data pulse DP which has a positive polarity peak potential. However, the address driver 55 converts the logic level “0” pixel driving data bit for setting the discharge cells PC to lighting-off mode into a low voltage (0 volt) pixel data pulse DP. Further, the address driver 55 applies the pixel data pulse DP to the column electrodes D₁ to Dₘ in synchronism with the application timing of the respective write scan pulses SP_{W} one display line at a time (m). Thereupon, a selective write address discharge is produced across the column electrodes D and row electrodes Y in the discharge cells PC to which a high voltage pixel data pulse DP for setting the discharge cells to lighting-on mode is applied at the same time as the write scan pulse SP_{W}. In addition, directly after the selective write address discharge, a weak discharge is also produced across the row electrodes X and Y in the discharge cells PC. That is, a voltage which corresponds to the base pulses BP⁻ and BP⁺ is applied across the row electrodes X and Y after the write scan pulse SP_{W} has been applied. This voltage is set at a voltage which is lower than the discharge start voltage of the respective discharge cells PC. Accordingly, a discharge cannot be produced within the discharge cells PC merely through the application of the voltage. However, when the selective write address discharge is produced, a discharge is produced across the row electrodes X and Y merely by applying the voltage of the base pulses BP⁻ and BP⁺ through induction by the selective write address discharge. As a result of the discharge and the selective write address discharge, the discharge cells PC are set to a state where a positive polarity wall charge is formed close to the row electrodes Y, a negative polarity wall charge is formed close to the row electrodes X, and a negative polarity wall charge is formed close to the column electrodes D, that is, to lighting-on mode.

However, the selective write address discharge is not produced, as mentioned earlier, across the column electrodes D and row electrodes Y in the discharge cells PC to which a low voltage (0 volt) pixel data pulse DP for setting the discharge cells PC to lighting-off mode is applied at the same time as the write scan pulse SP_{W}. Accordingly, the discharge cells PC maintain the preceding state, that is, the lighting-off mode state that was initialized in the second reset process R2.

Thereafter, in the sustain process I of subfield SF2, the Y electrode driver 53 generates one pulse's worth of sustain pulse IP with a positive polarity peak potential and simultaneously applies the sustain pulse IP to the row electrodes Y₁ to Yₙ. Meanwhile, the X electrode driver 51 sets the row electrodes X₁ to Xₙ to a ground potential (0 volt) state and the address driver 55 sets the column electrodes D₁ to Dₘ to a ground potential (0 volt) state. A sustain discharge is produced across the row electrodes X and Y in the discharge cells PC set to lighting-on mode as mentioned earlier in response to the application of the sustain pulse IP. As a result of the light which is irradiated by the fluorescent layer 17 being irradiated to the outside via the front transparent substrate 10 in accordance with the sustain discharge, one display's worth of light emission which corresponds to the brightness weighting of subfield SF1 is performed. Further, a discharge is also produced across the row electrodes Y and column electrodes D in the discharge cells PC that have been set to lighting-on mode in response to the application of the sustain pulse IP. As a result of the discharge and the sustain discharge, a negative polarity wall charge is formed close to the row electrodes Y in the discharge cells PC and a positive polarity wall charge is formed close to each of the row electrodes X and column electrodes D. Further, following the application of the sustain pulse IP, the Y electrode driver 53 applies a wall charge adjustment pulse CP in which the potential transition at the leading edge as time elapses is gradual and which has a negative polarity peak potential as shown in FIG. 33 to the row electrodes Y₁ to Yₙ. A weak erase discharge is produced in the discharge cells PC in which a sustain discharge is produced as mentioned earlier in response to the application of the wall charge adjustment pulse CP and a portion of the wall charge formed in the discharge cells PC is erased. As a result, the amount of wall charge in the discharge cells PC is adjusted to an amount that makes it possible to produce a selective erase address discharge correctly in the next selective erase address process W_{D}.

Thereafter, in the selective erase address process W_{D} of each of the subfields SF3 to SF14, the Y electrode driver 53 applies a base pulse BP⁺ which has a predetermined peak potential of a positive polarity to each of the row electrodes Y₁ to Yₙ while alternatively and sequentially applying an erase scan pulse SP_{D} which has a negative polarity peak potential to each of the row electrodes Y₁ to Yₙ as shown in FIG. 33. The peak potential of the base pulse BP⁺ is set at a potential which makes it possible to prevent erroneous discharge across the row electrodes X and Y during the period of execution of the selective erase address process W_{D}. Further, during the period of execution of the selective erase address process W_{D}, the X electrode driver 51 sets each of the row electrodes X₁ to Xₙ at ground potential (0 volt). Further, in the selective erase address process W_{D}, the address driver 55 first converts the pixel driving data bit which corresponds to the subfield SF into a pixel data pulse DP which has a pulse voltage that corresponds to the logic level of the pixel driving data bit. For example, in cases where a pixel driving data bit of logic level 1 which serves to shift the discharge cells PC from the lighting-on mode to the lighting-off mode is supplied, the address driver 55 converts the logic level-1 pixel driving data bit into a pixel data pulse DP which has a positive polarity peak potential. However, in cases where a pixel driving data bit of logic level 0 which is for maintaining the current state of the discharge cells PC is supplied, the address driver 55 converts the logic level-0 pixel driving data bit into a low voltage (0 volt) pixel data pulse DP. Further, the address driver 55 applies the pixel data pulse DP to the column electrodes D₁ to Dₘ in synchronism with the application timing of the respective erase scan pulses SP_{D} one display line at a time (m). Thereupon, a selective erase address discharge is produced across the column electrodes D and row electrodes Yin the discharge cells PC to which a high voltage pixel data pulse DP is applied at the same time as the erase scan pulse SP_{D}. As a result of the selective erase address discharge, the discharge cells PC are set to a state where a positive polarity wall charge is formed close to the row electrodes X and Y and a negative polarity wall charge is formed close to the column electrodes D, that is, to lighting-off mode. However, a selective erase address discharge is not produced, as mentioned earlier, across the column electrodes D and row electrodes Y in the discharge cells PC to which a low voltage (0 volt) pixel data pulse DP is applied at the same time as the erase scan pulse SP_{D}. Accordingly, the discharge cells PC maintain the preceding state (the lighting-on mode, lighting-off mode).

Thereafter, in the sustain process I of each of the subfields SF3 to SF14, the X electrode driver 51 and Y electrode driver 53 apply a sustain pulse IP which has a positive polarity peak potential to the row electrodes X₁ to Xₙ and Y₁ to Yₙ alternately to the row electrodes X and Y and repeatedly by a number of times (an even number of times) corresponding to the subfield brightness weighting as shown in FIG. 33. Whenever the sustain pulse IP is applied, the sustain discharge is produced across the row electrodes X and Y in the discharge cells PC which have been set to lighting-on mode. As a result of the light irradiated by the fluorescent layer 17 being irradiated to the outside via the front transparent substrate 10 in accordance with the sustain discharge, display light emission a number of times which corresponds to the brightness weighting of subfield SF is performed. Thereupon, a negative polarity wall charge is formed close to the row electrodes Y and a positive polarity wall charge is formed close to the row electrodes X and column electrodes D respectively in the discharge cells PC in which a sustain discharge is produced in accordance with the sustain pulse IP which is applied last in the sustain process I of each of the subfield SF2 to SF14. Further, following the application of the final sustain pulse IP, the Y electrode driver 53 applies a wall charge adjustment pulse CP in which the potential transition at the leading edge as time elapses is gradual and which has a negative polarity peak potential as shown in FIG. 33 to the row electrodes Y₁ to Yₙ. A weak erase discharge is produced in the discharge cells PC in which a sustain discharge is produced as mentioned earlier in response to the application of the wall charge adjustment pulse CP and a portion of the wall charge formed in the discharge cells PC is erased. As a result, the amount of wall charge in the discharge cells PC is adjusted to an amount that makes it possible to produce a selective erase address discharge correctly in the next selective erase address process W_{D}.

Further, directly after the end of the sustain process I of the final subfield SF14, an erase process E is executed. In erase process E, the Y electrode driver 53 applies a base pulse BP⁺ which has a predetermined base potential of a positive polarity to each of the row electrodes Y₁ to Yₙ while alternatively and sequentially applying an erase scan pulse SP_{D}′ which has a negative polarity peak potential to each of the row electrodes Y₁ to Yₙ as shown in FIG. 33. The peak potential of the base pulse BP⁺ is set at a potential which makes it possible to prevent erroneous discharge across the row electrodes X and Y during the period of execution of the selective erase process E. Further, during the period of execution of the erase process E, the X electrode driver 51 sets each of the row electrodes X₁ to Xₙ at ground potential (0 volt).

In the erase process E, the address driver 55 applies a pixel data pulse (address pulse) DP′ which has a positive polarity peak potential to the column electrodes D₁ to Dₘ in synchronism with the respective application timing of the erase scan pulse SP_{D}′ to the column electrodes D₁ to Dₘ one display line (m) at a time as the erase pulse, as per the case where the logic level-1 pixel driving data bit is supplied in order to set all of the discharge cells PC in lighting-off mode. Thereupon, at the same time as the erase scan pulse SP_{D}, an erase discharge is produced across the column electrodes D and row electrodes Y in all of the discharge cells PC to which the pixel data pulse DP′ has been applied and which are in lighting-on mode up until directly before the application of the pixel data pulse DP′. As a result of the erase discharge, the respective discharge cell PC in lighting-on mode up until directly before the erase discharge are set to a state where a positive polarity wall charge is formed close to each of the row electrodes X and Y and a negative polarity wall charge is formed close to the column electrodes D, that is, to lighting-off mode. The lighting-off mode is maintained in the discharge cells PC that have entered lighting-off mode until subfield SF13. As a result, all of the discharge cells PC enter lighting-off mode.

The driving above is executed on the basis of sixteen different pixel driving data GD as shown in FIG. 30.

First, at the second gray level which represents brightness which is one level higher than the first gray level which represents the black display (brightness level 0), a selective write address discharge for setting the discharge cells PC to lighting-on mode is produced only in SF1 among the subfields SF1 to SF14 as shown in FIG. 30 and the discharge cells PC set to the lighting-on mode are made to produce a micro light emission discharge (indicated by an empty square). Thereupon, the brightness level during the light emission caused by the selective write address discharge and the micro light emission discharge is lower than the brightness level during the light emission caused by one sustain discharge. Accordingly, in cases where the brightness level visualized as a result of the sustain discharge is ‘1’, at the second gray level, brightness which corresponds to a brightness level ‘α’ which is lower than brightness level ‘1’ is rendered.

Thereafter, at the third gray level which represents brightness that is one level higher than that of the second gray level, a selective write address discharge (indicated by two overlapping circles) for setting the discharge cells PC to lighting-on mode is produced only in SF2 among the subfields SF1 to SF14 and a selective erase address discharge which allows the discharge cells PC to make the transition to lighting-off mode is produced in the next subfield SF3 (indicated by a black circle). Accordingly, at the third gray level, light emission which is caused by a single sustain discharge is performed only in the sustain process I of the SF2 among the subfields SF1 to SF14 and brightness which corresponds to brightness level ‘1’ is rendered.

Thereafter, at the fourth gray level which represents brightness that is one level higher than that of the third gray level, a selective write address discharge for setting the discharge cells PC to lighting-on mode is first produced in subfield SF1 and the discharge cells PC set to the lighting-on mode are made to produce a micro light emission discharge (indicated by an empty square shape). Furthermore, at the fourth gray level, a selective write address discharge for setting the discharge cells PC to lighting-on mode is produced only in SF2 among the subfields SF1 to SF14 (indicated by two overlapping circles) and a selective erase address discharge which allows the discharge cells PC to make the transition to lighting-off mode is produced in the next subfield SF3 (indicated by a black circle). Accordingly, at the fourth gray level, light emission with a brightness level ‘α’ is executed in subfield SF1 and a sustain discharge which causes light emission of brightness level ‘1’ is implemented once in SF2. Hence, brightness which corresponds to the brightness level ‘α’+‘1’ is rendered.

Further, at each of the fifth to sixteenth gray levels, a selective write address discharge for setting the discharge cells PC to lighting-on mode is produced in subfield SF1 and the discharge cells PC which have been set to lighting-on mode are made to produce a micro light emission discharge (indicated by an empty square shape). Further, a selective erase address discharge which allows the discharge cells PC to make the transition to lighting-off mode is produced only in the one subfield which corresponds to the gray level (indicated by a black circle). Accordingly, at the fifth to sixteenth gray levels, the micro light emission discharge is produced in subfield SF1 and a single sustain discharge is produced in SF2, whereupon a sustain discharge is produced a number of times which corresponds to the number of times assigned to the subfield in each of the consecutive subfields in a number which corresponds to the gray levels (indicated by a white circle). As a result, at each of the fifth to sixteenth gray levels, brightness which corresponds to the brightness level ‘α’+‘one field (or one frame) the total number of sustain discharges produced in the display period’ is visualized.

That is, according to the driving shown in FIG. 30, it is possible to render the brightness range of brightness levels ‘0’ to ‘255+α’ by means of sixteen levels as shown in FIG. 30.

With the driving, because there is no mixing within one screen of areas in which the light emission patterns (lit state, unlit state) are mutually inverted within one field display period, a pseudo contour that arises in such a state is prevented. In the driving shown in FIG. 30, although a micro light emission discharge which causes the light emission of brightness level α is produced in subfield SF1 at each gray level of the fourth and subsequent gray levels, the micro light emission discharge may not be produced at the third and subsequent gray levels. In short, because the light emission caused by the micro light emission discharge has a very low brightness (brightness level α), at each of the fourth and subsequent gray levels in which the micro light emission discharge is used together with the sustain discharge which causes light emission of a higher brightness, there are cases where it is no longer possible to visualize the corresponding brightness increase of brightness level α and there is no sense in producing a micro light emission discharge at this time.

Here, in the driving shown in FIG. 33, by applying a voltage across the row electrodes Y and column electrodes D in the first reset process R1 of subfield SF1 and the second reset process R2 of subfield SF2 so that the row electrodes Y are anodic and the column electrodes D are cathodic, the column cathode discharge in which the current flows from the row electrodes Y to the column electrodes D is produced as the first reset discharge. Accordingly, during the first reset discharge, when anode ions in the discharge gas move toward the column electrode D, the anode ions collide with MgO crystals which are a secondary electron emission material contained in the fluorescent layer 17 as shown in FIG. 5 and secondary electrons are emitted by the MgO crystals. In a PDP 50 of the plasma display device shown in FIG. 29 in particular, by exposing the MgO crystals to a discharge space as shown in FIG. 5, the probability of the collision with the anode ions is raised so that the secondary electrons are efficiently emitted to the discharge space. Because the discharge start voltage of the discharge cells PC is low as a result of the priming action by the secondary electrons, a relatively weak reset discharge can be produced. Accordingly, because the light emission brightness caused by the discharge drops as a result of the weakened reset discharge, a display with an improved contrast when displaying a dark image, that is, an improved so-called darkness contrast is possible.

Furthermore, in the driving shown in FIG. 33, the first reset discharge is produced across the row electrodes Y formed on the side of the transparent substrate 10 and the column electrodes D formed on the side of the rear substrate 14, as shown in FIG. 3. Accordingly, in comparison with a case where a reset discharge is produced across the row electrodes X and Y formed on the side of the front transparent substrate 10, the discharged light emitted by the front transparent substrate 10 to the outside is reduced and, therefore, further darkness contrast improvements are possible.

Further, in the driving shown in FIGS. 30, 32, and 33, after a reset discharge for initializing all of the discharge cells PC in the lighting-off mode state has been produced in the leading subfield SF1, a selective write address discharge which serves to allow the discharge cells PC in the lighting-off mode state to make the transition to the lighting-on mode state is produced. Further, in a single subfield in each of the subfields SF3 to SF14 which follow SF2, driving which adopts a selective erase address method whereby a selective erase address discharge is produced to allow the discharge cells PC in the lighting-on mode state to make the transition to the lighting-off mode state is carried out. Accordingly, when a black display (brightness level 0) is performed by means of driving according to the first gray level as shown in FIG. 30, the discharge that is produced via a single field display period is only a reset discharge in the leading subfield SF1. Hence, in comparison with a case where driving to produce a selective erase address discharge which allows all of the discharge cells PC to make the transition to the lighting-off mode state after producing a reset discharge to initialize all of the discharge cells PC in the lighting-on mode state is employed in the subfield SF1, the number of discharges produced via a single field display period is reduced and, therefore, the darkness contrast can be improved.

In the driving shown in FIGS. 30, 32, and 33, in subfield SF1 which has the smallest brightness weighting, a micro light emission discharge is produced rather than a sustain discharge as the discharge which contributes to the display image. The micro light emission discharge is a discharge which is produced across the column electrodes D and row electrodes Y. Hence, the brightness level during the light emission caused by the discharge is low in comparison with that caused by the sustain discharge produced across the row electrodes X and Y. Accordingly, in cases where brightness which is one level higher than a black display (brightness level 0) is rendered by the micro light emission discharge (second gray level), the brightness difference from brightness level 0 is small in comparison with a case where the brightness is rendered by a sustain discharge. Therefore, the gray level rendering performance when rendering an image of low brightness increases. Further, at the second gray level, because a reset discharge is not produced in the second reset process R2 of SF2 which succeeds subfield SF1, the reduction in the darkness contrast caused by the reset discharge is suppressed.

Further, in the driving shown in FIG. 33, the peak potential of the reset pulse RP1_{Y1} which is applied to the row electrodes Y in order to produce the first reset discharge in the first reset process R1 of the subfield SF1 is lower than the peak potential of the reset pulse RP2_{Y1} which is applied to the row electrodes Y for producing a first reset discharge in the second reset process R2 of SF2. In the first reset process R1 of subfield SF1, the light emission when all of the discharge cells PC are subjected to the reset discharge all together is weakened to suppress the reduction in the darkness contrast.

Further, in the driving shown in FIGS. 30, 32, and 33, in the sustain process I of subfield SF2 whose brightness weighting is the second brightness weighting, the gray level rendering performance when rendering an image of low brightness increases as a result of producing a sustain discharge only once. In the sustain process I of subfield SF2, because the sustain pulse IP which is applied in order to produce a sustain discharge is applied only once, after the end of the sustain discharge which is produced in accordance with the single sustain pulse IP, a state where a wall charge of a negative polarity is formed close to the row electrodes Y and where a wall charge of a positive polarity is formed close to the column electrodes D is assumed. As a result, in the selective erase address process W_{D} of the next subfield SF3, a discharge in which the column electrodes D are the cathode side (referred to as the ‘column cathode discharge’ hereinbelow) can be produced as a selective erase address discharge across the column electrodes D and row electrodes Y. However, in the sustain process I of each of the subfields SF3 to SF14 which follow, the number of applications of the sustain pulse IP is an even number. Accordingly, directly after the end of the respective sustain process I, because a state is assumed where a negative polarity wall charge is formed close to the row electrodes Y and a positive polarity wall charge is formed close to the column electrodes D, in the selective erase address process W_{D} which is successively carried out in each sustain process I, a column cathode discharge is possible. Therefore, positive polarity pulses are only applied to the column electrodes D and an increase in costs for the address driver 55 is prevented.

Further, the PDP 50 shown in FIG. 29 contains CL light-emitting MgO crystals which constitute a secondary electron emission material not only in the magnesium oxide layer 13 formed on the side of the front transparent substrate 10 in each of the discharge cells PC but also in the fluorescent layer 17 which is formed on the side of the rear substrate 14.

The operating effects of adopting this configuration will be described hereinbelow with reference to FIGS. 6 and 7.

FIG. 6 represents the transition of the discharge intensity of the column cathode discharge that is produced when applying the reset pulse RP1_{Y1} or RP2_{Y1} as shown in FIG. 9 to a so-called conventional PDP which contains CL light-emitting MgO crystals only in the magnesium oxide layer 13 among the magnesium oxide layer 13 and fluorescent layer 17.

However, FIG. 7 shows the transition of the discharge intensity of the column cathode discharge that is produced when applying reset pulse RP1_{Y1} or RP2_{Y1} to the PDP 50 of the present invention which contains CL light-emitting MgO crystals in both the magnesium oxide layer 13 and the fluorescent layer 17.

As shown in FIG. 6, with a conventional PDP, although the relatively strong column cathode discharge continues for 1 [msec] or more in accordance with the application of the reset pulse RP1_{Y1} or RP2_{Y1}, with the PDP 50 of the present invention, the column cathode discharge ends within approximately 0.04 [msec] as shown in FIG. 7. That is, in comparison with a conventional PDP, the discharge delay time of the column cathode discharge can be markedly shortened.

Therefore, as shown in FIG. 33, when a column cathode discharge is produced by applying the reset pulse RP1_{Y1} or RP2_{Y1} which has a waveform in which the potential transition at the leading edge of the pulse is gradual to the row electrodes Y of the PDP 50, the discharge ends before the potential of the row electrodes Y arrives at the peak potential of the pulse. Accordingly, because the column cathode discharge ends at the stage where the voltage which is applied across the row electrodes and column electrodes is low, the discharge intensity also drops markedly below that of the case of FIG. 33, as shown in FIG. 7.

That is, by applying the reset pulse RP1_{Y1} or RP2_{Y1} as shown in FIG. 33, for example, which has a waveform in which the potential transition at the leading edge of the pulse is gradual to the PDP 50 in which CL light-emitting MgO crystals are contained not only in the magnesium oxide layer 13 but also in the fluorescent layer 17, a column cathode discharge with a weakened discharge intensity is produced. Therefore, because it is possible to produce a column cathode discharge with an extremely weak discharge intensity as the reset discharge, the contrast of the image and, in particular, the darkness contrast when a dark image is displayed can be raised.

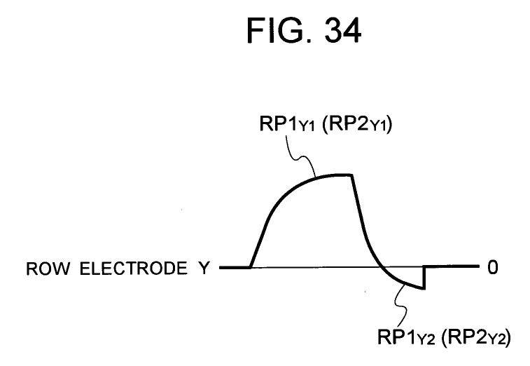

The waveform during the rise of the reset pulse RP1_{Y1} and RP2_{Y1} is not limited to having a fixed inclination as shown in FIG. 33. Rather, as shown in FIG. 34, for example, the inclination may change gradually as time elapses.

[Drive Sequence Based on Drive Mode B]

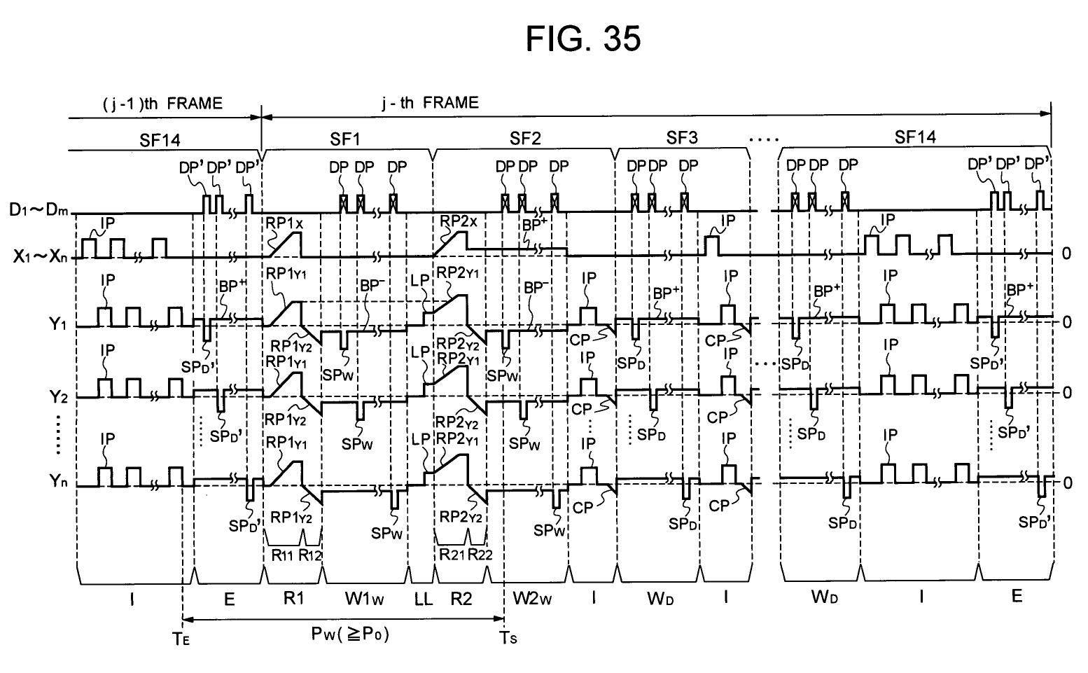

A drive sequence based on drive mode B will now be described with reference to FIG. 35. The drive sequence (drive mode B) is stored in the drive sequence data memory 58 together with the drive sequence (drive mode A). Further, the drive control circuit 56 selectively executes drive control using drive mode A or drive mode B on the basis of the drive sequence data from the data memory 58.

In the drive sequence of drive mode B, a period P_{W} which extends from the time T_{E} the application of the sustain pulse which is applied last in the frame ((j−1)th frame) preceding the frame (j-th frame) ends up until the time T_{S} the application of the data pulse DP which is applied first in the selective write address process (the second selective write address process W2_{W} in the embodiment) of the frame (j-th frame) which is the following frame starts is set to be equal to or more than a predetermined period P₀ (P_{W}≧P₀).

That is, as a result of the application of a negative polarity base pulse BP⁻ to the row electrodes Y and a positive polarity data pulse DP to the column electrodes D in the selective write address process W2_{W}, a very weak discharge is sometimes generated across the row electrodes Y and column electrodes D prior to the application of the write scan pulse SP_{W} (that is, during non-application thereof). As a result of the weak discharge, the small amount of negative polarity wall charge which remains in the row electrodes Y and the positive polarity wall charge which exists next to the column electrodes D decrease. In this case, a write discharge is no longer produced across the row electrodes Y and column electrodes D. In cases where a write discharge is not produced, the cells become dark points. In particular, in the case of the PDP of this embodiment in whose fluorescent layer MgO crystals including CL light-emitting MgO crystals are provided, the discharge characteristic is favorable and a weak discharge is therefore generated all the more readily.

Hence, a period P_{W} which extends from the time T_{E} the application of the final light emission sustain pulse in the frame ends up until the time T_{S} the application of the data pulse DP which is applied first in the selective write subfield preceding the selective erase subfield of the frame which follows the frame starts is set to be equal to or more than a predetermined period P₀ (P_{W}≧P₀). As a result, by reducing the priming particles produced in the sustain discharge of the final light emission sustain pulse during the period P_{W} (also called the ‘adjustment period’ hereinbelow) to a certain extent, the generation of a weak discharge can be prevented.

That is, adjustment period P_{W} requires that the time over which the priming particles decrease to an extent that allows the generation of a weak discharge to be prevented (also referred to as the ‘priming attenuation time’ or simply the ‘attenuation time’ hereinbelow) be equal to or more than P₀ (P_{W}≧P₀). The adjustment period P_{W} is set at or more than 1 msec (milliseconds). In addition, the adjustment period P_{W} is more preferably in the range 1 msec to 2 msec.

In the example of FIGS. 33 and 35, the ‘final light emission sustain pulse’ is the sustain pulse which is applied last in the leading frame ((j−1)th frame). That is, although the final sustain pulse of the light emission sustain pulse (the final light emission sustain pulse) in the respective discharge cells PC in one frame period are different depending on the pixel brightness (gray level), a case where all of the discharge cells PC display the maximum brightness level may be considered and, therefore, if the ‘final light emission sustain pulse’ is viewed as the sustain pulse which is applied last in one frame, it is no longer necessary to especially detect the true ‘final light emission sustain pulse’. Accordingly, here, the ‘final light emission sustain pulse’ is a sustain pulse that is applied last to all of the discharge cells PC, that is, to the whole of the PDP 50 in the leading frame.

However, in cases where the final light emission sustain pulse of the leading frame is detected from the pixel data and drive control based on drive mode B is executed, the application start timing of the data pulse DP which is first applied in the selective write address process of the frame which follows the leading frame may also be controlled on the basis of the timing for the application of the sustain pulse which is applied last in the light emission pattern (FIG. 30) with the largest gray level of all of the discharge cells PC of the PDP 50 in the leading frame. That is, in a case where the maximum gray level among the gray levels (display brightness) of all of the discharge cells PC of the PDP 50 in the leading frame is a tenth gray level (FIG. 30, brightness level ‘55+α’), for example, the final sustain pulse in subfield SF8 is the final light emission sustain pulse and the application end timing thereof is the abovementioned final light emission sustain pulse application end time T_{E}.

[Selective Driving of Drive Mode A and Drive Mode B]

As mentioned earlier, the drive control circuit 56 selectively executes drive mode A and drive mode B on the basis of the drive mode selection conditions.

(1) Control Based on the PDP Cumulative Usage Time

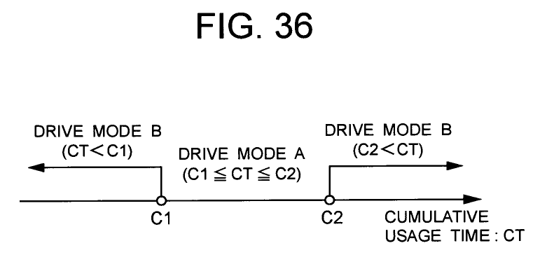

The drive control circuit 56 receives a signal which represents the cumulative usage time (cumulative drive time) CT of the PDP 50 from the cumulative usage time timer 57. As shown in FIG. 36, the drive control circuit 56 executes drive control (FIG. 35) on the basis of drive mode B (adjustment mode) in a case where the cumulative usage time (CT) is less than a predetermined cumulative usage time (first usage time threshold value; C1) (CT<C1) or in a case where the cumulative usage time (CT) is greater than a predetermined cumulative usage time (second usage time threshold value; C2) (C2<CT) (flowchart of FIG. 31, steps S11, S13).

On the other hand, in cases where the cumulative usage time (CT) is equal to or more than the first usage time threshold value and equal to or less than the second usage time threshold value (C1≦CT≦C2), drive control based on drive mode A (normal mode) (FIG. 33) is executed (flowchart of FIG. 31, steps S11, S12).

That is, this is because, in the case of a PDP, when the cumulative usage time is short, there are sometimes cases where the activity of the protective layer is insufficient and where the discharge characteristic is not stable. That is, this is because, in cases where the discharge characteristic is not stable, a weak discharge is readily produced across the row electrodes Y and column electrodes D and it is therefore necessary to prevent the production of the weak discharge by reducing the priming particles generated by the sustain discharge during the adjustment period P_{W} to a certain degree. This is also because the discharge characteristic transitions in an unstable manner and the weak discharge is readily generated even in cases where the cumulative usage time is long.

(2) Control Based on the Temperature of the PDP or the Ambient Temperature

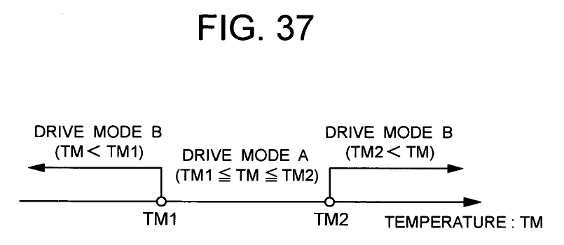

Alternatively, the drive control circuit 56 selectively executes drive mode A and drive mode B on the basis of the temperature of the PDP 50 or the ambient temperature (surrounding temperature). The temperature sensor 59 measures the temperature of the PDP 50 or the ambient temperature (TM) and supplies a signal which represents the measurement temperature to the drive control circuit 56. As shown in FIG. 37, the drive control circuit 56 executes drive control (FIG. 35) based on drive mode B (adjustment mode) in cases where the measurement temperature (TM) measured by the temperature sensor 59 is smaller than a predetermined first temperature (TM1) (TM<TM1) or where the measurement temperature is greater than a predetermined second temperature (TM2) (TM2<TM) (flowchart of FIG. 31, step S11, S13).

On the other hand, in cases where the measurement temperature is equal to or more than the first temperature and equal to or less than the second temperature (TM1≦TM≦TM2), drive control (FIG. 33) based on drive mode A (normal mode) is executed (flowchart of FIG. 31, steps S11, S12).

Further, usage of control based on the PDP cumulative usage time and control based on the temperature of the PDP (or ambient temperature) may also be combined. That is, the configuration may also be such that drive control (FIG. 35) based on drive mode B is executed in cases where both the cumulative usage time and the temperature of the PDP or either the cumulative usage time or the temperature thereof fulfils the condition for executing drive mode B.

Furthermore, although a case where two threshold values (an upper limit value and a lower limit value) are provided for the PDP cumulative usage time and the temperature of the PDP was illustrated in the above embodiment, the selection of the drive mode may also be performed by setting only either one of the two threshold values.

Alternatively, the configuration may be such that the selection (switching) of drive mode A and drive mode B is not executed and drive control (FIG. 35) based on drive mode B is always executed.

[Setting of Adjustment Period P_{W} (P_{W}≧P₀)]

As mentioned earlier, for the drive control based on drive mode B, the adjustment period P_{W} which extends from the time T_{E} the application of the final light emission sustain pulse of the preceding frame ((j−1)th frame) ends up until the time T_{S} the application of the data pulse DP (that is, the initial data pulse DP in the second selective write address process (W2_{W})) which is applied first in the selective write subfield (SF2) preceding the selective erase subfield (SF3) of the frame (j-th frame) which follows the preceding frame starts is set to be equal to or more than a predetermined period P₀ (P_{W}≧P₀).

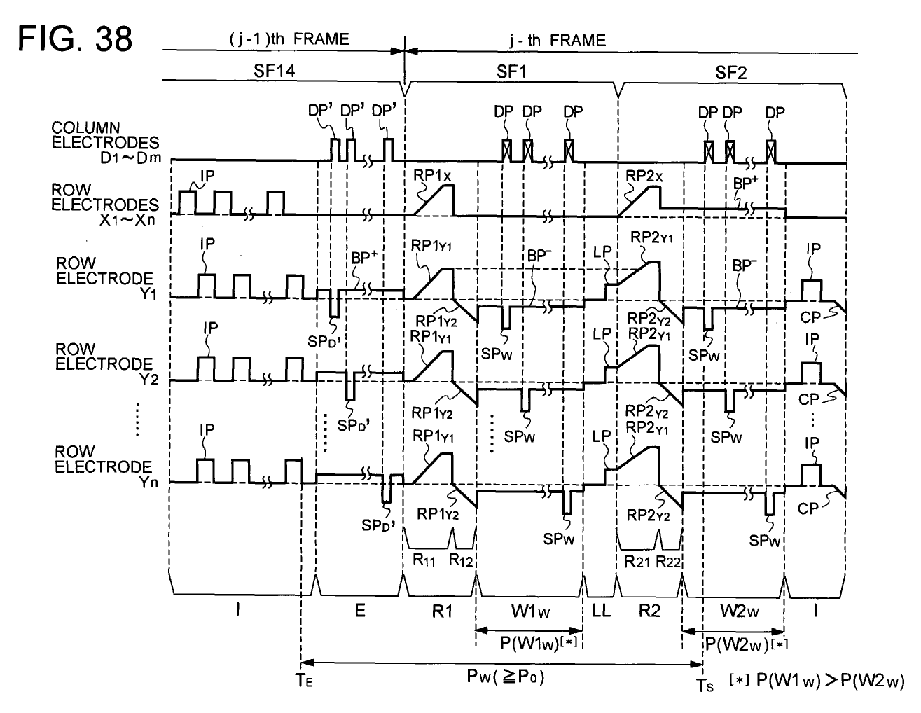

In the embodiment, as shown in FIG. 38, the period P(W1_{W}) of the first selective write address process W1_{W} is extended so that period P(W1_{W}) is longer than period P(W2_{W}) of the second selective write address process W2_{W} (that is, P(W1_{W})>(PW2_{W})). Thus, the adjustment period P_{W} is established as being equal to or more than predetermined period P₀ (P_{W}≧P₀) by extending the period P(W1_{W}) of the first selective write address process W1_{W}. For example, the adjustment period P_{W} is established as being 1 msec or more (P₀=1 msec).

In FIG. 38, only the operation of the last subfield (SF14) in the preceding frame (the (j−1)th frame) and of subfields SF1 to SF2 of the j-th frame are selectively shown.

In the above embodiment, period P(W1_{W}) of the first selective write address process W1_{W} may be set as 100 μsec to 2 msec. For example, period P(W1_{W}) may also be set to 250 μsec.

In FIG. 38, the ‘final light emission sustain pulse’ is shown as the final sustain pulse of the final subfield (SF14, sixteenth gray level) of the drive sequence (FIG. 32). However, as mentioned earlier, in cases where a final light emission sustain pulse is detected from the pixel data, the application end time T_{E} may also be set on the basis of the detected ‘final light emission sustain pulse’. That is, as mentioned earlier, in cases where the largest gray level of all the discharge cells PC in the frame is less than the sixteenth gray level (the tenth gray level, for example), the sustain pulse which is applied last in the final subfield (SF8) of the light emission pattern (FIG. 6) with the largest gray level is the final light emission sustain pulse. This point is also true of each of the embodiments described hereinbelow.

As mentioned hereinabove, the production of a weak discharge can be prevented by extending period P(W1_{W}) of the first selective write address process W1_{W} so that the adjustment period P_{W} is equal to or more than predetermined period P₀ (P_{W}≧P₀). Hence, a decrease in the wall charge that exists in the row electrodes Y and column electrodes D can be prevented. Therefore, because a write mistake (write failure) in the second selective write address process W2_{W} can be prevented, dark points (black display) due to write failure are not generated and deterioration in the image quality can be prevented.

### Embodiment 3.2

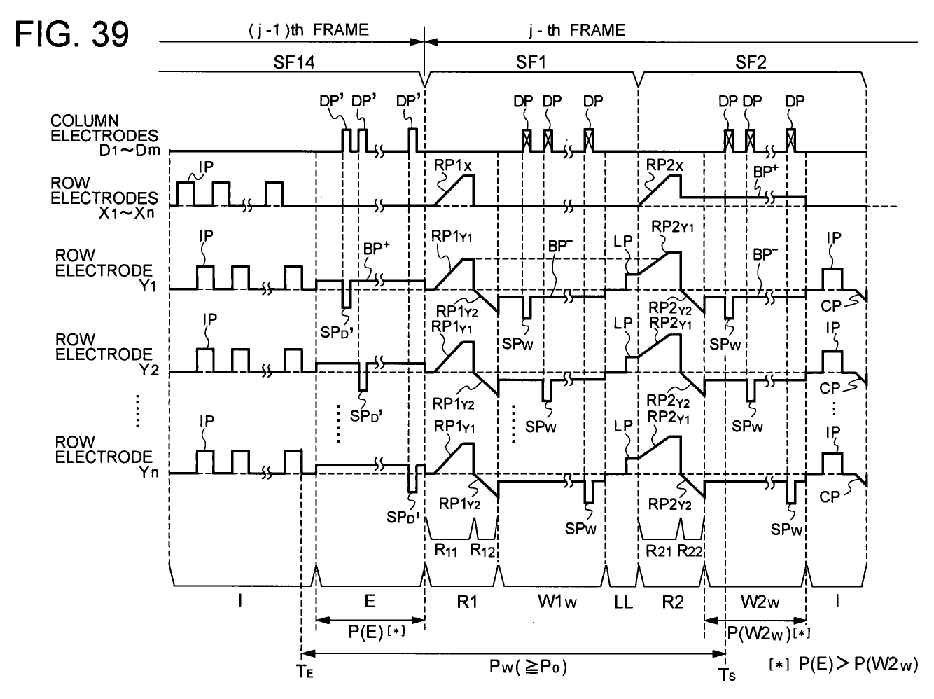

In the embodiment, as shown in FIG. 39, period P(E) of erase process E of the preceding frame ((j−1)th frame) is extended so that period P(E) of erase process E is longer than period P (W2_{W}) of the second selective write address process W2_{W} of the subsequent frame (j-th frame) (that is, P(E)>P(W2_{W})). Thus, the adjustment period P_{W} is established as equal to or more than predetermined period P₀ (P_{W}≧P₀) by extending period P(E) of erase period E.

As a result, the adjustment period P_{W} which extends from the time T_{E} the application of the final light emission sustain pulse of the (j−1)th frame ends up until the time T_{S} the application of the data pulse DP (that is, the initial data pulse DP in the second selective write address process (W2_{W})) which is applied first in the selective write subfield (SF2) preceding the selective erase subfield (SF3) of j-th frame which follows the preceding frame starts is established as equal to or more than predetermined period P₀ (P_{W}≧P₀). For example, the adjustment period P_{W} may be established as being 1 msec or more (P₀=1 msec).

Thus, a decrease in the wall charge that exists in the row electrodes Y and column electrodes D can be prevented by preventing the production of a weak discharge by extending period P(E) of erase process E of the preceding frame so that the adjustment period P_{W} is equal to or more than predetermined period P₀ (P_{W}≧P₀). Hence, because a write mistake (write failure) in the second selective write address process W2_{W} can be prevented, dark points (black display) due to write failure are not generated and deterioration in the image quality can be prevented.

### Embodiment 3.3

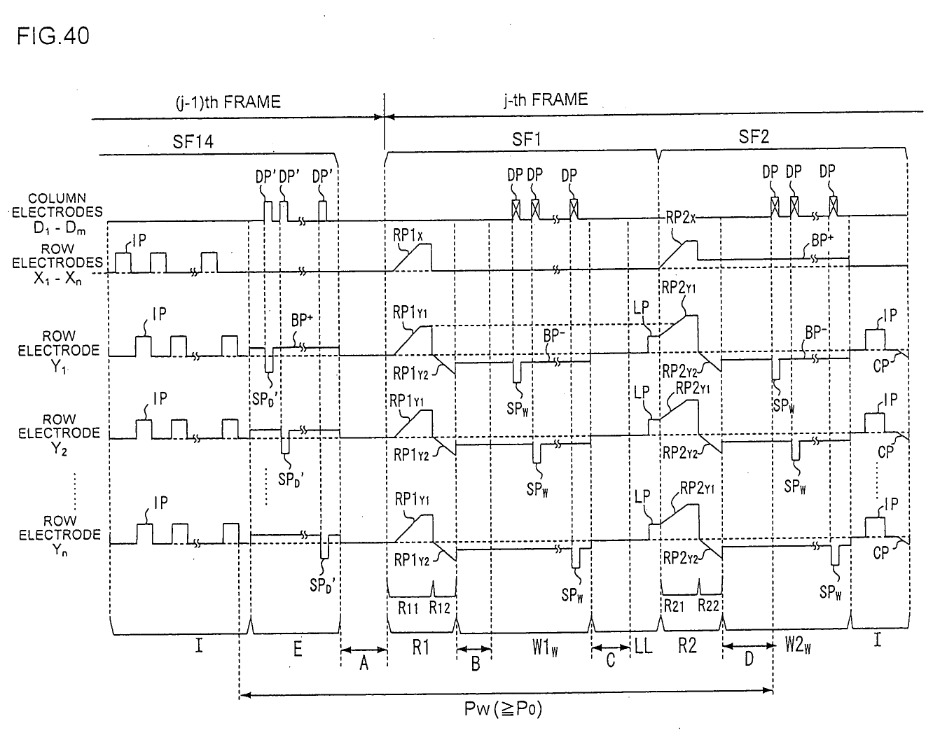

In the embodiment, as shown in FIG. 40, rest periods A, B, C, and D are assigned within the period from the time T_{E} the application of the final light emission sustain pulse in the preceding frame ((j−1)th frame) ends up until the time T_{S} the application of the data pulse DP which is applied first in the selective write subfield (SF2) of the subsequent frame (j-th frame) starts.

That is, a period which is obtained by subtracting the total time of all the subfields (SF1 to SFk, where k=1 to 14) of the frame from a single frame period generally exists. In the embodiment, the surplus period is assigned within the period (adjustment period P_{W}) from the time T_{E} the application of the final light emission sustain pulse of the preceding frame ends up until the time T_{S} the application of the data pulse DP in the selective write subfield of the subsequent frame starts as the rest periods A, B, C, and D. As a result, drive control is performed so that the adjustment period P_{W} is equal to or more than a predetermined period P₀ (P_{W}≧P₀) (1 msec or more, for example).

Here, the rest periods A, B, C, and D are each assigned as the period from the end of the preceding frame until the start of the subsequent frame, the period between the first reset process R1 of the subsequent frame and the first selective write address process W1_{W}, the period between the first selective write address process W1_{W} and the micro light emission process LL, and the period from the end of the second reset process R2 until the time T_{S} the application of the data pulse DP in the selective write address process (second selective write address process W2_{W}) starts.

There is no need for all of the rest periods A, B, C, and D to be assigned. At least any one of the rest periods may be assigned. Further, the surplus time can be actively generated by reducing the number of subfields for a normal light emission pattern (FIG. 6) and the rest periods A, B, C, and D can also be assigned thereto.

### Embodiment 3.4

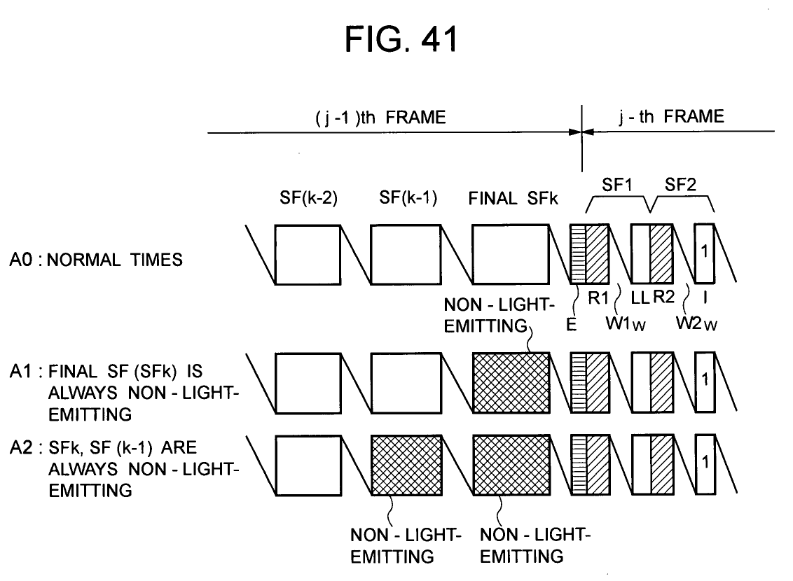

In the embodiment, the configuration is such that, in cases where the cumulative usage time and temperature of the PDP are within the execution range of the drive control of drive mode B (FIGS. 36 and 37), the adjustment period P_{W} which extends from the time T_{E} the application of the final light emission sustain pulse of the (j−1) th frame ends up until the time T_{S} the application of the data pulse DP (that is, the initial data pulse DP in the second selective write address process (W2_{W})) which is applied first in the selective write subfield (SF2) of the j-th frame starts is set to be equal to or more than predetermined period P₀ (P_{W}≧P₀) by forcibly making all of the discharge cells non-light-emitting (lighting-off mode) irrespective of the image data from the final subfield (SFk) of the preceding frame (the (j−1)th frame) to the predetermined subfield (SF(k−j), as shown in FIG. 41.

FIG. 41 shows a normal time A0 (in cases where the predetermined subfields are not forcibly made non-light-emitting), a case A1 which forcibly places the final subfield SFk in a non-light emission state (lighting-off mode), and a case A2 which forcibly places the subfield SFk and SF(k−1) in a non-light emission state (lighting-off mode). However, so that the period P_{W} which extends from the time T_{E} the application of the final light emission sustain pulse ends until the time T_{S} the application of the leading data pulse DP in the selective write subfield of the subsequent frame starts is equal to or more than predetermined period P₀ (1 msec or more, for example), the required number of subfields (SFk to SF(k−j), j=0, 1, 2, . . . ) are forcibly set to lighting-off mode in order retroactively from the last subfield SFk. In cases where the cumulative usage time and temperature of the PDP are outside the execution range of the driving control of drive mode B (within the execution range of the drive control of drive mode A), all of the subfields are set to the lighting-on mode/lighting-off mode in accordance with the pixel data.

### Embodiment 3.5

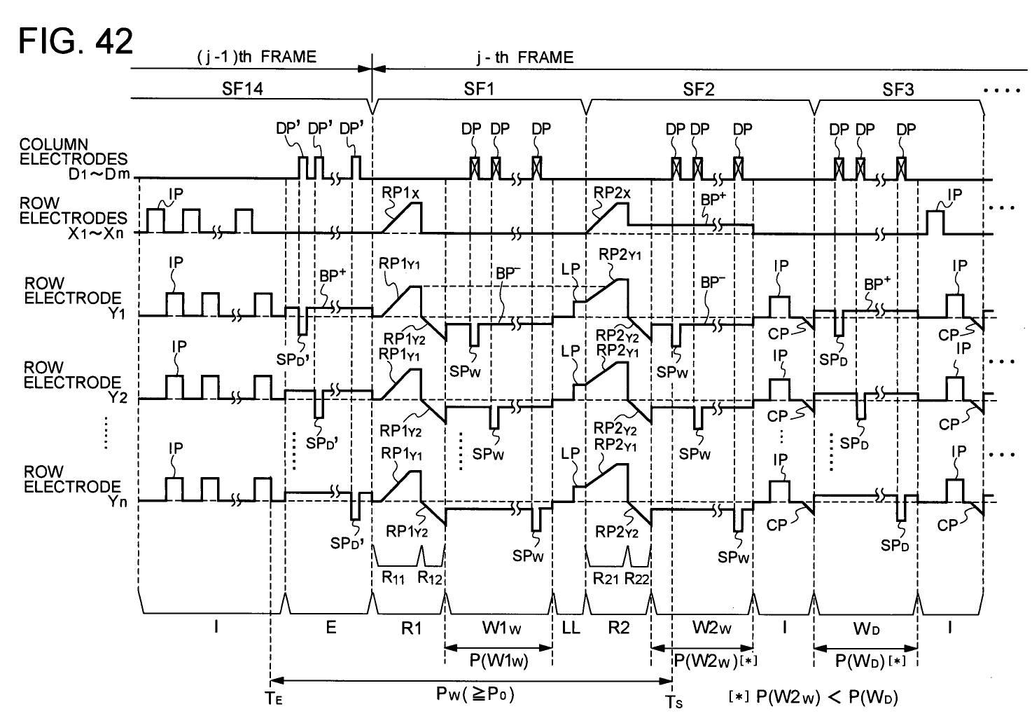

In the embodiment, as a modified example of the above embodiments, the write period P (W2_{W}) of the selective write address process (second selective write address process W2_{W}) is set short as shown in FIG. 42. For example, period P (W_{D}) of the selective erase address process W_{D} which is the subsequent subfield is made shorter than period P. That is, P(W2_{W})<P(W_{D}).

The weak discharge is continuously generated during the period of the selective write address process. Hence, as the address period grows longer, the wall charge is gradually reduced. For example, the address discharge becomes more difficult for scan lines with a later scanning order.

In the write address process in particular, because a negative polarity base potential is applied to the row electrodes Y and the data pulse DP which is applied to each of the respective column electrodes D has a positive polarity, that is, when a weak discharge is readily generated across the row electrodes Y and column electrodes D because potentials of mutually different potentials are applied across the row electrodes Y when the base potential is applied and across the column electrodes D when the data pulse DP is applied and, as mentioned earlier, when a write mistake is generated in the write address process, the subsequent subfield is the erase address process. Hence, the cells in which the write mistake occurs become dark points, which considerably degrades the display quality.

Based on the above point, it may be said that, if the period of the write address process is temporally short, a transition is made in the preferred direction without degrading the display quality. Therefore, in order to reduce the generation time of the weak discharge, the selective write address process period P (W2_{W}) is shortened. As a result, the writing as far as the final scan line ends before the wall charge is reduced and a stable write discharge is readily produced even in the final scan line. The configuration may also be combined with each of the above embodiments.

### Embodiment 3.6

In the above embodiment, a case where light emission driving is executed by means of a light emission drive sequence (also known as a 2-reset sequence) which comprises the first reset process and first selective write address process, the micro light emission process LL, and the second reset process and second selective write address process was described. The present invention can similarly be applied to a case of a light emission drive sequence (also called a 1-reset sequence) which comprises one reset process R and one selective write address process W_{W}.

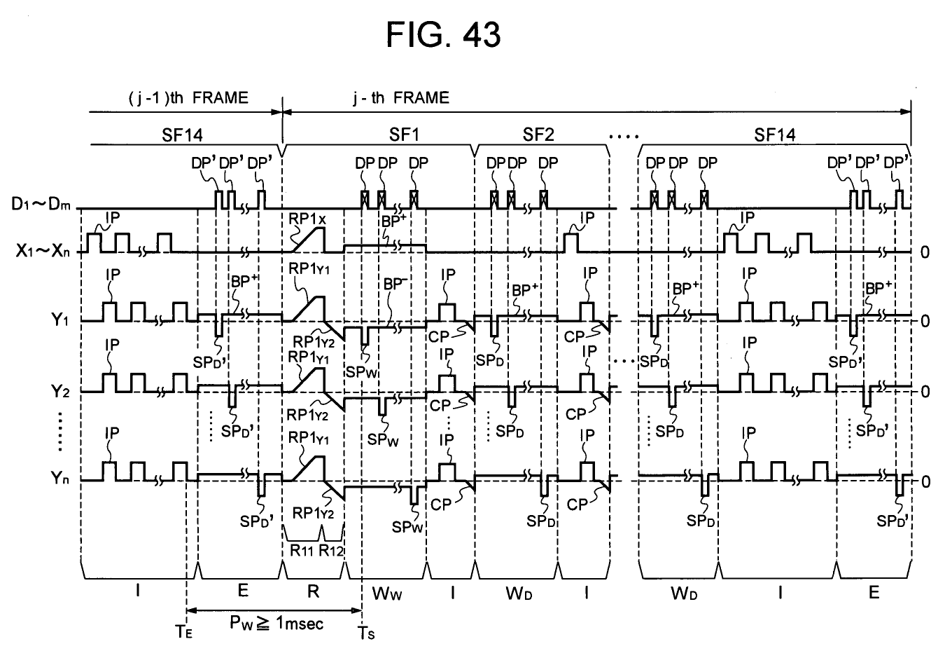

That is, in the above embodiment, a subfield which comprises the first reset process, the first selective write address process, and the micro light emission process LL of the 2-reset sequence is not provided as shown in FIG. 43 as a modified example of each of the above embodiments. Furthermore, as per each of the above embodiments, the adjustment period P_{W} which extends from the time T_{E} the application of the final light emission sustain pulse of the preceding frame ((j−1)th frame) ends up until the time T_{S} the application of the data pulse DP (that is, the initial data pulse DP in the selective write address process (W_{W})) which is applied first in the selective write subfield (SF1) of the following frame (j-th frame) is established as equal to or more than predetermined period P₀. FIG. 43 shows a case where period P_{W} is equal to or more than 1 msec as an example.

### Embodiment 3.7

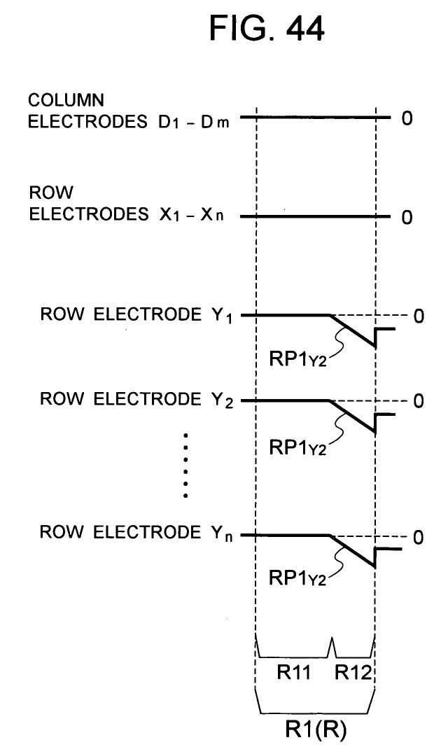

In the first reset process R1 and R which are shown in the embodiments above (in FIGS. 33, 13, 16 to 18, 19, and 21 and so forth, for example), although the first reset discharge which constitutes a column cathode discharge is produced by applying the reset pulse RP1_{Y1} in the first half (R11) to the row electrodes Y₁ to Yₙ, this step may also be omitted. For example, a reset process R1 (or R) is adopted as shown in FIG. 22 instead of the first reset process R1 or R. In other words, as shown in FIG. 44, the row electrodes Y₁ to Yₙ are fixed at ground potential in the first half (R11) of the reset process R1 (or R). That is, the objective of the column cathode discharge from the row electrodes Y to the column electrodes D in the first half (R11) of the reset process R1 (or R) is to emit the charged particles in order to stabilize the write discharge in the selective write address process W1_{W} (or W_{W}). However, in cases where a structure that contains MgO crystals which include CL light-emitting MgO crystals in the fluorescent layer as shown in FIG. 5, for example, is adopted, the write discharge stabilizes in comparison with a case where such a configuration is not adopted. Hence, a configuration which does not produce a column cathode discharge with both the row electrodes Y and column electrodes D at ground potential in the first half (R11) of the reset process R1 (or R) can be adopted. In this case, the row electrodes X are also at ground potential level as shown in FIG. 44. Further, so too in this case, directly after the end of the reset process R1 (or R), all of the discharge cells enter a lighting-off mode state as a result of the discharge of the erase pulse EP and the application of the reset pulse RP1_{Y2} in the erase process E of the preceding field.

Thereupon, with regard to the column cathode discharge caused by the application of the reset pulse RP2_{Y1} in the first half (R21) of the second reset process R2 shown in FIG. 33, for example, the charged particles which are emitted as a result of the reset discharge mainly act to stabilize the write discharge in the second selective write address process W2_{W}. Accordingly, when the column cathode discharge resulting from the application of the reset pulse RP2_{Y1} in the first half (R21) of the second reset process R2 is omitted, in cases where a write error occurs in the second selective write address process W2_{W}, a sustain discharge can no longer be produced in all of the subfields including subfield SF2 and subsequent subfields. Therefore, in the first half (R21) of the second reset process R2, the column cathode discharge resulting from the application of the reset pulse RP2_{Y1} is preferably carried out.

It is also understood that the above embodiments and modified examples can be suitably changed or applied in combination with one another.

Although a light emission drive sequence which has two reset process was mainly described by way of an example in the earlier embodiments, the light emission is not limited to the light emission drive sequence and can also be similarly applied in the case of another drive sequence. The numerical values of the earlier embodiments are only for illustration purposes. It goes without saying that values can be applied after being suitably modified.

As described in detail hereinabove, a method of driving a plasma display panel with a high darkness contrast and which is capable of preventing the degradation of the image quality and the production of dark points (black display) due to the failure of writing in the write address process can be provided.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Applications Nos. 2007-130611, 2007-131951, and 2007-133209 which are hereby incorporated by reference.

What is claimed is:

1. A method of driving a plasma display panel in which discharge cells are formed at respective intersections between a plurality of row electrode pairs and a plurality of column electrode, the plasma display panel including a fluorescent layer having a fluorescent material and a secondary electron emission material formed on a surface of the respective discharge cells which is in contact with the discharge space and the plasma display panel being driven in accordance with pixel data for each of pixels based on a video signal,
the method comprising:
a drive control process which executes each of address processing and sustain processing, in which the discharge cells are subjected to a sustain discharge repeatedly, in each of a plurality of subfields in each unit display period of the video signal, a drive pulse to the row electrode pairs and/or the column electrodes; and
a lighting sustain total calculation process that finds the total of the sustain discharges produced in each of the discharge cells within a predetermined period as a lighting sustain total,
wherein the drive control process further executes pulse waveform adjustment processing in order to adjust a pulse waveform of the drive pulse in accordance with the lighting sustain total.

2. The method of driving a plasma display panel according to claim 1, comprising:
in the address processing, applying, to one of each of the row electrodes of each of the row electrode pairs, a scan pulse which constitutes the drive pulse and selectively applying a pixel data pulse which constitutes the drive pulse to the column electrodes in accordance with the pixel data; and
performing, in the pulse waveform adjustment processing, adjustment in order to increase the pulse widths of the scan pulse and the pixel data pulse as the lighting sustain total determined for each of the predetermined periods increases and/or performing adjustment of the peak potential of the scan pulse or the pixel data pulse so that the voltage across one of each of the row electrodes and the column electrodes is large.

3. The method of driving a plasma display panel according to claim 2, the predetermined period is a unit display period which precedes each of the unit display periods,
the method comprising, in the pulse waveform adjustment processing, adjusting the pulse width and/or peak potential of the scan pulse and the pixel data pulse in accordance with the lighting sustain total so that the scan pulse and the pixel data pulse are applied within the unit display period, for each unit display period.

4. The method of driving a plasma display panel according to claim 2, the predetermined period being the subfield or subfield group which precedes each of the subfields,
the method comprising, in the pulse waveform adjustment processing, adjusting the pulse width and/or peak potential of the scan pulse and the pixel data pulse which are to be applied within the subfield for each of the subfields in accordance with the lighting sustain total.

5. The method of driving a plasma display panel according to claim 1, comprising:
producing, in the sustain processing, the sustain discharge only in the discharge cells in a lighting-on mode state by applying, to the row electrode pairs, a sustain pulse which constitutes the drive pulse repeatedly a number of times which corresponds to the brightness weighting of the subfield, for each subfield; and
performing, in the pulse waveform adjustment processing, adjustment in order to extend the peak potential maintenance period of a final sustain pulse among the respective sustain pulses applied repeatedly in each of the subfields as the lighting sustain total determined for each of the predetermined periods increases.

6. The method of driving a plasma display panel according to claim 5, wherein the predetermined period is the subfield which precedes each of the subfields or the subfield group which precedes each of the subfields.

7. The method of driving a plasma display panel according to claim 1, comprising:
producing, in the sustain processing, the sustain discharge only in the discharge cells in a lighting-on mode state by applying, to the row electrode pairs, a sustain pulse which constitutes the drive pulse repeatedly a number of times which corresponds to the brightness weighting of the subfield, for each subfield, and applying a wall charge adjustment pulse constituting the drive pulse to one of each of the row electrode of each of the row electrode pairs immediately after the application of a final sustain pulse among the respective sustain pulses which are repeatedly applied in each of the subfields,
wherein a trailing edge of the final sustain pulse comprises a first potential drop segment in which the potential applied to the row electrodes drops gradually as time elapses, a fixed potential segment which follows the first potential drop segment and in which the potential to be applied to the row electrodes is maintained at a predetermined first potential, and a second potential drop segment which follows the fixed potential segment and in which the potential to be applied to the row electrodes drops gradually as time elapses and reaches a predetermined second potential; and
the wall charge adjustment pulse has a pulse waveform in which the potential to be applied to the row electrodes drops gradually as time elapses after the second potential state and reaches a predetermined peak potential and the potential rises gradually as time elapses after the peak potential state.

8. The method of driving a plasma display panel according to claim 7, comprising:
performing, in the pulse waveform adjustment processing, adjustment in order to raise the first potential as the lighting sustain total determined in each of the predetermined periods increases.

9. The method of driving a plasma display panel according to claim 7, comprising:
performing, in the pulse waveform adjustment processing, adjustment in order to extend the period length of the fixed potential segment as the lighting sustain total determined in each of the predetermined periods increases.

10. The method of driving a plasma display panel according to claim 7, comprising:
performing, in the pulse waveform adjustment processing, adjustment so that the peak potential of the wall charge adjustment pulse approaches zero volts as the lighting sustain total determined in each of the predetermined periods increases.

11. The method of driving a plasma display panel according to claim 7, comprising:
performing, in the pulse waveform adjustment processing, adjustment in order to increase the pulse width of the wall charge adjustment pulse as the lighting sustain total determined in the predetermined period increases.

12. The method of driving a plasma display panel according to claim 8, wherein the predetermined period is the subfield which immediately precedes each of the subfields or the subfield group which immediately precedes each of the subfields.

13. The method of driving a plasma display panel according to claim 2, comprising:
producing, in the address processing of one subfield among the respective subfields, a write address discharge which allows the discharge cells to make the transition from a lighting-off mode state to a lighting-on mode state; and
producing, in the address processing of the subfield which follows the first subfield, an erase address discharge which allows the discharge cells to make the transition from a lighting-on mode state to a lighting-off mode state.

14. The method of driving a plasma display panel according to claim 13, wherein the drive control process executes reset processing which initializes all of the discharge cells in the lighting-off mode immediately prior to the address processing of the first subfield.

15. The method of driving a plasma display panel according to claim 14, comprising, in the reset processing, applying a voltage, with one of each of the row electrodes taken as an anode and the column electrodes as cathodes across one of each of the row electrodes and the column electrodes.

16. The method of driving a plasma display panel according to claim 14, wherein the first subfield is the subfield provided at the start of the unit display period and the reset processing is executed only in the leading subfield.

17. The method of driving a plasma display panel according to claim 13, comprising:
allowing, in the address processing of the immediately preceding subfield which is provided immediately before the one subfield, the discharge cells to make the transition to the lighting-on mode state selectively in accordance with the pixel data; and
executing reset processing which initializes all of the discharge cells in the lighting-off mode immediately before the address processing of the preceding subfield.

18. The method of driving a plasma display panel according to claim 17, comprising, in the reset processing, applying a voltage, with one of each of the row electrodes taken as an anode and the column electrodes as cathodes across one of each of the row electrodes and the column electrodes.

19. The method of driving a plasma display panel according to claim 17, wherein the immediately preceding subfield is a subfield which is provided at the start of the unit display period; and
the reset processing is executed only in the immediately preceding subfield and the one subfield among the respective plurality of subfields in the unit display period.

20. The method of driving a plasma display panel according to claim 19, comprising:
executing, in the preceding subfield, micro light emission processing which produces a micro light emission discharge across the column electrodes and one of each of the row electrodes in the discharge cells which have been set to the lighting-on mode state by applying a voltage, with one of each of the row electrodes of the row electrode pairs taken as an anode and the column electrodes as cathodes across one of each of the row electrodes and the column electrodes.

21. The method of driving a plasma display panel according to claim 20, wherein the micro light emission discharge is a discharge which causes light emission that corresponds to a gray level of a brightness which is one level higher than brightness level 0.

22. The method of driving a plasma display panel according to claim 1, wherein the secondary electron emission material comprises magnesium oxide.

23. The method of driving a plasma display panel according to claim 22, wherein the magnesium oxide comprises magnesium oxide crystals which perform cathode luminescence light emission with a peak within a waveband of 200 to 300 nm as a result of being excited by an electron beam.

24. The method of driving a plasma display panel according to claim 23, wherein the magnesium oxide crystals are magnesium oxide single crystals which are generated by means of gas phase oxidation.

25. The method of driving a plasma display panel according to claim 23, wherein the magnesium oxide crystals have a particle diameter of 2000 Å or more.

26. The method of driving a plasma display panel according to claim 1, wherein the secondary electron emission material is in contact with the discharge gas within the discharge space.

27. The method of driving a plasma display panel according to claim 13, wherein the period which is devoted to the address processing in the one subfield is shorter than the period which is devoted to the address processing in the subfield which follows the one subfield.

28. The method of driving a plasma display panel according to claim 13, wherein, in cases where the lighting sustain total is greater than a predetermined number, the drive control process makes the period which is devoted to the address processing of the one subfield shorter than the period which is devoted to the address processing of the subfield which follows the one subfield.

29. A method of driving a plasma display panel in which a plurality of row electrode pairs and a plurality of column electrode form discharge cells at each of an intersections, and a fluorescent layer is provided in the discharge cells, the plasma display panel being gray-level driven in accordance with a video signal,
the method comprising:
executing, in each of the subfields when the display period of one field of the video signal is divided into a plurality of subfields which correspond to respective weightings, an address process which selectively sets the discharge cells to a lighting-on mode or lighting-off mode, and a maintained light emission process which applies a sustain pulse to the row electrodes which constitute the row electrode pairs; and
applying an auxiliary pulse of the same polarity as that of the sustain pulse to the column electrodes in a first period which extends from after the application of a final scan pulse which is applied to one of each of the row electrodes of the row electrode pairs in the address process until the application of a leading sustain pulse, which is applied in the maintained light emission process, starts.

30. The method of driving a plasma display panel according to claim 29, wherein
the leading sustain pulse has a leading edge in which the potential rises during the period from the time the application of the leading sustain pulse starts until the clamping of the sustain pulse at a rated potential,
the method comprising:
applying an auxiliary potential of the same polarity as that of the leading sustain pulse to the other one of each of the row electrodes of the row electrode pairs in a second period which corresponds to the leading edge of the leading sustain pulse for one of each of the row electrodes.

31. The method of driving a plasma display panel according to claim 30, wherein the auxiliary potential is applied to the other one of each of the row electrodes by placing the other row electrodes in a floating state in the second period.

32. The method of driving a plasma display panel according to claim 30, wherein the auxiliary potential is applied to the other one of each of the row electrodes by applying a fixed potential to the other one of each of the row electrodes in the second period.

33. The method of driving a plasma display panel according to claim 30, wherein the auxiliary potential is applied to the other one of each of the row electrodes by applying the sustain pulse to the other one of each of the row electrodes in the second period.

34. The method of driving a plasma display panel according to claim 29, comprising:
executing, in one subfield among the plurality of subfields, a reset process which initializes the discharge cells in either a lighting-on mode state or a lighting-off mode state immediately prior to the address process; and
in the reset process, applying a voltage, with one of each of the row electrodes of the row electrode pairs taken as an anode and the column electrodes as cathodes across one of each of the row electrodes and the column electrodes.

35. The method of driving a plasma display panel according to claim 34, wherein the one subfield is a subfield which is provided at the start of the one field and the reset process is executed only in the one subfield in the one field.

36. The method of driving a plasma display panel according to claim 34, comprising:
executing, in the leading subfield which is provided at the start of the one field which is provided before the one subfield, a reset process which initializes the discharge cells in either a lighting-on mode state or a lighting-off mode state immediately prior to the address process.

37. The method of driving a plasma display panel according to claim 36, comprising, in the reset process of the leading subfield, applying a voltage, with one of each of the row electrodes of the row electrode pairs taken as an anode and the column electrodes as cathodes across one of each of the row electrodes and the column electrodes.

38. The method of driving a plasma display panel according to claim 36, comprising a step of executing the reset process only in the leading subfield and the one subfield in the one field.

39. The method of driving a plasma display panel according to claim 36, comprising:
executing, immediately after the address process of the leading subfield, a micro light emission process to produce a micro light emission discharge across the column electrodes and one of each of the row electrodes in the discharge cells which have been set to lighting-on mode in the address process of the leading subfield by applying a voltage, with one of each of the row electrodes of the row electrode pairs taken as an anode and the column electrodes as cathodes across one of each of the row electrodes and the column electrodes.

40. The method of driving a plasma display panel according to claim 39, wherein the micro light emission discharge is a discharge which causes light emission that corresponds to a gray level of a brightness which is one level higher than brightness level 0.

41. The method of driving a plasma display panel according to claim 29, wherein the fluorescent layer comprises a fluorescent material and a secondary electron emission material.

42. The method of driving a plasma display panel according to claim 41, wherein the secondary electron emission material comprises magnesium oxide.

43. The method of driving a plasma display panel according to claim 42, wherein the magnesium oxide comprises magnesium oxide crystals which perform cathode luminescence light emission with a peak within a waveband of 200 to 300 nm as a result of being excited by an electron beam.

44. The method of driving a plasma display panel according to claim 43, wherein the magnesium oxide crystals are magnesium oxide single crystals which are generated by means of gas phase oxidation.

45. The method of driving a plasma display panel according to claim 41, wherein particles comprising the secondary electron emission material contact a discharge gas in the discharge space.

46. The method of driving a plasma display panel according to claim 43, wherein the magnesium oxide crystals have a particle diameter of 2000 Å or more.

47. The method of driving a plasma display panel according to claim 29, wherein the address process is a selective write address process which selectively subjects the discharge cells to an address discharge to set the discharge cells to a light emission state.

48. The method of driving a plasma display panel according to claim 29, wherein the first period comprises at least a period in which a base potential of a negative polarity which is applied to one of each of the row electrodes rises toward a positive polarity in the address process.

49. A method of driving a plasma display panel in which discharge cells on which a fluorescent layer including a fluorescent material is provided are formed at respective intersections between a plurality of row electrode pairs and a plurality of column electrode, the plasma display panel being driven in accordance with pixel data for each of the pixels based on a video signal,
the method comprising:
executing a write address process that sets the discharge cells to lighting-on mode by applying a pixel data pulse to the column electrodes selectively in one subfield when one frame display period of the video signal is divided into a plurality of subfields, and a sustain process which applies a sustain pulse to the row electrode pairs;
executing, in the subfield which follows the one subfield, an erase address process which sets the discharge cells to lighting-off mode selectively and the sustain process; and
taking, as an adjustment period, a period extending from time of the application of the final sustain pulse which is a sustain pulse that is applied last in the immediately preceding frame which is the one frame display period up until time of the application of the leading pixel data pulse which is a pixel data pulse that is applied first in the write address process of the one subfield of the subsequent frame which follows the immediately preceding frame, and making the adjustment period 1 msec (millisecond) or more.

50. The method of driving a plasma display panel according to claim 49, comprising:
setting the adjustment period at 1 msec or more in cases where either the temperature of the plasma display panel or the ambient temperature of the plasma display panel exceeds a predetermined temperature.

51. The method of driving a plasma display panel according to claim 49, comprising:
setting the adjustment period at 1 msec or more in cases where either the temperature of the plasma display panel or the ambient temperature of the plasma display panel is less than a predetermined temperature.

52. The method of driving a plasma display panel according to claim 49, comprising:
setting the adjustment period at 1 msec or more until the cumulative drive time of the plasma display panel exceeds a first set time.

53. The method of driving a plasma display panel according to claim 49, comprising:
setting the adjustment period at 1 msec or more in cases where the cumulative drive time of the plasma display panel exceeds a second set time.

54. The method of driving a plasma display panel according to claim 49, comprising:
applying, in the write address process, negative polarity scan pulses sequentially to one of each of the row electrodes of the row electrode pairs in synchronism with the positive polarity pixel data pulse and applying a negative polarity base pulse to one of each of the row electrodes at times of non-application of the scan pulses during the write address process.

55. The method of driving a plasma display panel according to claim 49, comprising:
executing, in the immediately preceding subfield provided immediately before the one subfield, an address process which selectively sets the discharge cells to lighting-on mode or lighting-off mode and making the adjustment period 1 msec or more by setting the time assigned to the address process longer than the time assigned to the write address process.

56. The method of driving a plasma display panel according to claim 49, comprising:
making the adjustment period 1 msec or more by setting the time assigned to a batch erase process provided at the end of the preceding frame which sets all of the discharge cells that have been set to the lighting-on mode to the lighting-off mode longer than the time assigned to the write address process.

57. The method of driving the plasma display panel according to claim 49, comprising:
making the adjustment period 1 msec or more by disposing a rest period which comprises a surplus time which is the difference between the one frame time and the total time of all of the subfields in the period extending from the time of the application of the final sustain pulse up until the time of the application of the leading pixel data pulse.

58. The method of driving the plasma display panel according to claim 57, comprising:
disposing the rest time at the end of the immediately preceding frame.

59. The method of driving the plasma display panel according to claim 57, comprising:
disposing the rest time immediately before or immediately after the address period of the immediately preceding subfield provided immediately before the one subfield.

60. The method of driving the plasma display panel according to claim 57, comprising:
disposing the rest time immediately before the write address process.

61. The method of driving the plasma display panel according to claim 49, comprising:
setting the time assigned to the write address process shorter than the time assigned to the erase address process.

62. The method of driving the plasma display panel according to claim 49, comprising:
executing, in the one subfield, a reset process which initializes the discharge cells in lighting-off mode immediately before the write address process and applying a voltage, with one of each of the row electrodes taken as an anode and the column electrodes as cathodes across one of each of the row electrodes and the column electrodes during the reset process.

63. The method of driving the plasma display panel according to claim 49, comprising:
executing, in the immediately preceding subfield provided immediately before the one subfield, an address process which selectively sets the discharge cells to lighting-on mode or lighting-off mode and executing a reset process which initializes the discharge cells in lighting-off mode immediately prior to the address process.

64. The method of driving the plasma display panel according to claim 63, comprising:
applying a voltage, with one of each of the row electrodes taken as an anodic and the column electrodes as cathodes across one of each of the row electrodes and the column electrodes during the reset process.

65. The method of driving the plasma display panel according to claim 49, wherein the fluorescent layer comprises a secondary electron emission material.

66. The method of driving the plasma display panel according to claim 65, wherein the secondary electron emission material comprises magnesium oxide.

67. The method of driving the plasma display panel according to claim 66, wherein the magnesium oxide comprises magnesium oxide crystals which perform cathode luminescence light emission with a peak within a waveband of 200 to 300 nm as a result of being excited by an electron beam.

68. The method of driving a plasma display panel according to claim 67, wherein the magnesium oxide crystals have a particle diameter of 2000 Å or more.

69. The method of driving a plasma display panel according to claim 65, wherein particles comprising the secondary electron emission material contact the discharge gas in the discharge space.

70. The method of driving a plasma display panel according to claim 49, wherein the write address process and sustain process are executed in a leading subfield which precedes the one subfield.

71. The method of driving a plasma display panel according to claim 49, wherein, in the sustain process of the leading subfield, a micro light emission process which produces a micro light emission discharge across the column electrodes and one of each of the row electrodes in the discharge cells which have been set to lighting-on mode is executed in the write address process of the leading subfield.

72. A method of driving a plasma display panel in which discharge cells on which a fluorescent layer including a fluorescent material is provided are formed at the respective intersections between a plurality of row electrode pairs and a plurality of column electrode, the plasma display panel being driven in accordance with pixel data for each of the pixels based on a video signal,
the method comprising:
executing a write address process that sets the discharge cells to lighting-on mode by applying a pixel data pulse to the column electrodes selectively in one subfield when one frame display period of the video signal is divided into a plurality of subfields and a sustain process which subjects the discharge cells which have been set to the lighting-on mode to a sustain discharge by applying a sustain pulse to the row electrode pairs;
executing an erase address process which sets the discharge cells to lighting-off mode selectively and the sustain process in the subfield which follows the one subfield; and
taking, as an adjustment period, a period extending from the time of the application of the final light emission sustain pulse which is the sustain pulse which produces the sustain discharge last in the immediately preceding frame which is the first frame display period up until the time of the application of the leading pixel data pulse which is the pixel data pulse that is applied first in the write address process of the one subfield of the subsequent frame which follows the immediately preceding frame, and making the adjustment period 1 msec (millisecond) or more.

73. The method of driving a plasma display panel according to claim 72, comprising:
setting the adjustment period at 1 msec or more by setting all of the discharge cells to a forced lighting-off mode which is the lighting-off mode irrespective of the pixel data in at least the subfield at the end of the preceding frame.

74. The method of driving a plasma display panel according to claim 73, comprising:
setting the discharge cells to the forced lighting-off mode in cases where either the temperature of the plasma display panel or the ambient temperature of the plasma display panel exceeds a predetermined temperature.

75. The method of driving a plasma display panel according to claim 73, comprising:
setting the pixels to the forced lighting-off mode in cases where either the temperature of the plasma display panel or the ambient temperature of the plasma display panel is less than a predetermined temperature.

76. The method of driving a plasma display panel according to claim 73, comprising:
setting the discharge cells to the forced lighting-off mode until the cumulative drive time of the plasma display panel exceeds a first set time.

77. The method of driving a plasma display panel according to claim 73, comprising:
setting the discharge cells to the forced lighting-off mode in cases where the cumulative drive time of the plasma display panel exceeds a second set time.

78. The method of driving a plasma display panel according to claim 72, wherein the fluorescent layer comprises a secondary electron emission material.

79. The method of driving a plasma display panel according to claim 78, wherein the secondary electron emission material comprises magnesium oxide.

80. The method of driving a plasma display panel according to claim 79, wherein the magnesium oxide comprises magnesium oxide crystals which perform cathode luminescence light emission with a peak within a waveband of 200 to 300 nm as a result of being excited by an electron beam.

81. The method of driving a plasma display panel according to claim 80, wherein the magnesium oxide crystals have a particle diameter of 2000 Å or more.

82. The method of driving a plasma display panel according to claim 72, wherein particles comprising the secondary electron emission material contact the discharge gas in the discharge space.

83. The method of driving a plasma display panel according to claim 72, comprising:
executing the write address process and sustain process in a leading subfield which precedes the one subfield.

84. The method of driving a plasma display panel according to claim 72, comprising:
executing, in the sustain process of the leading subfield, a micro light emission process which produces a micro light emission discharge across the column electrodes and one of each of the row electrodes in the discharge cells which have been set to lighting-on mode in the write address process of the leading subfield.
